(19) United States
(12) Patent Application Publication
(10) Pub. No.: US 2003/0056244 A1
(43) Pub. Date: Mar. 20, 2003

(54) Feed additive compositions and methods

(76) Inventors: Ning Huang, Davis, CA (US); Raymond L. Rodriguez, Davis, CA (US); Frank E. Hagie, Sacramento, CA (US)

Correspondence Address: PERKINS COIE LLP, P.O. BOX 2168, MENLO PARK, CA, 94026, US

(21) Appl. No.: 10/076,816

(22) Filed: Feb. 14, 2002

Related U.S. Application Data
(63) Continuation-in-part of application No. 09/847,232, filed on May 2, 2001.
(60) Provisional application No. 60/269,188, filed on Feb. 14, 2001.
(60) Provisional application No. 60/266,929, filed on Feb. 6, 2001.
(60) Provisional application No. 60/201,182, filed on May 2, 2000.

(30) Foreign Application Priority Data
Nov. 8, 2001 (US) PCT/US01/14234

(51) Int. Cl. A23K 1/165; A23K 1/17

(52) U.S. Cl. 800/278; 424/442; 426/53

(57) ABSTRACT

The invention is directed to improved animal feed compositions comprising one or more milk proteins produced in the seeds of a transgenic plant and methods of making and using the same.

This application claims priority benefit to U.S. provisional application Ser. No. 60/269,188, filed Feb. 14, 2001, for “Production of Feed Additives in Transgenic Plants” which is incorporated herein in its entirety. The present application is also a continuation-in-part of U.S. patent application Ser. No. 09/847,232, filed May 2, 2001 for, for “Plant Transcription Factors and Enhanced Gene Expression”, which claims the benefit of U.S. Provisional Application No. 60/266,929 filed Feb. 6, 2001 and U.S. Provisional Application No. 60/201,182 filed May 2, 2000 all of which are incorporated herein by reference. The corresponding PCT application No. PCT/US01/14234, International Publication number WO 01/83792 A1, published Nov. 8, 2001, is also incorporated herein by reference.

### REFERENCES

The following references are cited herein, and to the extent they may be pertinent to the practice of the invention, are incorporated herein by reference.

Alber and Kawasaki, Mol. and Appl. Genet 1:419-434, 1982.

Aniansson, G, et al. (1990). Anti-Adhesive Activity Of Human Casein Against Streptococcus Pneumoniae And Haemophilus Influenzae. Micro Pathog 8(5):315-323.

Arnold R. R. et al., Infect Immun. 28, 893-898, 1980.

Ausubel F. M. et al., CURRENT PROTOCOLS IN MOLECULAR BIOLOGY, John Wiley & Sons, New York, N.Y., 1993.

Bhan, M. K. et al., J Pediatr Gastroenterol Nutr 7:208-213, 1988.

Beatty, K., et al., Kinetics of association of serine proteinases with native and oxidized alpha-1-proteinase inhibitor and alpha-1-antichymotrypsin. J. Biol. Chem. 255:3931-3934, 1980.

Boesman-Finkelstein M. and Finkelstein R. A. FEBS Letters, 144, 1-5, 1982.

Bradford M. Analytical Biochem. 72, 248-254, 1976.

Brandt, et al., Carlsberg Res. Commun. 50, 333-345, 1985.

Briggs, D, et al. (1981). Malting And Brewing Science—Volume 1, Malt And Sweet Wort (Chapman & Hall, New York, 2nd edition).

Briggs, D (1998). Malts And Malting (Blackie Academic And Professional, New York).

Bullen J. J. et al., Br. Med. J. 1, 69-75, 1972.

Carrell, R. W. et al. Structure and variation of human alpha-1-antitrypsin. Nature 298:329-334, 1983.

Castañón M. J. et al., Gene, 66, 223-234, 1988.

Chandan R. C., J Dairy Sci, 51: 606-607, 1968.

Chong, D. K. and Langridge, W. H., Transgenic Res 9: 71-8, 2000.

Chowanadisai, W. and Lönnerdal, B. Alpha-1-antitrypsin and antichymotrypsin in human milk: origin, concentrations, and stability. Am. J. Clin. Nutr. 2001:(in press)

Chrispeels K., Ann. Rev. Plant Phys. Plant Mol. Biol. 42:21-53, 1991.

Clark et al., J. Biol. Chem. 264:17544-17550, 1989.

Davidson L A, et al. (1987). Persistence Of Human Milk Proteins In The Breast-Fed Infant. Act Pediatric Scand 76(5):733-740.

Davidson, L. A., and Lönnerdal, B. Fecal alpha-1-antitrypsin in breast-fed infants is derived from human milk and is not indicative of enteric protein loss. Acta Paediatr. Scand. 79:137-141, 1990.

della-Cioppa et al., Plant Physiol. 84:965-968, 1987.

Dellaporta S. L. et al., Plant Mol. Biol. Rep. 1, 19-21, 1983.

Depicker et al., Mol. App;. Genet. 1:561-573, 1982.

Dewey K. G. et al., J Pediatrics 126: 696-702, 1995.

Dewey K. G. et al., Pediatrics 89: 1035-1041, 1992.

Dewey K. G. et al., Am J Clin Nutr 57: 140-145, 1993.

Ditta et al., Proc. Nat. Acad. Sci., U.S.A. 77:7347-7351, 1980.

Doncheck, J (1995). Malts And Malting. In: Kirk-Othmer Encyclopedia Of Chemical Technology (John Wiley & Sons, New York, 4th edition), volume 15, pp. 947-962.

Eley, E (1990). A Wandful World. Food Processing August 1990, pp. 17-18.

Faure A. and Jollès P., et al., Comptes Rendus Hebdomadaires des Seances de L Academie des Sciences. D: Sciences Naturelles, 271, 1916-1918,1970.

Fujihara T. and Hayashi K., Archives of Virology 140:1469-1472, 1995.

Gastañaduy, A. et al., J Pediatr Gastroenterol Nutr 11:240-6, 1990.

Gelvin, S. B. et al., eds. PLANT MOLECULAR BIOLOGY MANUAL, 1990.

Gielen, et al., EMBO J. 3:835-846, 1984

Goto, F et al., Nature Biotech. 17, 282-286, 1999.

Grover M. et al., Acta Paediatrica 86:315-316, 1997.

Hamosh, M, et al. (1999). Protective Function Of Human Milk: The Fat Globule. Semin Perinatol 23(3):242-9.

Harmsen M. C. et al., Journal of Infectious Diseases 172:380-388, 1995.

Hickenbotttom, J W (1977). Sweeteners In Biscuits And Crackers. The Bakers Digest, December 1977, pp. 18-22.

Hickenbottom, J W (1983). AIB Research Department Technical Bulletin, V(3), March 1983, pp. 1-8.

Hickenbottom, J W (1996). Processing, Types, And Uses Of Barley Malt Extracts And Syrups. Cereal Foods World 41(10): 778-790.

Hickenbottom J W (1997). Malts In Baking. American Society Of Bakery Engineers, Technical Bulletin #238, August 1997, pp. 1010-1013.

Huang N. et al., Plant Mol. Biol., 23, 737-747, 1993.

Hough, J S, et al. (1982).). Malting And Brewing Science—Volume 2, Hopped Wort And Beer (Chapman & Hall, New York, 2nd edition).

Huang N. et al., J CAASS, 1, 73-86, 1990a.

Horvath H. et al., Proc. Natl. Acad. Sci. USA, 97, 1914-1919, 2000.

Humphreys, D. P. and Glover, D. J. Therapeutic antibody production technologies: molecules, applications, expression and purification. Curr Opin Drug Discov Devel Mar;4(2):172-85, 2001.

Huang N. et al., Plant Mol. Biol. 14, 655-668, 1990b.

Huang, J., et al., Expression and purification of functional human alpha-1-antitrypsin from cultured plant cells. Biotechnol. Prog. 17:126-133, 2001.

Jensen L. G. et al., Proc. Natl. Acad. Sci. USA, 93, 3487-3491, 1996.

Jigami Y. et al., Gene, 43, 273-279, 1986.

Johnson, T. Human alpha-1-proteinase inhibitor. Methods Enzymol. 80:756-757, 1981.

Jollès P., LYSOZYMES—MODEL ENZYMES IN BIOCHEMISTRY AND BIOLOGY. Birkhäuser Verlag, Basel; Boston, 1996.

Jouanin et al., Mol. Gen. Genet. 201:370-374, 1985.

Kortt A. A. et al., Dimeric and trimeric antibodies: high avidity scFvs for cancer targeting. Biomol Eng 18:95-108, 2001.

Kovar M. G. et al., Pediatrics 74: 615-638, 1984.

Kunz C. et al., Clin. Perinatol. 26(2):307-33, 1999.

Lake, C, (1988). From Strength To Strength. Flood Flavorings, Ingredients, Packaging And Processing, February 1988, pp. 55-57.

Langridge et al., Planta 156,166-170, 1982.

Larrick, J. W. et al., Production of antibodies in transgenic plants. Res Immunol 149:603-8, 1998.

Lásztity, R. The chemistry of cereal proteins. CRC Press, Boca Raton, 1996.

Lee-Huang S. et al., Proc. Natl. Acad. Sci. USA, 96, 2678-2681, 1999.

Lindberg, T. Protease inhibitors in human milk. Pediatr. Res. 13:969-972, 1979.

Lollike K. et al., Leukemia, 9, 206-209, 1995a.

Lönnerdal B., Am L Clin Nutr, 42: 1299-1317, 1985.

Lönnerdal, B. Recombinant milk proteins—an opportunity and a challenge. Am. J. Clin. Nutr. 63:622S-626S, 1996.

Maga E. et al., J. of Food Protection, 61, 52-56, 1998.

Maga E. et al., Transgenic Research, 3, 36-42, 1994.

Maga E. et al., Journal of Dairy Science, 78, 2645-2652, 1995.

Maniatis, et al., MOLECULAR CLONING: A LABORATORY MANUAL, 2nd Edition, 1989.

Matsumoto, A. et al., Plant Mol Bio 27:1163-72, 1995.

Maynard, J. and Georgiou, G. Antibody engineering Annu Rev Biomed Eng 2:339-76, 2000.

McBride and Summerfelt, Plant Mol. Biol. 14:269-276, 1990.

Mcgilligan, K M, et al. (1987). Alpha-1-Antitrypsin Concentration In Human Milk. Pediatr Res 22(3):268-27o. Mitra A. and Zhang Z., Plant Physiol. 106, 977-981, 1994.

McGilligan, K. M. et al., Alpha-1-antitrypsin concentration in human milk. Pediatr. Res. 22:268-270, 1987.

Mitra, A, and Zhang, Z., Plant Physiol 106:977-81, 1994.

Moe, T, et al. (1995). Mashing Of Rice With Barley Malt Under Non-Conventional Process Conditions For Use In Food Processes. International Journal Of food Science And Technology 29:635-649.

Moore, K (1978). Rice-Barley Malt Combo Improves Functionality And Nutrition Of Meats, Breads, And Baked Goods. Food Product Development 12(5): 74.

Moreira-Ludewig, R. and Healy, C., J. Pharm. and Tox. Meth., 27, 75-100, 1992.

Motil K. J., Curr Opin Pediatr 12(5):469-76, 2000.

Murphy M S (1998). Growth Factors And The Gastrointestinal Tract. Nutrition 14(10):771-4.

Nakajima H. et al., Plant Cell Reports, 16, 674-679, 1997.

Newburg, DS (1999). Human Milk Glycoconjugates That Inhibit Pathogens. Curr Med Chem 6(2):117-127.

Newburg, D S, et al. (1998). Role Of Human-Milk Lactadherin In Protection Against Symptomatic Rotavirus Infection. Lancet 351(1910): 1160-4.

NIH publication, American Academy of Allergy and Immunology Committee on adverse reaction to food and National Institute of Allergy and Infectious Diseases, NIH, Bethesda, 1984

Peeters, K., et al., Production of antibodies and antibody fragments in plants. Vaccine 9:2756-61, 2001.

Peterson J A, et al. (1998). Glycoproteins Of The Human Milk Fat Globule In The Protection Of The Breast-Fed Infant Against Infections. Bio Neonate 74(2): 143-162.

Piper, D. W. and Fenton, B. H. pH stability and activity curves of pepsin with special reference to their clinical importance. Gut 6:506-508, 1965.

Prosser, C G (1996). Insulin-Like Growth Factors In Milk And Mammary Gland. J Mammary Gland Bio Neoplasia (3):297-306.

Raikhel N., Plant Phys. 100:1627-1632, 1992.

Rey, M. W., Nucleic Acid Res. 18, 5288, 1990.

Romer et al., Biochem. Biophys. Res Commun. 196:1414-1421, 1993.

Rudloff, S. and Lönnerdal, B. Solubility and digestibility of milk proteins in infant formulas exposed to different heat treatments. J. Pediatr. Gastroenterol. Nutr. 15:25-33, 1992.

Saarinen K. M. et al., Adv Exp Med Biol 478:121-30, 2000.

Salmon V. et al., Protein Expression and purification 9, 203-210, 1997.

Salmon, V. et al., Protein Expr Purif 13:127-135, 1998.

Samaranayake Y. H. et al., Apmis, 105, 875-883, 1997.

Sambrook J. et al., MOLECULAR CLONING: A LABORATORY MANUAL (Second Edition), Cold Spring Harbor Press, Plainview, N.Y, 1989.

Satue-Gracia M. T. et al., J Agric Food Chem 48(10):4984-90, 2000.

Schütte H. and Kula M. R., Biotechnology and Applied Biochemistry, 12, 599-620, 1990.

Sfat, M, et al (1981). Malts And Malting. In: Kirk-Othmer Encyclopedia Of Chemical Technology (John Wiley & Sons, New York, 3rd edition), volume 14, pp. 810-823.

Shah et al., Science 233:478-481, 1986.

Shin, K, et al. (2000). PCR Cloning And Baculovirus Expression Of Human Lactoperoxidase And Myeloperoxidase. Biochem Biophys Res Commun 27(13):831-836.

Shugar D., Biochim. Biophys. Acta, 8, 680-68, 1952.

Symbicon A B (1995). Human Milk Kappa-Casein And Inhibition Of Helicobacter pylori Adhesion To Human Gastric Mucosa. J Pediatr Gastroenterol Nujtr 21(3):288-296.

Takai I. et al., J. Chrom. B, Biomedical Applications, 685, 21-25, 1996.

Tsuchiya K. et al., Applied Microbiology and Biotechnology, 38, 109-114, 1992.

Von Heijne et al., Plant Mol. Biol. Rep. 9:104-126, 1991.

Wang C. S. and Kloer H. U., Anal. Biochem., 139, 224-227, 1984.

Wang C. et al., Comp. Biochem. Physiol. 78B, 575-580, 1984.

Ward P. P. et al., Bio/technology 10, 784-789, 1992.

Ye X. et al., Science 287, 303-305, 2000.

Yoshimura K. et al., Biochem. Biophys Res Com, 150, 794-801, 1988.

### BACKGROUND OF THE INVENTION

The profitability of livestock and poultry producers is dependent upon the efficiency and rate that nutrients in feed are converted into salable products such as meat, milk and eggs. An animal's maximum growth rate and efficiency of conversion of feed into products (feed conversion efficiency) are set by its genetic potential.

Environmental factors grouped under the term “stress” prevent the expression of an animal's genetic potential. A common form of stress encountered by animals is that of infectious challenge. Animals are exposed to millions of potential pathogens daily, through contact, ingestion, and inhalation. Infectious challenge may or may not result in clinical disease, depending upon the pathogenicity of the challenging microorganism and the immunocompetence of the animal. Regardless of the outcome, a stress response is indicated by decreased growth performance and feed conversion efficiency when the immune system is stimulated.

Veterinarians, like their medical doctor counterparts, occasionally prescribe the therapeutic use of antibiotics in order to protect the health of animals. The animal industries also rely on the chronic, low level (sub-therapeutic) feeding of antibiotics to prevent disease and mitigate the economic impact of infection. Approximately 100% of chicken and turkeys, 90% of swine and veal calves, and 60% of cattle raised in the United States receive diets that continuously contain antibiotics. These antibiotics are fed prophylactically with the goal of preventing infectious disease before it can be established. The use of antibiotics at sub-therapeutic levels (ST antibiotics) permits the large-scale husbandry of animals at very high population densities, with minimal labor costs and results in cost effective and wholesome production of foods. Modern animal farming in the United States is virtually dependent upon the use of antibiotics throughout the production cycle.

In 1995, ST antibiotics used by the animal production industries accounted for $3.3 billion in sales. One study estimated that the use of sub-therapeutic antibiotics alone, saved the US swine industry $2 billion in production costs annually. Sub-therapeutic levels of antibiotics in the diet or water allow an increased rate of growth and feed conversion efficiency, and increase the general state of health of fish, chickens, pigs, sheep, and cattle. Regulatory statutes restrict ST antibiotics to those that are poorly absorbed from the digestive tract and consequently do not contaminate meat, mile, and eggs. For this reason, the mode of action of ST antibiotics is limited to effects within the digestive tract. By definition, ST antibiotics exert their beneficial effects by suppressing the growth of microorganisms. Antibiotics lack efficacy in germ-free or highly sanitized environments and do not require the presence of clinically identifiable disease or pathogenic agents.

The behavioral and metabolic changes that occur during an immune response to pathogen challenge include anorexia, fever, decreased accretion of skeletal muscle, synthesis of acute phase proteins, increased use of amino acids as an energy source, and decreased use of fat as an energy source. These changes form the basis for impaired growth, poor feed utilization, and altered nutrition requirements in growing chickens and pigs challenged by non-infectious pathogens.

According to a recent National Academy of Sciences Report, antibiotics “enhance growth and production performance because an animal can reduce that portion of the nutrition requirement associated with fighting subclinical disease and bolstering health defense processes, thereby enhancing the portion of nutrients available for growth and production.”

However, the sub-therapeutic use of antibiotics in animals has also been shown to have a negative impact on human health. This is due to the emergence in food animals of zoonotic microorganisms that are resistant to antibiotics. Furthermore, the enlarged pool of resistance genes created by ST-antibiotics is thought to result in decreased therapeutic efficacy of antibiotics used for treatment of a variety of human infections. For this reason, the use of antibiotics by animal production industries has come under intense scrutiny by the Food and Drug Administration, the Institute of Medicine, and the World Health Organization. All of these regulatory bodies have called for decreased use of ST-antibiotics by the animal production industries. Further, the potential threat to human health due to ST antibiotic use in animal production has prompted several European countries (Sweden, Denmark, Switzerland) to completely ban their use. In July of 1999, the European Union banned the sub-therapeutic use of most antibiotics by all of its member countries. Australia is considering a similar ban. A recent report by the National Academy of Sciences in the United States examining this issue does not call for a total ban but argues for the development of alternatives so that ST-antibiotic use in animals can be markedly reduced.

### SUMMARY OF THE INVENTION

Accordingly, it is an object of the invention to provide an animal feed or feed supplement containing a transgenic plant-produced heterologous, anti-microbial protein which when fed to production animals results in improved feed efficiency, and methods for using and producing the improved animal feed.

In one aspect, the invention includes an improved feed for production animals (poultry and hoofed farm animals), comprising one or more plant-derived feed ingredients, substantially unsupplemented with small-molecule antibiotics, and, as an additive, a seed composition containing a flour, extract, or malt obtained from mature monocot seeds and one or more seed-produced heterologous, anti-microbial proteins in substantially unpurified form.

In one embodiment, the one or more seed-produced anti-microbial protein(s) present in the seed composition are an anti-microbial proteins, including the anti-microbial milk proteins such as lactoferrin, lysozyme, lactoferricin, lactohedrin, kappa-casein, haptocorrin, or lactoperoxidase, a milk protein like alpha-1-antitrypsin that may function as an antimicrobial by inhibiting proteolysis of other anti-microbial proteins, non-milk anti-microbial proteins and acute-phase proteins, e.g., proteins that are produced normally in production animals in response to infection, and small anti-microbial proteins. Exemplary anti-microbial proteins are lysozyme and lactoferrin, where lysozyme is preferably present in an amount between about 0.05 and 0.5 grams protein/kg feed, and lactoferrin, in an amount between 0.2 to 2 grams/protein/kg feed. 17.

In another embodiment, the one or more seed-produced anti-microbial protein(s) present in the food are acute-phase, non-milk proteins selected from the group consisting of C-reactive protein, serum amyloid A; ferritin, haptoglobin, seromucoids, ceruloplasmin, 15-keto-13,14-dihydro-prostaglandin F2 alpha, fibrinogen, alpha-1-acid glycoprotein, mannose binding protein, lipopolysaccharide binding protein, alpha-2 macroglobulin and defensins.

In still another embodiment, the the one or more seed-produced anti-microbial protein(s) present in the food are antimicrobial peptides selected from the group consisting of cecropin, magainin, defensins, tachyplesin, parasin I, buforin 1, PMAP-23, moronecidin, anoplin, gambicin, and SAMP-29.

In another embodiment, the one or more seed-produced anti-microbial protein(s) present in the food are antimicrobial pproteins selected from the group consisting: CAP37, granulysin, secretory leukocyte protease inhibitor, CAP18, ubiquicidin, bovine antimicrobial protein-1, Ace-AMP1, tachyplesin, big defensin, Ac-AMP2, Ah-AMP1, and CAP18.

The seed composition may be prepared as follows:

(a) the flour is prepared by milling mature monocot seeds,

(b) the extract is prepared by suspending milled flour in a buffered aqueous medium; and

(c) the malt is prepared by (i) steeping barley seeds to a desired water content, (ii) germinating the stepped barley, (iii) drying the germinated seeds, under conditions effective to stop germination, (iv) crushing the dried seeds, (v) optionally, adding crushed seeds from a non-barley monocot plant, (vi) forming a mixture of crushed seeds in water, and (vii) malting the crushed seed mixture until a desired malt is achieved, where at least one of the barley or non-barley monocot seeds contain such anti-microbial protein(s). Step (v) in the malt-producing step may include adding to the crushed dried barley seeds, mature rice transgenic seeds that produce an anti-microbial protein.

In another aspect, the invention includes an improvement over existing methods for achieving high growth rates in production animals, particularly methods in which a production animal is fed a feed supplemented with subclinical (sub-therapeutic or ST) levels of one or more small-molecule antibiotics. The improvement comprises replacing the small-molecule antibiotic(s) in the feed with a seed composition containing a flour, extract, or malt obtained from mature monocot seeds and one or more seed-produced heterologous, anti-microbial proteins in substantially unpurified form.

In a related aspect, the invention includes a method of producing a feed for production animals. The method includes the steps of first obtaining a monocot plant that has been stably transformed with a first chimeric gene having (i) a transcriptional regulatory region from a monocot gene having a seed maturation-specific promoter, (ii) operably linked to said transcriptional regulatory region, a leader/targeting DNA sequence encoding a monocot seed-specific transit sequence capable of targeting a linked polypeptide to an endosperm-cell organelle, and (iii) a protein-coding sequence encoding a heterologous, anti-microbial normally.

The transformed plant is cultivated under seed-maturation conditions, and the mature seeds are harvested, then extracted to yield a flour, extract, or malt composition containing the anti-microbial protein in substantially unpurified form. The seed composition is added to an animal feed that is substantially free of small-molecule antibiotics, i.e., has no or significantly reduced amounts of small-molecule antibiotics added.

In preparing the seed composition:

(a) the flour is prepared by milling mature monocot seeds,

(b) the extract is prepared by suspending milled flour in a buffered aqueous medium; and

(c) the malt is prepared by (i) steeping barley seeds to a desired water content, (ii) germinating the stepped barley, (iii) drying the germinated seeds, under conditions effective to stop germination, (iv) crushing the dried seeds, and (v) after mixing the crushed seeds with water, malting the crushed seed mixture until a desired malt is achieved.

Exemplary transcriptional regulatory regions in the chimeric gene are from the promoter of the group of genes: rice glutelins, rice globulins, oryzins, and prolamines, barley hordeins, wheat gliadins and glutenins, maize zeins and glutelins, oat glutelins, and sorghum kafirins, millet pennisetins, and rye secalins genes. Exemplary leader/targeting sequences are likewise from the group of genes selected from the group of rice glutelins, rice globulins oryzins, and prolamines, barley hordeins, wheat gliadins and glutenins, maize zeins and glutelins, oat glutelins, and sorghum kafirins, millet pennisetins, and rye secalins genes.

In one preferred embodiment, the transcriptional regulatory region in the chimeric gene is a rice glutelin Gt1 promoter, and the leader DNA sequence is a rice glutelin Gt1 signal sequence capable of targeting a linked polypeptide to a protein storage body. An exemplary glutelin Gt1 promoter and glutelin Gt1 signal sequence are included within the sequence identified by SEQ ID NO:15. In another preferred embodiment, the transcriptional regulatory region in the chimeric gene is a rice globulin Glb promoter, and the leader DNA sequence is a rice glutelin Gt1 signal sequence capable of targeting a linked polypeptide to a protein storage body. An exemplary globulin Glb promoter and glutelin Gt1 signal sequence are included within the sequence identified by SEQ ID NO:16.

The transformed monocot seed may further encode at least one transcription factors O2, PBF, and Reb, as exemplified by SEQ ID NOS: 31, 32, ands 33, respectively, and preferably O2 and/or PBF.

The protein-coding sequence may be the coding sequence for a milk protein selected from the group consisting of lactoferrin, lysozyme, lactoferricin, lactohedrin, kappa-casein, haptocorrin, lactoperoxidase, alpha-1-antitrypsin, and immunoglobulins, preferably a sequence which has been codon-optimized for expression in monocots. Exemplary codon-optimized sequences for human milk proteins are represented by SEQ ID NOS: 1, 3, and 7-14. Exemplary coding sequences for acute-phase, non-milk proteins are identified by SEQ ID NOS: 36, and 46-56. Exemplary coding sequences for antimicrobial peptides are identified by SEQ ID NOS: 34-68, 40-41, and 43. Exemplary sequences for other anti-microbial proteins are identified by SEQ ID NOS: 37, 45, and 57-59.

The plant may be further stably transformed with a second chimeric gene having (i) a transcriptional regulatory region from a monocot gene having a seed maturation-specific promoter, (ii) operably linked to said transcriptional regulatory region, a transit DNA sequence encoding a monocot seed-specific transit sequence capable of targeting a linked polypeptide to an endosperm-cell organelle, and (iii) a protein-coding sequence encoding a second heterologous, anti-microbial protein.

In still another aspect, the invention includes an improved feed for production animals (poultry and hoofed farm animals), comprising one or more plant-derived feed ingredients, substantially unsupplemented with small-molecule antibiotics, and, as an additive, a seed composition containing one or more seed-produced heterologous, anti-microbial proteins in substantially purified form.

These and other objects and features of the invention will become more fully apparent when the following detailed description of the invention is read in conjunction with the accompanying drawings.

### BRIEF DESCRIPTION OF THE FIGURES

FIG. 1 is a map of the pAPI159 expression construct that contains the human lysozyme coding sequence under the control of a Gt1 promoter and Gt1 signal sequence

FIG. 2 shows the results of Western blot analysis for the expression of recombinant human lysozyme in various tissues of rice plants, where lanes 1 and 15 are a human milk lysozyme standard; lane 2 is a broad range molecular weight marker from Sigma; lanes 3 and 4 represent mature seed tissue extracts; lanes 5 and 6 represent germinated seed extracts; lanes 7 and 8 represent root tissue extracts; lanes 9 and 10 represent extracts from young root tissue; lanes 11 and 12 represent leaf extracts; and lanes 13 and 14 represent extracts from young leaf; from untransformed (“U”) or transgenic (“T”) plants, respectively. The total loading protein amount was 40 μg per lane.

FIG. 3 shows the effect of incubating recombinant human lysozyme from transgenic rice seed, a human lysozyme standard (30 μg/ml), a control (20 mM sodium phosphate, pH 7.0, 5 mM EDTA) or an untransformed rice extract on the growth of E.coli strain JM109. At the end of the incubation (for the time indicated), an aliquot of the mixture was plated on LB plates and colony forming units per ml (CFU/ml) was calculated.

FIG. 4 is a graph showing the specific activity of lysozyme, as determined by incubating an identical concentration of a human lysozyme standard, human lysozyme from transgenic rice (plant) and lysozyme from chicken egg white with a standard amount of M. luteus, followed by evaluation of the reduction in the turbidity due to the activity of lysozyme over five minutes.

FIG. 5A: Thermal stability of human lysozyme (“Hlys”) and recombinant human lysozyme from transgenic rice (“rHLys”). Lysozyme was dissolved at 100 μg/ml in PBS. The mixtures were subjected to different temperatures for different lengths of time. At the end of each heat treatment, the remaining lysozyme activity was assessed by activity assay. FIG. 5B: pH stability of Hlys and rHlys. Lysozyme was dissolved in different buffers at 100 μg/ml. The mixture was incubated at 37° C. for 30 min. The lysozyme activity was determined by activity assay.

FIG. 6 presents the results of an analysis of lysozyme expression in transgenic rice grains over several generations. Proteins from 1 g of brown rice flour were extracted with 40 ml of extraction buffer containing 0.35 M NaCl in PBS. Extraction was conducted at room temperature for 1 h with shaking. Homogenate was centrifuged at 14,000 rpm for 15 min at 4° C. Protein supernatant was removed and diluted as needed for lysozyme turbidimetric activity assay. Extraction was repeated three times and standard deviation was shown as an error bar. Lysozyme yield was expressed as percentage of total soluble protein (% TSP).

FIG. 7 is a restriction map of the pAPI164 plasmid that contains the human lactoferrin coding sequence under the control of a rice glutelin (Gt1) promoter, aGt1 signal peptide, and a nopaline synthase (NOS) terminator/polyadenylation site.

FIG. 8 shows the results of a SDS-PAGE analysis for human lactoferrin stained with Coomassie blue, where lane 1 is the molecular weight marker; lanes 2-5 are purified human derived lactoferrin (Sigma, USA); lanes 6-10 are single seed extracts from homozygous transgenic lines and lane 11 is a seed extract from non-transformed TP-309.

FIG. 9 shows the results of a Western blot analysis of various tissues of the transgenic rice plants, demonstrating the tissue specificity of rLF expression. Lane 1 is the molecular weight marker; lane 2 is human lactoferrin (Sigma, USA); lane 3 is an extract from leaf; lane 4 is an extract from sheath; lane 5 is an extract from root; lane 6 is an extract from seed and lane 7 is an extract from 5-day germinated seeds.

FIG. 10 is a bar diagram illustrating the bactericidal effect of native human lactoferrin (“nHLF”) and purified recombinant human lactoferrin produced by transgenic rice (“rHLF”) on growth of E. coli (EPEC) after pepsin/pancreatic treatment.

FIG. 11 is a graph illustrating pH-dependent iron release by native human lactoferrin (“nHLF”) and purified recombinant human lactoferrin produced by transgenic rice seeds (“rHLF”).

FIG. 12 shows the binding and uptake of HLf to Caco-2 cells after in vitro digestion.

FIG. 12 A shows the determination of Dissociation constant.

FIG. 12B shows the number of binding sites for HLf on Caco-2 cells.

FIG. 12C shows the total uptake of HLf and Fe to Caco-2 cells within 24 h.

FIG. 12D shows degradation of HLf after uptake into Caco cells determined by the amount of free ¹²⁵I in the cell fractions.

FIG. 13 shows three AAT plasmids: pAPI255 containing Glb promoter, Glb signal peptide, codon-optimized AAT gene, Nos terminator and ampicillin resistence gene;pAPI250 containing Gt1 promoter, Gt1 signal peptide, codon-optimized AAT gene, Nos terminator and ampicillin resistance gene; and pAPI282 containing Bx7 promoter, Bx7 signal peptide, codon-optimized AAT gene, Nos terminator and ampicillin resistance gene.

FIG. 14 shows Coomassie brilliant blue staining of aqueous phase extraction of transgenic rice cells expressing human AAT. Both untransformed and transgenic rice grains were ground with PBS. The resulting extract was spun at 14,000 rpm at 4° C. for 10 min. Supernanant was collected and loaded onto a precast SDS-PAGE gel.

FIG. 15 shows Western blot analysis of recombinant human AAT from transgenic rice grains. The extract from transgenic rice grain was separated by SDS-PAGE gel and then blotted onto a filter. The identification of AAT in rice grain was carried out by anti-AAT antibody by Western analysis.

FIGS. 16A-B shows Coomassie staining (FIG. 16A) and western blot analysis (FIG. 16B) of protein from transgenic rice grains expressing AAT. The activity of rAAT was demonstrated by a band shift assay. AAT samples from different sources were incubated with equal moles of porcine pancreatic elastase (PPE) at 37° C. for 15 min. Negative control for band shift assay was prepared with the AAT samples incubated with equal volume of PPE added. Lane M is molecular weight markers. Lane 1a is purified AAT from human plasma. Lane 1b is purified AAT from human plasma+PPE. Lane 2a is protein extract containing AAT from transgenic rice seed; Lane 2b is protein extract containing AAT from transgenic rice seed+PPE. Lane 3a is untransformed seed extract. Lane 3b is untransformed seed extract+PPE. A shifted band was shown in lane 1b, 2b and 3b in FIG. 16A. The shifted band was confirmed to contain AAT entity by Western blot in FIG. 16B.

FIG. 17A-C are schematic representations of 3 plasmids containing the Reb coding sequence under the control of 3 dfferent promoters.

FIG. 17A shows the globulin promoter (Glb), with the Reb gene and the Reb terminator.

FIG. 17B shows the actin promoter (Act), with the Reb gene and the Reb terminator.

FIG. 17C shows the native Reb promoter, with the Reb gene and the Reb terminator.

FIGS. 18A-B are schematic depictions of 2 plasmids which contain different transcription factor coding sequences under the control of the rice endosperm-specific glutelin promoter (Gt-1).

FIG. 18A shows plasmid pGT1-BPBF (API286) containing the Gt1 promoter, barley prolamin box binding factor (BPBF), Nos terminator and kanamycin resistance gene.

FIG. 18B shows pGT1-PBF (API285) containing the Gt1 promoter, the maize prolamin box binding factor (PBF), Nos terminator and kanamycin resistance gene.

FIG. 19 illustrates the results of an analysis for the expression of recombinant human lysozyme in mature seed of T₀ transgenic plants derived from progenitor cells transformed with constructs containing the human lysozyme gene expressed under the control of the Glb promoter and the Reb gene expressed under the control of its own promoter (“Native-Reb”). Seeds of 30 plants containing the Reb and lysozyme genes and seeds from 17 plants containing only the lysozyme gene were analyzed for lysozyme, with twenty individual seeds of each plant analyzed.

FIG. 20 is a comparison of the codon-optimized epidermal growth factor sequence (“Egfactor”) with a native epidermal growth factor sequence (“Native Gene”), aligned to show 53 codons in the mature sequences, with 27 (51%) codon changes and 30 (19%) nucleotides changes.

FIG. 21 is a restriction map of the 4,143 bp plasmid, API270 (pGlb-EFG v2.1), showing an expression cassette for epidermal growth factor (“EGF”), and containing a Glb promoter, a Glb signal peptide, codon optimized EGF, a Nos terminator and an ampicillin resistance selectable marker.

FIG. 22 is a restriction map of the 3877 bp plasmid, API303 (pGt1-EGF v2.1), showing an expression cassette for epidermal growth factor (EGF), and containing a rice Gt1 promoter, a Gt1 signal peptide, codon optimized EGF, a Nos terminator and an ampicillin resistance selectable marker.

FIG. 23 is a Western blot analysis of recombinant human EFG (“rhEGF”) in transgenic rice seed. Lane 1 shows a broad range of molecular weight markers. Lane 2 shows rhEGF expressed in yeast, loaded at 125 ng. Lanes 2 to 6 show rhEGF expressed from different transgenic rice seeds. Lane 7 is from seeds of control untransformed TP 309.

FIG. 24 is a comparison of the codon-optimized insulin-like growth factor I sequence (“Insgfact”) with a native human insulin-like growth factor I sequence (“native Gene”), aligned to show 70 codons in the mature sequences, with 40 (57%) codon changes and 47 (22%) nucleotides changes.

FIG. 25 is a restriction map of the 3928 bp plasmid, API304 (pGt1-IFG v2.1), showing an expression cassette for insulin-like growth factor I (“IGF”), and containing a rice Gt1 promoter, a Gt1 signal peptide, codon optimized IGF, a Nos terminator and an ampicillin resistance selectable marker.

FIG. 26 is a restriction map of the 4194 bp plasmid, API271 (pGlb-IGF v2.1), showing an expression cassette for insulin-like growth factor I (“IGF”), and containing a Glb promoter, a Glb signal peptide, codon optimized IGF, a Nos terminator and an ampicillin resistance selectable marker.

FIG. 27 is a Western blot analysis of recombinant human IGF-I (“rhlGF”) expressed in transgenic rice seeds. Lane 1 shows a broad range of molecular weight markers. Lane 2 shows rhlGF expressed in yeast, loaded at 1 μg. Lanes 3-9 show rhlGF from different transgenic seeds. Lane 10 is from seeds of control untransformed TP 309.

FIG. 28 is a restriction map of the 5250 bp plasmid, API321 (pGlb-gt1sig-Haptocorrin v 2.1), showing an expression cassette for haptocorrin, and containing a Glb promoter, a Gt1 signal peptide, codon optimized haptocorrin, a Nos terminator and an ampicillin resistance selectable marker.

FIG. 29 is a restriction map of the 4948 bp plasmid, API320 (pGt1-Haptocorrin v 2.1), showing an expression cassette for haptocorrin, and containing a Gt1 promoter, a Gt1 signal peptide, codon optimized haptocorrin, a Nos terminator and an ampicillin resistance selectable marker.

FIG. 30 is a restriction map of the 4468 bp plasmid, API292 (pGlb-kcasein v2.1), showing an expression cassette for kappa-casein (“k-casein”), and containing a Glb promoter, a Glb signal peptide, a k-casein gene, a Nos terminator and an ampicillin resistance selectable marker.

FIG. 31 is a restriction map of the 4204 bp plasmid, API297 (pGT1-kaapa-Casein v2.1), showing an expression cassette for kappa-casein, and containing a Gt1 promoter, a Gt1 signal peptide, mature kappa-casein polypeptide encoding gene, a Nos terminator and an ampicillin resistance selectable marker.

FIG. 32 is a restriction map of the 4834 bp plasmid, API420 (pGt1-LAD), showing an expression cassette for lactahedrin, and containing a Gt1 promoter, a Gt1 signal peptide, lactohedrin gene, a Nos terminator and a kanamycin resistance selectable marker.

FIG. 33 is a restriction map of the 5638 bp plasmid, API418 (pGT1-LPO-S), showing an expression cassette for lactoperoxidase (minus the propeptide), and containing a Gt1 promoter, a Gt1 signal peptide, lactoperoxidase gene without the propeptide, a Nos terminator and a kanamycin resistance selectable marker.

FIG. 34 is a restriction map of the 5801 bp plasmid, API416 (pGt1-lactoperoxidase), showing an expression cassette for codon optimized human lactoperoxidase, and containing a rice Gt1 promoter, a Gt1 signal peptide, codon optimized lactoperoxidase, a Nos terminator and a kanamycin resistance selectable marker.

FIG. 35 is a restriction map of the 4408 bp plasmid, API230 (pBX7-Lysozyme v2.1.1), showing an expression cassette for codon optimized lysozyme, and containing a BX-7 promoter, a Gt1 signal peptide, codon optimized lysozyme gene, a Nos terminator and an ampicillin resistance selectable marker.

FIGS. 36A-B represent schematic diagrams of the map of 2 plasmids, API254 (FIG. 36A) and API264 (FIG. 36B) containing heterologous protein coding sequences under the control of the rice endosperm-specific globulin promoter (Glb), the Glb signal peptide, and Nos terminator. API254 contains the lactoferrin coding sequence, and API264 contains the human lysozyme coding sequence.

FIG. 37 is a restriction map of the 4271 bp plasmid, API225, showing an expression cassette for codon optimized lysozyme, and containing a GT-3 promoter, a Gt1 signal peptide, codon optimized lysozyme, a Nos terminator and an ampicillin resistance selectable marker.

FIG. 38 is a restriction map of the 4106 bp plasmid, API229, showing an expression cassette for codon optimized lysozyme, and containing a RP-6 promoter, a Gt1 signal peptide, codon optimized lysosyme, a Nos terminator and an ampicillin resistance selectable marker.

FIG. 39 is a comparison of the expression of lysozyme under Gt1 or Glb promoter with Gt1 signal peptide or Glb signal peptide. FIG. 50A is a schematic representation of plasmid API159 that contains Gt1 promoter, Gt1 signal peptide, a lysozyme gene and Nos terminator; plasmid API228 that contains Glb promoter, Gt1 signal peptide, a lysozyme gene and Nos terminator; and plasmid API264 that contains Glb promoter, Glb signal peptide, a lysozyme gene and Nos terminator. FIG. 39B shows the activities of lysozyme in lysozyme-positive seeds produced in transgenic rice plants transformed with API159, API228 and API264. The seeds from multiple lines of each construct were analyzed by the lysozyme activity assay. Individual seeds from each plant were analyzed. Seeds lacking detectable amounts of lysozyme were excluded. The activities of 20-lysozyme-positive seeds per plant, including both hemizygous and homozygous seeds were averaged. The average activities were plotted on the chart.

FIG. 40 shows the expression time course of human lysozyme during endosperm development in transgenic line. Ten spikelets were harvested at 7, 14, 21, 28, 35, 42 and 49 days after pollination (“DAP”) and analyzed by the lysozyme activity assay. The dark bars were from 159-1-53-16-1. The light bars were from 264-1-92-6-1.

FIG. 41 is a bar graph comparing the level of lysozyme expression in transgenic T1 rice seeds under 7 different promoters: Gt1, Glb, Glub-2, Bx7, Gt3, Glub-1 and Rp6. All constructs contained a Gt1 signal peptide.

### DETAILED DESCRIPTION OF THE INVENTION

I. Definitions

Unless otherwise indicated, all terms used herein have the meanings given below, and are generally consistent with same meaning that the terms have to those skilled in the art of the present invention. Practitioners are particularly directed to Sambrook et al. (1989) Molecular Cloning: A Laboratory Manual (Second Edition), Cold Spring Harbor Press, Plainview, N.Y. and Ausubel F M et al. (1993) Current Protocols in Molecular Biology, John Wiley & Sons, New York, N.Y., for definitions and terms of the art. It is to be understood that this invention is not limited to the particular methodology, protocols, and reagents described, as these may vary.

All publications cited herein are expressly incorporated herein by reference for the purpose of describing and disclosing compositions and methodologies that might be used in connection with the invention.

The term “polypeptide” refers to a biopolymer compound made up of a single chain of amino acid residues linked by peptide bonds. The term “protein” as used herein may be synonymous with the term “polypeptide” or “peptide” or may refer, in addition, to a complex of two or more polypeptides.

The term “anti-bacterial protein” refers to a polypeptide that is has the ability to limit or diminish the intensity or duration of infection by a micro-organism, e.g., bacteria, virus, or fungal organism, when administered to the gut of a production animal. Included within this group of proteins are those that are (i) “bacteriostatic protein,” meaning the protein is capable of inhibiting the growth of, but not capable of killing bacteria, (ii) “bactericidal protein,” meaning a protein capable of killing bacteria, (iii) anti-viral proteins, (iii) agents, such as alpha-antitrypsin, that act, at least in part, by reducing proteolysis of other anti-microbial proteins, (iv) acute phase proteins which are induced in production animals in response to infection, (v) probiotic proteins, and (vi) cationic antimicrobial proteins, such as bactericidal permeability increasing protein, lactoferrin, transferrin, cathepsin G, cystatin, CAP18, and pepsinogen C. (See, e.g., Robert E. W. Hancock et al., 2000.), recognizing that some anti-microbial proteins will be in two or more of these classes.

“Anti-microbial proteins” include, without limitation,

(i) anti-microbial milk proteins (either human or non-human) lactoferrin, lysozyme, lactoferricin, lactohedrin, kappa-casein, haptocorrin, lactoperoxidase, alpha-1-antitrypsin, and immunoglobulins, e.g., IgA,

(ii) acute-phase proteins, such as C-reactive protein (CRP); lactoferrin; lysozyme; serum amyloid A (SAA); ferritin; haptoglobin (Hp); complements 2-9, in particular complement-3; seromucoid; ceruloplasmin (Cp); 15-keto-13,14-dihydro-prostaglandin F2 alpha (PGFM); fibrinogen (Fb); alpha(1)-acid glycoprotein (AGP); alpha(1)-antitrypsin; mannose binding protein; lipoplysaccharide binding protein; alpha-2 macroglobulin and various defensins,

(iii) antimicrobial peptides, such as cecropin, magainin, defensins, tachyplesin, parasin l,buforin I, PMAP-23, moronecidin, anoplin, gambicin, and SAMP-29, and

(iv) other anti-microbial protein(s), including CAP37, granulysin, secretory leukocyte protease inhibitor, CAP18, ubiquicidin, bovine antimicrobial protein-1, Ace-AMP1, tachyplesin, big defensin, Ac-AMP2, Ah-AMP1, and CAP18.

The term “milk protein” or “proteins normally present in milk” refers to a protein or biologically active fragments thereof, found in normal mammalian milk, e.g., human milk, including, without limitation, of lactoferrin, lysozyme, lactoferricin, EGF, IGF-I, lactohedrin, kappa-casein, haptocorrin, lactoperoxidase, alpha-1-antitrypsin, and immunoglobulins, and biologically active fragments thereof. The milk protein may be human milk protein, i.e., having the protein sequence of a normal human milk protein, or active fragment thereof, or of another mammalian source, e.g., bovine or ovine, or of a non-mammalian source, e.g., avian source.

The term “active fragments of an anti-microbial protein” refers to a modified anti-microbial protein containing either amino acid substitutions, deletions or additions, or fragment substitutions or deletions, but retain the anti-microbial activity of the native anti-microbial protein.

A “small-molecule antibiotic” refers to one a non-peptide antibiotic having a molecular weight typically less than 2 Kdaltons, typically of fungal origin, meaning produced by a strain of fungus, or being an analog of such a compound. Exemplary small-molecule antibiotics that have been used in animal feed, at subclinical levels, include, as examples, bacitracin, roxarsone; penicillin G, amoxicillin, semduramicin, chlortetracycline, tetracycline, neomycin, salinomycin, and virginiamycin.

The term “vector” refers to a nucleic acid construct designed for transfer between different host cells. An “expression vector” refers to a vector that has the ability to incorporate and express heterologous DNA fragments in a foreign cell. Many prokaryotic and eukaryotic expression vectors are commercially available. Selection of appropriate expression vectors is within the knowledge of those having skill in the art. Accordingly, an “expression cassette” or “expression vector” is a nucleic acid construct generated recombinantly or synthetically, with a series of specified nucleic acid elements that permit transcription of a particular nucleic acid in a target cell. The recombinant expression cassette can be incorporated into a plasmid, chromosome, mitochondrial DNA, plastid DNA, virus, or nucleic acid fragment. Typically, the recombinant expression cassette portion of an expression vector includes, among other sequences, a nucleic acid sequence to be transcribed and a promoter.

The term “plasmid” refers to a circular double-stranded (ds) DNA construct used as a cloning vector, and which forms an extrachromosomal self-replicating genetic element in many bacteria and some eukaryotes.

The term “selectable marker-encoding nucleotide sequence” refers to a nucleotide sequence capable of expression in plant cells and where expression of the selectable marker confers to plant cells containing the expressed gene the ability to grow in the presence of a selective agent. As used herein, the term “Bar gene” refers to a nucleotide sequence encoding a phosphinothricin acetyltransferase enzyme that upon expression confers resistance to the herbicide glufosinate-ammonium (“Basta”).

A “transcription regulatory region” or “promoter” refers to nucleic acid sequences that influence and/or promote initiation of transcription. Promoters are typically considered to include regulatory regions, such as enhancer or inducer elements. The promoter will generally be appropriate to the host cell in which the target gene is being expressed. The promoter, together with other transcriptional and translational regulatory nucleic acid sequences (also termed “control sequences”), is necessary to express any given gene. In general, the transcriptional and translational regulatory sequences include, but are not limited to, promoter sequences, ribosomal binding sites, transcriptional start and stop sequences, translational start and stop sequences, and enhancer or activator sequences.

“Chimeric gene” or “heterologous nucleic acid construct”, as defined herein refers to a construct which has been introduced into a host and may include parts of different genes of exogenous or autologous origin, including regulatory elements. A chimeric gene construct for plant/seed transformation is typically composed of a transcriptional regulatory region (promoter) operably linked to a heterologous protein coding sequence, or, in a selectable marker heterologous nucleic acid construct, to a selectable marker gene encoding a protein conferring antibiotic resistance to transformed plant cells. A typical chimeric gene of the present invention, includes a transcriptional regulatory region inducible during seed development, a protein coding sequence, and a terminator sequence. A chimeric gene construct may also include a second DNA sequence encoding a signal peptide if secretion of the target protein is desired.

A nucleic acid is “operably linked” when it is placed into a functional relationship with another nucleic acid sequence. For example, DNA for a presequence or secretory leader is operably linked to DNA for a polypeptide if it is expressed as a preprotein that participates in the secretion of the polypeptide; a promoter or enhancer is operably linked to a coding sequence if it affects the transcription of the sequence; or a ribosome binding site is operably linked to a coding sequence if it is positioned so as to facilitate translation. Generally, “operably linked” means that the DNA sequences being linked are contiguous, and, in the case of a secretory leader, contiguous and in reading frame. However, “operably linked” elements, e.g., enhancers, do not have to be contiguous. Linking is accomplished by ligation at convenient restriction sites. If such sites do not exist, the synthetic oligonucleotide adaptors or linkers are used in accordance with conventional practice.

The term “gene” means the segment of DNA involved in producing a polypeptide chain, which may or may not include regions preceding and following the coding region, e.g. 5′ untranslated (5′ UTR) or “leader” sequences and 3′ UTR or “trailer” sequences, as well as intervening sequences (introns) between individual coding segments (exons).

The term “sequence identity” means nucleic acid or amino acid sequence identity in two or more aligned sequences, aligned using a sequence alignment program.

The term “% homology” is used interchangeably herein with the term “% identity” and refers to the level of nucleic acid or amino acid sequence identity between two or more aligned sequences, when aligned using a sequence alignment program. For example, 70% homology means the same thing as 70% sequence identity determined by a defined algorithm, and accordingly a homologue of a given sequence has greater than 80% sequence identity over a length of the given sequence. Exemplary levels of sequence identity include, but are not limited to, 80, 85, 90 or 95% or more sequence identity to a given sequence, e.g., the coding sequence for lactoferrin, as described herein.

Exemplary computer programs which can be used to determine identity between two sequences include, but are not limited to, the suite of BLAST programs, e.g., BLASTN, BLASTX, and TBLASTX, BLASTP and TBLASTN, publicly available on the Internet at “www.ncbi.nih.gov/BLAST/”. See, also, Altschul, S. F. et al., 1990 and Altschul, S. F. et al., 1997.

Sequence searches are typically carried out using the BLASTN program when evaluating a given nucleic acid sequence relative to nucleic acid sequences in the GenBank DNA Sequences and other public databases. The BLASTX program is preferred for searching nucleic acid sequences which have been translated in all reading frames against amino acid sequences in the GenBank Protein Sequences and other public databases. Both BLASTN and BLASTX are run using default parameters of an open gap penalty of 11.0, and an extended gap penalty of 1.0, and utilize the BLOSUM-62 matrix. [See, Altschul, et al., 1997.]

A preferred alignment of selected sequences in order to determine “% identity” between two or more sequences, is performed using for example, the CLUSTAL-W program in MacVector version 6.5, operated with default parameters, including an open gap penalty of 10.0, an extended gap penalty of 0.1, and a BLOSUM 30 similarity matrix.

A nucleic acid sequence is considered to be “selectively hybridizable” to a reference nucleic acid sequence if the two sequences specifically hybridize to one another under moderate to high stringency hybridization and wash conditions. Hybridization conditions are based on the melting temperature (Tm) of the nucleic acid binding complex or probe. For example, “maximum stringency” typically occurs at about Tm-5° C. (5° below the Tm of the probe); “high stringency” at about 5-10° below the Tm; “intermediate stringency” at about 10-20° below the Tm of the probe; and “low stringency” at about 20-250 below the Tm. Functionally, maximum stringency conditions may be used to identify sequences having strict identity or near-strict identity with the hybridization probe; while high stringency conditions are used to identify sequences having about 80% or more sequence identity with the probe.

Moderate and high stringency hybridization conditions are well known in the art (see, for example, Sambrook et al, 1989, Chapters 9 and 11, and in Ausubel et al., 1993, expressly incorporated by reference herein). An example of high stringency conditions includes hybridization at about 42° C. in 50% formamide, 5× SSC, 5× Denhardt's solution, 0.5% SDS and 100 μg/ml denatured carrier DNA followed by washing two times in 2× SSC and 0.5% SDS at room temperature and two additional times in 0.1× SSC and 0.5% SDS at 42° C.

As used herein, “recombinant” includes reference to a cell or vector, that has been modified by the introduction of a heterologous nucleic acid sequence or that the cell is derived from a cell so modified. Thus, for example, recombinant cells express genes that are not found in identical form within the native (non-recombinant) form of the cell or express native genes that are otherwise abnormally expressed, under expressed or not expressed at all as a result of deliberate human intervention.

A plant cell, tissue, organ, or plant into which a heterologous nucleic acid construct comprising the coding sequence for an anti-microbial protein or peptide has been introduced is considered transformed, transfected, or transgenic. A transgenic or transformed cell or plant also includes progeny of the cell or plant and progeny produced from a breeding program employing such a transgenic plant as a parent in a cross and exhibiting an altered phenotype resulting from the presence of the coding sequence for an anti-microbial protein. Hence, a plant of the invention will include any plant which has a cell containing introduced nucleic acid sequences, regardless of whether the sequence was introduced into the plant directly through transformation means or introduced by generational transfer from a progenitor cell which originally received the construct by direct transformation.

The term “transgenic plant” refers to a plant that has incorporated exogenous nucleic acid sequences, i.e., nucleic acid sequences which are not present in the native (“untransformed”) plant or plant cell. Thus a plant having within its cells a heterologous polynucleotide is referred to herein as a “transgenic plant”. The heterologous polynucleotide can be either stably integrated into the genome, or can be extra-chromosomal. Preferably, the polynucleotide of the present invention is stably integrated into the genome such that the polynucleotide is passed on to successive generations. The term “transgenic” as used herein does not encompass the alteration of the genome (chromosomal or extra-chromosomal) by conventional plant breeding methods or by naturally occurring events such as random cross-fertilization, non-recombinant viral infection, non-recombinant bacterial transformation, non-recombinant transposition, or spontaneous mutation. “Transgenic” is used herein to include any cell, cell line, callus, tissue, plant part or plant, the genotype of which has been altered by the presence of heterologous nucleic acids including those transgenics initially so altered as well as those created by sexual crosses or asexual reproduction of the initial transgenics.

Terms “transformed”, “stably transformed” or “transgenic” with reference to a plant cell means the plant cell has a non-native (heterologous) nucleic acid sequence integrated into its genome which is maintained through two or more generations.

The term “expression” with respect to a protein or peptide refers to the process by which the protein or peptide is produced based on the nucleic acid sequence of a gene. The process includes both transcription and translation. The term “expression” may also be used with respect to the generation of RNA from a DNA sequence.

The term “introduced” in the context of inserting a nucleic acid sequence into a cell, means “transfection”, or “transformation” or “transduction” and includes the incorporation of a nucleic acid sequence into a eukaryotic or prokaryotic cell where the nucleic acid sequence may be incorporated into the genome of the cell (for example, chromosome, plasmid, plastid, or mitochondrial DNA), converted into an autonomous replicon, or transiently expressed (for example, transfected mRNA).

By “host cell” is meant a cell which contains a vector and supports the replication, and/or transcription or transcription and translation (expression) of the expression construct. Host cells for use in the present invention can be prokaryotic cells, such as E. coli, or eukaryotic cells such as yeast, plant, insect, amphibian, or mammalian cells. In general, host cells are monocotyledenous or dicotyledenous plant cells.

A “plant cell” refers to any cell derived from a plant, including undifferentiated tissue (e.g., callus) as well as plant seeds, pollen, progagules and embryos.

The term “mature plant” refers to a fully differentiated plant.

The terms “native” and “wild-type” relative to a given plant trait or phenotype refers to the form in which that trait or phenotype is found in the same variety of plant in nature.

The term “plant” includes reference to whole plants, plant organs (for example, leaves, stems, roots, etc.), seeds, and plant cells and progeny of same. Plant cell, as used herein includes, without limitation, seeds, suspension cultures, embryos, meristematic regions, callus tissue, leaves roots shoots, gametophytes, sporophytes, pollen, and microspores. The class of plants that can be used in the methods of the present invention is generally as broad as the class of higher plants amenable to transformation techniques, including both monocotyledenous and dicotyledenous plants.

The term “seed” is meant to encompass all seed components, including, for example, the coleoptile and leaves, radicle and coleorhiza, scutulum, starchy endosperm, aleurone layer, pericarp and/or testa, either during seed maturation and seed germination.

The term “seed in a form for use as a food or food supplement” includes, but is not limited to, seed fractions such as de-hulled whole seed, flour (seed that has been de-hulled by milling and ground into a powder) a seed protein extract (where the protein fraction of the flour has been separated from the carbohydrate fraction) and/or a purified protein fraction derived from the transgenic grain.

The term “purifying” is used interchangeably with the term “isolating” and generally refers to the separation of a particular component from other components of the environment in which it was found or produced. For example, purifying a recombinant protein from plant cells in which it was produced typically means subjecting transgenic protein containing plant material to biochemical purification and/or column chromatography.

The term “animal feed” refers to feed, commercial or otherwise, used as part or all of the diet of a production animal. The feed is typically a mixture or grains or grain-derived components and one or more nutritional supplements, e.g., amino acids, fat, vitamins, minerals, and the like.

“Monocot seed components” refers to carbohydrate, protein, and lipid components extractable from monocot seeds, typically mature monocot seeds.

“Malted-seed components” refers to seed-derived components, predominantly carbohydrate components, after conversion of complex carbohydrates to malt sugars by malting, i.e., treating with malting enzymes such as a barley amylase and glucanases, under conditions effective to conversion seed-derived carbohydrates to malt sugars.

“Substantially unpurified form”, as applied to anti-microbial proteins in a seed extract means that the protein or proteins present in the extract are present in an amount less than 50% by weight, typically between 0.25 and 2.5 percent by weight.

“Seed maturation” or “grain development” refers to the period starting with fertilization in which metabolizable reserves, e.g., sugars, oligosaccharides, starch, phenolics, amino acids, and proteins, are deposited, with and without vacuole targeting, to various tissues in the seed (grain), e.g., endosperm, testa, aleurone layer, and scutellar epithelium, leading to grain enlargement, grain filling, and ending with grain desiccation.

“Inducible during seed maturation” refers to promoters which are turned on substantially (greater than 25%) during seed maturation.

“Heterologous DNA” or “foreign DNA” refers to DNA which has been introduced into plant cells from another source, or which is from a plant source, including the same plant source, but which is under the control of a promoter or terminator that does not normally regulate expression of the heterologous DNA.

“Heterologous protein” is a protein, including a polypeptide, encoded by a heterologous DNA.

A “signal/targeting/transport sequence” is an N- or C-terminal polypeptide sequence which is effective to localize the polypeptide or protein to which it is attached to a selected intracellular or extracellular region, including an intracellular vacuole or other protein storage body, chloroplast, mitochondria, or endoplasmic reticulum, or extracellular space or seed region, such as the endosperm, following secretion from the cell.

A “product” encoded by a DNA molecule includes, for example, RNA molecules and polypeptides.

A DNA sequence is “derived from” a gene if it corresponds in sequence to a segment or region of that gene. Segments of genes which may be derived from a gene include the promoter region, the 5′ translated region, and the 3′ untranslated region of the gene.

“Alpha-amylase” as used herein refers to an enzyme which principally breaks starch into dextrins.

“Beta-amylase” as used herein refers to an enzyme which converts start and dextrins into maltose.

“Cereal adjuncts” as used herein refers to cereal grains, principally barley, wheat, rye, oats, maize, sorghum and rice, or processed whole or portions thereof, especially the starch fraction, which are added to the barley mash, which allows the barley enzymes to hydrolyze both the barley starch and the starch derived from the cereal adjunct. “Transgenic cereal adjuncts” as used herein refers to transgenic cereal grains, principally barley, wheat, rye, oats, maize, sorghum and rice, and which is expressing a recombinant molecule in a grain part, principally the endosperm (starch) layer.

“Conversion” as used herein refers to the process of starch hydrolysis, usually catalyzed by acid or enzyme action, which produces dextrose, maltose, and higher polysaccharides from starch.

“Diastatic enzyme (amylolytic)” as used herein refers to an enzyme capable of causing the hydrolysis of starch.

“Diastatic malt flour” as used herein refers to enzyme active flour milled from germinated (malted) barley.

“Diastatic malt syrup” as used herein refers to enzyme active liquid malt syrup (barley and cereal adjuncts).

“Dry diastatic malt” as used herein refers to a blend of diastatic malted barley flour, wheat flour and dextrose with standardized enzyme levels at 20 degrees and 60 degrees Lintner.

“Dry nondiastatic malt” as used herein refers to spray dried form of liquid nondiastatic malt extract or syrup.

“Lintner” as used herein refers to a laboratory measurement of enzyme activity strength. The higher the value, the higher activity.

“Dried malt” as used herein refers to the dried grain resulting form controlled germination of cereal grins, usually barley, but other cereals can be malted as well.

“Malt extract” as used herein refers to a viscous concentrate of the water extract of dried malt.

“Maltodextrin” as used herein refers to a purified, concentrated aqueous solution of nutritive saccharides, obtained form edible starch, or the dried product derived from the solution. Maotodextrins have a dextrose equivalent of less than 20 and are considered ‘non-sweet soluble solids’. They are usually marketed dry, but may be obtained as a concentrated solution. Maltodextrins are usually offered as 10 to 14 D.E. products or as 15 to 19 D.E. versions. Another maltodextrin, with a D.E. of about 5, is sometimes manufactured, but currently not used widely. Composition of maltodextrins is roughly 65 to 80% higher saccharides, 4 to 9% pentasaccharides, 4 to 7% tetrasaccharides, and 5 to 9% trisaccharides. Traces of mono and disaccharides are present. They are usually used as bulking agents or viscosity builders, without sweetness.

“Malt syrup” as used herein refers to viscious concentrate of the water extract of dried ‘malt’ and other cereal grains.

“Malt” refers to a malt extract or malt syrup.

“Nondiastatic malt syrup” as used herein refers to liquid malt syrup (barley and cereal adjuncts) without enzyme activity.

“Transgenic malt extract” as used herein refers to a vicious concentrate of the water extract of dried malt which includes a recombinant protein, polypeptide and/or metabolite.

“Transgenic malt syrup” as used herein refers to vicious concentrate of the water extract of dried ‘malt’ and other cereal grains which includes a recombinant protein, polypeptide and/or metabolite.

The term “production animals” includes poultry, such as chickens, turkeys, squab, and ducks, and hoofed farm animals, such as cattle, sheep, goats, and pigs that are grown and harvested for human food consumption.

II. Animal Feed-State of the Art

As described above, animal feed typically contains sub-therapeutic levels of antibiotics, which have been found to increase weight gain in animals by about 3-15% over a given feed period. The antibiotics are believed to suppress the microbial flora, and hence reduce the immune responses in the animal to low-level infection. Untreated, such immune responses result in the animal eating less and therefore gaining less weight. In other words, the antibiotics help keep the animal in a “hungry” healthy state.

It has been reported that a loss of about 20% animal weight results from filthy animal-growing conditions, and a reclamation of about 4-15% of the “lost” weight takes place when antibiotics are incorporated into feed.

The reactions of an animal's immune system to infection is both specific against the causal agent and nonspecific, yielding predictable metabolic changes termed the “acute-phase response” (Johnson, 1997). The acute phase proteins (APP) produced during this response play a major role in the inflammatory process in mammals. In human and veterinary medicine, determination of the plasma concentration of these proteins gives valuable clinical information on the infection inflammation process (See, e.g., Gruys et al., 1994.)

In general, the inflammatory response begins with release of interleukin-1 (IL-1) and tumor necrosis factor-alpha (TNF-alpha) by monocytes and macrophages that subsequently activates a complex cascade of other inflammatory mediators including IL-2, IL-6 and IL-8 (Dinarello, 1994; Jensen et aL, 1998).

The various acute phase proteins rise in response to activation by pro-inflammatory cytokines (such as IL-1 and TNF-alpha) that are secreted into the circulation from sites of infection or inflammatory lesions. The infection may be subclinical and of bacterial, viral or other origin and still effect both growth and appetite in animals.

Data in chicks, rats, and mice implicate interleukin-1 (IL-1), tumor necrosis factor-alpha (TNF), and interleukin-6 (IL-6), as the primary monokines involved in the acute-phase response. The metabolic changes orchestrated by these cytokines represent a homeostatic response that alter the partitioning of dietary nutrients away from the growth and skeletal muscle accretion in favor of metabolic processed that support their immune response and disease resistance.

The release of cytokines leads to both the stimulation and inhibition of protein synthesis. Exemplary positive acute phase proteins, include C-reactive protein (CRP); lactoferrin; lysozyme; serum amyloid A (SAA); ferritin; haptoglobin (Hp); complements 2-9, in particular complement-3; seromucoid; ceruloplasmin (Cp); 15-keto-13,14-dihydro-prostaglandin F2 alpha (PGFM); fibrinogen (Fb); alpha(1)-acid glycoprotein (AGP); alpha(1)-antitrypsin; mannose binding protein; lipoplysaccharide binding protein; alpha-2 macroglobulin and various defensins. (See, e.g., Laurell, 1985 and Thompson et al., 1992.) The circulating concentration of these acute phase proteins are biochemical markers of inflammation. Cytokines can also inhibit the synthesis of proteins (negative acute phase proteins), e.g., serum albumin and transferrin. (See, e.g., P. D. Eckersall, Ed., IN: TEXTBOOK OF THE JAPANESE SOCIETY OF VETERINARY CLINICAL PATHOLOGY 10-21, 1999; Regassa et al., 1999.)

Acute phase proteins that are reportedly produced by the intestinal epithelium include, but are not limited to, serum amyloid a, complement-3, mannose binding protein and various defensins.

In the past decade, the role of anti-microbial proteins has become increasingly apparent and there is a growing body of evidence that their role in defense against microbes may be as important to the host as antibodies, immune cells, and phagocytes.

Analysis of serum acute phase proteins such as SAA, Hp and AGP in bovine serum or plasma suggests a correlation to a number of disease states and may be used by meat inspectors to identify animals with current infection. (See, e.g., Conner et al., 1989; Wittum et al., 1996; Hofner et al., 1994; Horadagoda et al., 1994; Hirvonen et al., 1996; Horadagoda et al., 1999; Salonen et al., 1996; and Saini et al., 1998.)

Cationic anti-microbial peptides are also involved in the response to infection in all mammals and may be constitutively expressed or induced by infectious organisms or their products. A number of antimicrobial peptides show activity against a broad range of bacterial strains, including antibiotic-resistant isolates. Although the mechanism is not part of the invention, the antimicrobial peptides prevent cytokine induction by bacterial products in tissue culture and human blood, and they block the onset of sepsis in mouse models of endotoxemia. Exemplary antimicrobial peptides include, but are not limited to, animal cationic proteins such as bactericidal permeability increasing protein, lactoferrin, transferrin, cathepsin G, cystatin, CAP18, pepsinogen C, ribosomal protein S30, etc. (See, e.g., Robert E. W. Hancock et a!., 2000.)

Chicks raised in environments with poor sanitation have small intestines that possess high numbers of leukocytes in the villi and thickened lamina propria with larger Peyers patches. Chicks raised with poor sanitation also have markedly higher levels of circulation IL-1 than chicks raised with excellent sanitation. Presumably, the high burden of microbes, dust and dander chronically stimulate the immune system and induce the release of cytokines such as IL-1. As described above, high circulating levels of inflammatory cytokines result in slower growth. Feeding antibiotics to chicks in a dirty environment decreases the amount of circulation IL-1 to levels more similar to chicks raised in the clean environment. Feeding antibiotics result in little or no improvements in growth rate or changes in circulating IL-1 levels in clean environments. Thus, one of the mechanisms by which antibiotics improve growth rates is to decrease the number and severity of bacterial interactions with the animal. By decreasing the number of bacteria-host interactions, antibiotics decrease the degree of activity of the immune system and consequently decrease the levels of IL-1 and other monokines. This normalizes the metabolic rate and results in poor feed conversion efficiency and less muscular animals.

The concerns about antibiotics in animal feed, however, are well known, including such issues as the development of antibiotic-resistant microbes, requiring new and higher levels of antibiotics. Of perhaps greater concern is the threat of antibiotic resistant genes being spread in the environment, potentially spreading even to human intestinal flora and/or human bacterial pathogens.

It has been proposed that acute phase proteins be used as markers for clinical and subclinical disease in production animals in order to identify conditions for optimal growth. Given the public pressure to reduce the use of ST antibiotics as growth promotants, there is a need to develop alternative strategies to maintain the health and growth of production animals.

III. Compositions Containing Anti-Microbial Proteins

The present invention provides animal feed compositions (also termed “improved animal feed compositions”) containing one or more anti-microbial proteins, and methods of making such compositions. In practicing the invention, an anti-microbial protein, e.g., an acute-phase milk anti-microbial protein, is stably expressed in transgenic monocot seeds, the transgenic seeds are processed and added to animal feed. Accordingly, it is an object of the invention to provide animal feed compositions comprising anti-microbial proteins that allow for enhanced animal growth and production performance, without the side effects that result from long-term use of ST levels of small-molecule antibiotics.

By the present the invention a method is provided for maintaining healthy microflora in production animals by supplementing animal feed with transgenic grain or other plant material comprising one or more anti-microbial proteins. Exemplary anti-microbial proteins are the milk acute-phase anti-microbial proteins such as lysozyme and/or lactoferrin, particularly human lysozyme and/or lactoferrin.

Although the mechanism is not part of the invention, when fed to production animals the anti-microbial proteins described herein, are able to regulate the microflora of an animal in such a fashion that the animal avoids the typical low-level immune responses to subclinical infection. Accordingly, the supplemented animal feed compositions of the invention may be fed to production animals in order to regulate the animal gut microflora, thereby contributing to increased feed efficiency, and increased weight gain in the animals.

The invention is based on the expression at high expression levels of one or more anti-microbial proteins, exemplified by human lactoferrin (hLF) and human lysozyme, among others, under the control of a seed specific promoter in monocot seeds. The description provided herein includes a comparison of anti-microbial proteins produced by transgenic plants to the native form of the same protein, information on the stability of the recombinant protein and the advantages of using grain containing such anti-microbial proteins in animal feed products.

The invention relies on the use of heterologous nucleic acid constructs which include the coding sequence for one or more anti-microbial proteins. Exemplary anti-microbial proteins, lysozyme and lactoferrin, are an integral part of the immune system of multicellular animals. They are found in epithelial secretions (tears, mucous, gastric juice) and blood plasma of mammals, birds, reptiles, amphibia, and a variety of invertebrates. They are also enriched in mammalian milk and avian eggs, where they serve as primary antimicrobial proteins. Furthermore, lysozyme is a major component of the secretory granules of neutrophils and macrophages and is released at the site of infection in the earliest stages of the immune response, and lactoferrin is found at high concentrations within specific granules of polymorphonuclear leukocytes.

Lysozyme along with lactoferrin and immunoglobulins, e.g., IgA, are widely recognized to be the predominant immunological factors in milk that manage the establishment of a protective commensal microflora population and control the growth of pathogens in the gastrointestinal tract of mammals.

While the capacity of lysozyme and lactoferrin to survive the digestive processes has long been appreciated in neonatal animal, several studies have examined this property in adult animals. (See, e.g., Mestecky et al., 1998.) Thirty minutes following a single oral dose of lysozyme to mice, 10% of the dose was isolated in an enzymatically active form from the mid-jejunum and lysozyme activity could be measured throughout the intestine.

Furthermore, chicken lysozyme fed to rats can be observed by immunohistochemistry along the villi of the intestines, indicating a lack of proteolysis during transit through the digestive tract. Such studies demonstrate that native lysozyme and lactoferrin can survive the proteolytic and denaturing environment of the digestive tract. (See Example 6). Below is a discussion of several anti-microbial proteins suitable for use in the invention, classed as (Group 1) anti-microbial milk proteins, (Group 2), acute-phase proteins (other than Group-1 protein), (Group 3) anti-microbial peptides, and (Group 4), other anti-microbial proteins. Coding sequences for many of these proteins are given below. Other coding sequences, either for anti-microbial proteins from other sources, or other anti-microbial proteins, may be found in public gene databases, such as the GENBANK database, accessible through internet address “www.ncbi.nlm.gov/BLAST/”.

Group 1. Anti-Microbial Milk Proteins

Lysozyme, called muramidase or peptidoglycan N-acetylmuramoyl-hydrolase (EC 3.2.1.17) contains 130 amino acid residues (human lysozyme) and is a protein of 14.7 kDa in size. Human lysozyme is non-glycosylated and possesses unusual stability in vitro and in vivo due to its amino acid and secondary structure.

Lysozyme is one of the most abundant proteins present in human milk with a concentration of about 400 μg/ml. The concentration of lysozyme is approximately 0.13 μg/ml in cow's milk (almost 3000 times less than found in human milk), 0.25 μg/ml in goat's milk, 0.1 μg/ml in sheep's milk and almost absent in rodent's milk (Chandan RC, 1968). Lysozyme is also found in other mammalian secretions, such as tears and saliva.

The protective role of lysozyme has been observed to include lysis of microbial cell walls, adjuvant activity of the end products peptidoglycan lysis, direct immunomodulating effects on leukocytes, and neutralization of bacterial endotoxins. The bacteriostatic and bactericidal actions of lysozyme were originally discovered by Flemming in 1922 and have been studied in detail. Lysozyme is effective against both gram positive and gram negative bacteria, as well as some types of yeasts. The antimicrobial effects of lysozyme often act synergistically with other defense molecules, including immunoglobulin and lactoferrin. Furthermore, structural changes in the cell wall due to lysozyme render bacteria more susceptible to phagocytosis by macrophages and neutrophils.

The hydrolysis of microbial peptidoglycans results in the release of the cleavage product, muramyl dipeptide, which is a potent adjuvant and is the active component of Freund's complete adjuvant. Muramyl dipeptide enhances IgA production, macrophage activation, and rapid clearance of a variety of bacterial pathogens in vivo. Lysozyme itself is also immunomodulatory. It directly interacts with the cell membrane of phagocytes to increase their uptake of bacteria. Lysozyme also augments the proliferative response of mitogen stimulated lymphocytes to interleukin-2 and increases the rate of synthesis of IgG and IgM by more than 5- and 2-fold respectively. Furthermore, the immunomodulatory action of lysozyme is not dependent upon enzymatic activity and is retained following denaturation. When lysozyme is fed to mice, it increases the number of intraepithelial and mesenteric lymph node lymphocytes that display antigens.

Lysozymes (either from human or non-human sources) act as enzymes that cleave peptidoglycans, and ubiquitous cell wall component of microorganisms, in particular bacteria. Specifically, lysozymes are 1,4-acetylmuramidases that hydrolyze the glycoside bond between N-acetylmuramic acid and N-acetylglucosamine. Gram-positive bacteria are highly susceptible to lysozyme due to the polypeptidoglycan on the outside of the cell wall. Gram-negative strains have a single polypeptidoglycan layer covered by lipopolysaccharides and are therefore less susceptible to lysis by lysozyme, however, the sensitivity can be increased by the addition of EDTA (Schütte and Kula, 1990). Lysozyme also exhibits antiviral activity, as exemplified by the significant reduction in recurrent occurrences of genital and labial herpes after oral treatment of patients with lysozyme (Jollès, 1996). More recently, lysozyme from chicken egg whites, human milk and human neutrophils has been shown to inhibit the growth of HIV-1 in an in vitro assay (Lee-Huang et al., 1999). In addition, an anti-fungal activity has been demonstrated for lysozymes using oral isolates of Candida albicans (the most common fungal causative agent of oropharyngeal infection in humans; (Samaranayake et al., 1997). Lysozyme thus functions as a broad spectrum antimicrobial agent.

The ability of lysozyme to bind bacterial endotoxins, especially LPS, confers an important anti-microbial property to the molecule. Lysozyme binds electrostatically to the lipid A component of bacterial endotoxins at a 1:3 molar ratio. The resulting conformational change in endotoxin keeps it from interacting with macrophage receptors and dampens the release of pro-inflammatory cytokines such as interleukin-1 (IL-1), interleukin-6 (IL-6), and tumor necrosis factor (TNF). Thus, lysozyme exhibits anti-inflammatory activity during pathogen challenges.

The current major commercial source for lysozyme is chicken egg whites. Sequence analysis shows that lysozyme from chicken egg whites exhibits only partial homology (60%) with that synthesized by humans. Chicken and human lysozyme do not cross-react with their respective antibodies (Faure et al., 1970), indicating significant structural differences between these two lysozymes. Human lysozyme has been purified from breast milk (Boesman-Finkelstein et al., 1982; Wang et al., 1984), neutrophills (Lollike et al., 1995), and urine of hemodialysis patients (Takai et al., 1996). Breast milk remains the main source for isolation of human lysozyme, but the supply is limited. Precautions are required for isolation of the enzyme from human sources to avoid contamination with viral and microbial pathogens.

Recombinant human lysozyme has been produced in the mammary gland of transgenic mice. The enzyme retained its antimicrobial activity, but the final concentration in the milk was low (Maga et al., 1998; Maga et al., 1994; Maga et al., 1995). Human lysozyme has been expressed in Aspergillus oryzae (A. oryzae) (Tsuchiya et al., 1992) yeast (S. cerevisiae; Castañón et al., 1988; Jigami et al., 1986; and Yoshimura et al., 1988) and in small amounts in tobacco leaves (Nakajima et al., 1997). However, the expression level of recombinant human lysozyme in these organisms could be very low, and the cost of these forms may be prohibitive for food applications. In addition, human lysozyme produced in microorganisms may require extensive purification before it can be used in foods, particularly for infants and children.

In contrast to many other proteins, lysozyme is highly resistant to digestion in the gastrointestinal tract. In vitro studies have demonstrated that both molecules are resistant to hydrolysis by pepsin in the pH range found in the stomach. Furthermore, partial denaturation of lysozyme increases its bactericidal activity against some types of bacteria, and low pH, such as found in the stomach, increases the bactericidal effects of lysozyme. A proteolytic fragment (amino acids 98-112 of chicken egg white lysozyme) completely lacking enzymatic activity has been found to be the active bactericidal component of lysozyme. Additionally, a fragment of lactoferrin, known as lactoferricin, is formed by limited proteolytic digestion and has been shown to have extremely effective antibacterial activity.

The rice produced human lysozyme of the present invention exhibits acid pH resistance, as well as resistance to pepsin and pancreatin to make it resistant to digestion in the gastrointestinal tract. The excellent thermostability provides the feasibility to pasteurize products that include the recombinant human lysozyme.

Lactoferrin is an iron-binding protein found in the granules of neutrophils where it apparently exerts an antimicrobial activity by withholding iron from ingested bacteria and fungi; it also occurs in many secretions and exudates (milk, tears, mucus, saliva, bile, etc.). In addition to its role in iron transport, lactoferrin has bacteriostatic and bactericidal activities, in addition to playing a role as an anti-oxidant (Satue-Gracia et al., 2000).

The mature human lactoferrin (LF) polypeptide consists of 692 amino acids, consists of a single-chain polypeptide that is relatively resistant to proteolysis, is glycosylated at two sites (N138 and N478) and has a molecular weight of about 80 kD. Human lactoferrin (hLF) is found in human milk at high concentrations (at an average of 1-3 mg/ml), and at lower concentration (0.1-0.3 mg/ml), in exocrine fluids of glandular epithelium cells such as bile, tears, saliva etc.

The primary functions of lactoferrin have been described as iron regulation, immune modulation and protection from infectious microbes. Lactoferrin can bind two ferric ions and has been shown to have biological activities including bacteriostatic (Bullen et al., 1972), bactericidal (Arnold, et al., 1980) and growth factor activity in vitro. Further, lactoferrin can promote the growth of bacteria that are beneficial to the host organism by releasing iron in their presence. Additional studies have recently shown lactoferrin to have antiviral activity towards cytomegalovirus, herpes simples virus, rotovirus and HIV both in vitro and in vivo. (See, e.g., Fujihara et al., 1995; Grover et al., 1997; and Harmsen et al., 1995.)

Lactoferrin, like transferrin, has a strong capacity to bind free iron under physiological conditions due to its tertiary structure, which consists of two globular lobes linked by an extended alpha-helix. The ability of lactoferrin to scavenge iron from the physiological environment can effectively inhibit the growth of “more than 90% of all microorganisms” by depriving them of a necessary component of their metabolism, which will inhibit their growth in vivo and in vitro.

Unrelated to iron binding, the bactericidal activity of lactoferrin stems from its ability to destabilize the outer membrane of gram-negative bacteria through the liberation of lipopolysaccaharides that constitute the cell walls of the bacteria. Additionally, lactoferrin has recently been shown to bind to prions, a group of molecules common in E coli, causing permeability changes in the cell wall. Studies in germfree piglets fed lactoferrin before being challenged with E. coli show significant decrease in mortality compared to the control group.

Recombinant LF (rLF) has been produced as a fusion protein in Aspergillus oryzae (Ward et al., 1992) and in the baculovirus expression system (Salmon et al., 1997). The Aspergillus-produced protein will require a high degree of purification as well as safety and toxicity testing prior to using it as a food additive (Lönnerdal, 1996). Lactoferrin has also been expressed in tobacco (Nicotiana tabacum L. cv Bright Yellow) cell culture (Mitra and Zhang, 1994), tobacco plants (Salmon et al., 1998) and potato (Solanum tuberosum) plants (Chong and Langridge, 2000). In tobacco cell culture the protein was truncated, whereas in tobacco and potato plants the rLF was processed correctly, but its expression level was very low (0.1% of total soluble protein) (Chong and Langridge, 2000). However, the expression level of recombinant human lactoferrin in these organisms could be very low, and the cost of these forms may be prohibitive for food applications. In addition, human lactoferrin produced in microorganisms may require extensive purification before it can be used in foods, particularly for infants and children.

In contrast to most other proteins, lactoferrin has also been shown to be resistant to proteolytic degradation in vitro, with trypsin and chymotrypsin remarkably ineffective in digesting lactoferrin, particularly in its iron-saturated form. Some large fragments of lactoferrin were formed, but proteolysis was clearly limited.

Lactoperoxidase is an an enzyme which catalyzes the conversion of hydrogen peroxide to water. This enzyme is found in human milk, and plays host defensive roles through antimicrobial activity. When hydrogen peroxide and thiocyanate are added to raw milk, the SCN's oxidized by the enzyme-hydrogen peroxide complex producing bactericidal compounds which destroy Gram-negative bacteria (Shin).

Kappa-casein is a group of readily digested caseins, which account for almost half of the protein content in human milk, are important as nutritional protein for breast-fed infants. It has also been advocated that part of the antimicrobial activity of human milk resides in the caseins, most likely the glycosylated kappa-casein.

Alpha-1-antitrypsin is a protease inhibitor that acts to prevent the digestion of the milk proteins, for example lysozyme and lactoferrin, in newbown infant gut, is the presence of protease inhibitors, such as α-1-antitrypsin (AAT) in human milk. AAT belongs to the class of serpin inhibitors, has a molecular mass of 52 kD, and contains about 15% carbohydrate (Carrell et al, 1983). Concentrations of AAT in human milk range from 0.1 to 0.4 mg/mL, and they appear to decrease with infant age (Davidson and Lönnerdal,1979; McGilligan et al., 1987). While the binding affinity of AAT is highest for human neutrophil elastase, it also has affinity for pancreatic proteases such as chymotrypsin and trypsin (Beatty et al., 1980). The role of T in milk is possible that AAT may prolong the survival of other anti-microbial proteins through inhibition of pancreatic proteases. While anti-microbial proteins have been expressed in systems such as transgenic cows and Aspergillus (Lönnerdal, 1996), transgenic rice provides a more attractive vehicle for the production of recombinant human AAT for food applications. High levels of expression are possible by using the combination of regulatory elements such as promotor, signal peptide, and terminator, and optionally, transciption factors, as disclosed herein.

Lactadherin is a nonimmunological component in human milk that helps can protect breast-fed infants against infection by microorganisms. One of the major protective glycoproteins is lactadherin. Protection against certain virus infections by human milk is associated with lactadherin. (Newburg, 1999, 1998; Peterson; Hamosh).

Immunoglobulins. e.g., IgA, are present in human act to confer resistance to a variety of pathogens to which the mother may have been exposed. (See, for example, Humphreys; Kortt; Larrick; Maynard; and Peeters.

Group 2, Acute-Phase Proteins

C-reactive Protein (CRP) is a protein generally having a very low blood concentration, which rises up to two thousand times following inflammatory processes [J. J. Morley and I. Kushner, Am. N.Y. Acad. Sci., 389, 406-418 (1989)].

Serum amyloid A (SM) is known to be an acute phase protein whose concentration increases about a thousand-fold, usually within 24 hours, during any inflammatory disorder.

Ferritin is a large (480 kD) intracellular iron storage protein which converts ferrous (Fe²⁺) iron to the ferric (Fe³⁺) state and sequesters up to 4500 iron atoms in the ferric state per molecule of ferritin. Hepatic ferritin content and serum ferritin concentrations increase rapidly after administration of interleukin-6 to rats. Kobune et al., Hepatology (1994); 19: 1468-1475. These effects of pro-inflammatory cytokines on ferritin synthesis are part of the hypoferremic response which occurs early in inflammation. Rogers, “Genetic regulation of the iron transport and storage genes: links with the acute phase response.” In Iron and Human Disease. Lauffer, editor. (1992); CRC Press, Boca Raton, pp. 77-104.

Haptoglobin (HP) is a hemoglobin-binding serum protein which plays a major role in the protection against heme-driven oxidative stress (Langlois M R and Delanghe J R (1996) Clin Chem 42: 1589-1600; Delanghe J R et al. (1998) AIDS 12: 1027-1032; Gutteridge J M. (1987) Biochim Biophys Acta 917: 219-223; Miller Y I et al. (1997) Biochem 36: 12189-12198; Vercellotti G M et al. (1994) Art Cell Blood Substit 1 mm Biotech 22: 207-213).

Seromucoids are glycoproteins derived from blood serum.

Ceruloplasmin (Cp) is a copper-containing glycoprotein which plays an important rold in the metabolism of copper. The ceruloplasmin level in serum of a patient suffering from Wilson's disease, or an infectious disease, or of a pregnant woman is different from that of a normal human, so that quantification of human ceruloplasmin may be used for the diagnosis of these diseases and pregnancy.

15-keto-13,14-dihydro-prostaglandin F2 alpha (PGFM) is a prostanoid produced by the placental. Prostanoids are a family of autacoids (formed from arachidonic acid) thought to play an important role during implantation, in the progress and maintenance of pregnancy, and during the initiation and progress of labor (Angle and Johnston, 1990).

Fibrinogen (Fb) is a large protein molecule that normally circulates in the blood plasm in the dissolved state. Under attack from the enzyme thrombin, the fibrinogen molecules link up, spontaneously aligning themselves into a long thread like polymer or network called fibrin which is the primary ingredient of blood clots. Fibrinogen itself comprises 6 chains including two copies of an alpha, beta and gamma chain.

Alpha-1-acid glycoprotein (AGP) is a human plasma glycoprotein which is produced by the liver. AGP is an acute-phase reactant, i.e., the concentration of AGP in the blood increases following inflammation. AGP synthesis increases several fold during an acute phase response (Baumann, H. et al. J. Biol. Chem. 256:10145-10155 (1981); Ricca, G. A. et al. J. Biol. Chem. 256:11199-11202 (1981); Koj, A. et al. Biochem J. 206:545-553 (1982); Koj, A. et al. Biochem J. 224:505-514 (1984)). The major acute phase inducers of AGP synthesis are the cytokines interleukin-1 (IL-1) and interleukin-6 (IL-6), which act additively to induce transcription of the AGP gene.

Mannose binding protein (MBP) is thought to play a role in the disposal of pathogenic organisms. MBP works both by opsonisizing pathogen, and by activating the complement cascade. MBP consists of several monomers that assemble into one larger multimer.

Lipopolysaccharide binding protein (LBP) is a 60 kD glycoprotein synthesized in the liver and present in normal human serum. LBP belongs to the group of plasma proteins called acute phase proteins, including C-reactive protein, fibrinogen and serum amyloid A, that increase in concentration in response to infectious, inflammatory and toxic mediators. LBP expression has been induced in animals by challenge with lipopolysaccharide (LPS), silver nitrate, turpentine and Corynebacterium parvum [Geller et al., Arch. Surg. 128(1): 22-28 (1993); Gallay et al., Infect. Immun. 61(2): 378-383 (1993); Tobias et al., J. Exp. Med. 164: 777-793 (1986)].

Alpha-2 Macroglobulin and Various Defensins

Alpha-2 macroglobulin is a 718 kDa homotetrameric glycoprotein and is a well characterized as an extracellular proteinase inhibitor.

The milk proteins lysozyme and lactoferrin, discussed above, are also included in this group.

Group 3: Antimicrobial Peptides

As many as 450 antimicrobial peptides have been found from amphibians, insects, mammals, plants, microorganisms and fishes. These antimicrobial peptides are known to be different in their sizes and amino acid sequences, but similar in their antimicrobial mechanism. Representative antimicrobial peptides include cecropin, magainin, bombinin, defensin, tachyplesin, and buforin. All of these are composed of 17-24 amino acids, showing antimicrobial activity against a broad spectrum of microorganisms, including Gram-negative bacteria, Gram-positive bacteria, protozoa and fungi. Some of these peptides are effective against both cancer cells and viruses. For instance, magainin, consisting of 23 amino acids, was isolated from the skin of an amphibian and is reported not only to defend against pathogenic bacteria, but to kill human lung cancer cells (Zasloff, M. (1987) Proc. Natl. Acad. Sci., U.S.A. 84, 5449-5453).

Antimicrobial peptides comprising six conserved cysteines form the defensin family. This family is composed of antimicrobial peptides which are present in numerous species, which are abundant and which are about 3-4 kDa (Ganz and Lehrer, 1994). These peptides are formed of 30 to 40 amino acids, of which six invariant cysteines which form three intramolecular disulfide linkages. They have complex conformation, are amphipathic, rich in beta antiparallel sheets but lack alpha helices (Lehrer and Ganz, 1992). The antimicrobial action of defensins is thought to result from their insertion into the membranes of the target cells, allowing the formation of voltage-dependent channels. White et al. (1995) describe the possible mechanisms of membrane insertion and of formation of multimeric pores by the defensins, which allow the permeabilization of the membranes of the target cells, for example microbial or tumor cells. Defensins have an antimicrobial action on a broad spectrum of microorganismes in vitro (Martin et al., 1995). This activity spectrum, which is particularly broad, comprises bacteria, Gram-positive and Gram-negative bacteria, several fungi, mycobacteria, parasites including spirochetes and several enveloped viruses including the HSV and HIV viruses. They are also cytotoxic for several categories of normal and malignant cells, including cells resistant to TNF-alpha and to the cytolytic NK factor (Kagan et al., 1994).

Indolicidin is a peptide that has been isolated from bovine neutrophils and has antimicrobial activity, including activity against viruses, bacteria, fungi and protozoan parasites. Subbalakshmi C et al., Biochem Biophys Res Commun, 2000, 274(3):714-6.

Cecropin is an antimicrobial peptide that is isolated from the silkworm. Choi et al., Comp Biochem Physiol C Toxicol Pharmacol, 2000,125:287-97.

Magainins are a group of short peptides originally isolated from frog skin and thought to function as a natural defense mechanism against infection due to their antimicrobial properties. Li et al., Planta, 2001, 212:635-9.

Tachyplesin I (T-SS) is a membrane-permeabilizing antimicrobial peptide discovered from horseshoe crab hemolymph. Kobayashi S et al., Biochemistry, 2001, 40:14330-5.

Parasin I (Park et al., FEBS Left, 1998, 437:258-62 amd U.S. Pat. No. 6,316,594). Parasin I is a potent antimicrobial peptide which is secreted in response to an epidermal injury by Parasilurus asotus, a catfish.

Buforin I is a 39-residue antimicrobial peptide derived from the N-terminal of toad histone H2A [Kim et al. (1996) Biochem. Biophys. Res. Commun. 229, 381-387].

PMAP-23 (Park et al., Biochem Biophys Res Commun, 2002, 290:204-12). PMAP-23 is a cathelicidin-derived antimicrobial peptide identified from porcine leukocytes. PMAP-23 demonstrates potent antimicrobial activity against Gram-negative and Gram-positive bacteria without hemolytic activity.

Moronecidin: Lauth, et al., J Biol Chem, 2002, 277:5030-5039. Moronecidin is a 22-residue, C-terminally amidated antimicrobial peptide which is isolated from the skin and gill of hybrid striped bass. Two isoforms, differing by only one amino acid, are derived from each parental species, white bass (Morone chrysops) and striped bass (Morone saxatilis). Molecular masses (2543 and 2571 Da), amino acid sequences (FFHHIFRGIVHVGKTIH(K/R)LVTGT SEQ ID NO:42), cDNA, and genomic DNA sequences were determined for each isoform. A predicted 79-residue moronecidin prepropeptide consists of three domains: a signal peptide (22 amino acids), a mature peptide (22 amino acids), and a C-terminal prodomain (35 amino acids). The synthetic, amidated white bass moronecidin exhibited broad spectrum antimicrobial activity that was retained at high salt concentration. The moronecidin gene consists of three introns and four exons. Peptide sequence and gene organization were similar to pleurocidin, an antimicrobial peptide from winter flounder. A TATA box and several consensus-binding motifs for transcription factors were found in the region 5[prime prime or minute] to the transcriptional start site. Moronecidin gene expression was detected in gill, skin, intestine, spleen, anterior kidney, and blood cells by kinetic reverse transcription (RT)-PCR. Thus, moronecidin is a new [alpha]-helical, broad spectrum antimicrobial peptide isolated from the skin and gills of hybrid striped bass.

Anoplin:

Konno et al, Biochim Biophys Acta, 2001, 1550:70-80. Anoplin is an antimicrobial peptide which was purified from the venom of the solitary wasp Anoplius samariensis. Anoplin is composed of 10 amino acid residues, Gly-Leu-Leu-Lys-Arg-Ile-Lys-Thr-Leu-Leu-NH2 and is the smallest among the linear alpha-helical antimicrobial peptides hitherto found in nature. Anoplin is the first antimicrobial component to be found in the solitary wasp venom and it may play a key role in preventing potential infection by microorganisms during prey consumption by their larvae. Biological evaluation using the synthetic peptide revealed that this peptide exhibited potent activity in stimulating degranulation from rat peritoneal mast cells and broad-spectrum antimicrobial activity against both Gram-positive and Gram-negative bacteria.

Gambicin:

Vizioli J. et al., Proc Natl Acad Sci USA, 2001, 98:12630-5. Gambicin is a antimicrobial peptide which is excreted by the mosquito. The 616-bp gambicin ORF encodes an 81-residue protein that is processed and secreted as a 61-aa mature peptide. Gambicin lacks sequence homology with other known proteins. Like other Anopheles gambiae antimicrobial peptide genes, gambicin is induced by natural or experimental infection in the midgut, fatbody, and hemocyte-like cell lines. Within the midgut, gambicin is predominantly expressed in the anterior part. Both local and systemic gambicin expression is induced during early and late stages of natural malaria infection. In vitro experiments showed that the 6.8-kDa mature peptide can kill both Gram-positive and Gram-negative bacteria, has a morphogenic effect on a filamentous fungus, and is marginally lethal to Plasmodium berghei ookinetes.

SAMP-29:

Shin S Y et al., Biochem Biophys Res Commun 2001 Jul 27;285(4):1046-51. AMP-29 is a cathelecidin-derived antimicrobial peptide deduced from sheep myeloid mRNA.

Group 4-Other Anti-Microbial Proteins

CAP37:

Cationic antimicrobial protein of Mr 37 kDa (CAP37) is a neutrophil-derived inflammatory mediator on endothelial cell function.

Granulysin:

A mechanism by which T cells contribute to host defense against microbial pathogens is release of the antimicrobial protein granulysin. Ochoa et al., Nat Med, 2001, 7:174-9.

SLPI:

Secretory leukocyte protease inhibitor (SLPI) exhibits antimicrobial activity. (Shugars et al., Gerontology, 2001, 47:246-53.)

Calprotectin:

Squamous mucosal epithelial cells constitutively express calprotectin in the cytoplasm. Cells expressing calprotectin resist invasion by Listeria monocytogenes and Salmonella enterica serovar Typhimurium. Nisapakultom K et al., Infect Immun, 2001, 69:3692-6.

CAP18:

Cationic antimicrobial protein (CAP18) is an 18 kDa antimicrobial protein.

Ubiguicidin:

Ubiquicidin is a cationic, small (Mr 6654) protein which displays marked antimicrobial activity against Listeria monocytogenes and Salmonella typhimuriumand activity against Escherichia coli, Staphylococcus aureus, and an avirulent strain of Yersinia enterocolitica. Hiemstra et al., J Leukoc Biol, 1999, 66:423-8.

BAMP-1:

Bovine antimicrobial protein-1 (BAMP-1) is a 76 amino acid residue antimicrobial protein which has been isolated from fetal calf serum. BAMP-1 showed a weak growth-inhibitory activity against Escherichia coli and yeasts tested in phosphate-buffered saline (PBS).: J Biochem (Tokyo) 1998 Apr;123(4):675-9.

Ace-AMP1 is an antifungal protein extracted from onion seeds. This cationic protein contains 93 amino acid residues and four disulfide bridges. Tassin et al., Biochemistry, 1998, 37:3623-37.

Small granules of horseshoe crab hemocytes contain two known major antimicrobial substances, tachyplesin and big defensin (S5). Kawabata et al., J Biochem (Tokyo), 1996, 120:1253-60.

Ac-AMP2 is a lectin-like small protein with antimicrobial and antifungal activity isolated from Amaranthus caudatus. Verheyden et al., FEBS Lett, 1995, 370:245-9.

Ah-AMP1 (Fant et al., Proteins, 1999, 37:388-403). Aesculus hippocastanum antimicrobial protein 1 (Ah-AMP1) is a plant defensin isolated from horse chestnuts. The plant defensins have been divided in several subfamilies according to their amino acid sequence homology. Ah-AMP1 is a member of subfamily A2 and inhibits growth of a broad range of fungi.

CAP18 (Cationic antimicrobial protein of 18 kDa) is an antimicrobial protein found in human and rabbit granulocytes.

IV. Expression Vectors for Generation of Transgenic Plants Expressing Anti-Microbial Proteins

Expression vectors for use in the present invention are chimeric nucleic acid constructs (or expression vectors or cassettes), designed for operation in plants, with associated upstream and downstream sequences.

In general, expression vectors for use in practicing the invention include the following operably linked components that constitute a chimeric gene: (i) a transcriptional regulatory region from a monocot gene having a seed maturation-specific promoter, (ii) operably linked to said transcriptional regulatory region, a leader DNA sequence encoding a monocot seed-specific transit sequence capable of targeting a linked polypeptide to an endosperm-cell organelle, such as the leader sequence for targeting to a protein-storage body, and (iii) a protein-coding sequence encoding an anti-microbial protein The chimeric gene, in turn, is typically placed in a suitable plant-transformation vector having (i) companion sequences upstream and/or downstream of the chimeric gene which are of plasmid or viral origin and provide necessary characteristics to the vector to permit the vector to move DNA from bacteria to the desired plant host; (ii) a selectable marker sequence; and (iii) a transcriptional termination region generally at the opposite end of the vector from the transcription initiation regulatory region.

Exemplary methods for constructing chimeric genes and transformation vectors carrying the chimeric genes are given in Example 1.

A. Promoters

In one aspect of this embodiment, the expression construct includes a transcription regulatory region (promoter) which exhibits specifically upregulated activity during seed maturation. Examples of such promoters include the maturation-specific promoter region associated with one of the following maturation-specific monocot storage proteins: rice glutelins, oryzins, and prolamines, barley hordeins, wheat gliadins and glutenins, maize zeins and glutelins, oat glutelins, and sorghum kafirins, millet pennisetins, and rye secalins. Exemplary regulatory regions from these genes are exemplified by SEQ ID NOS: 18-24, as identified below.

Of particular interest is the expression of the nucleic acid encoding an anti-microbial protein from a transcription initiation region that is preferentially expressed in plant seed tissue. Examples of such seed preferential transcription initiation sequences include those sequences derived from sequences encoding plant storage protein genes or from genes involved in fatty acid biosynthesis in oilseeds. Exemplary preferred promoters include a glutelin (Gt-1) promoter, as exemplified by SEQ ID NO: 18, which effects gene expression in the outer layer of the endosperm and a globulin (Glb) promoter, as exemplfied by SEQ ID NO: 19, which effects gene expression in the center of the endosperm. Promoter sequences for regulating transcription of gene coding sequences operably linked thereto include naturally-occurring promoters, or regions thereof capable of directing seed-specific transcription, and hybrid promoters, which combine elements of more than one promoter. Methods for construction such hybrid promoters are well known in the art.

In some cases, the promoter is derived from the same plant species as the plant cells into which the chimeric nucleic acid construct is to be introduced. Promoters for use in the invention are typically derived from cereals such as rice, barley, wheat, oat, rye, corn, millet, triticale or sorghum.

Alternatively, a seed-specific promoter from one type of monocot may be used regulate transcription of a nucleic acid coding sequence from a different monocot or a non-cereal monocot.

Numerous types of appropriate expression vectors, and suitable regulatory sequences are known in the art for a variety of plant host cells. The transcription regulatory or promoter region is chosen to be regulated in a manner allowing for induction under seed-maturation conditions. Examples of such promoters include those associated with the following monocot storage proteins: rice glutelins, oryzins, and prolamines, barley hordeins, wheat gliadins and glutelins, maize zeins and glutelins, oat glutelins, and sorghum kafirins, millet pennisetins, and rye secalins. Exemplary promoter sequences are identified herein as SEQ ID NOS: 18-24. Other promoters suitable for expression in maturing seeds include the barley endosperm-specific B1-hordein promoter (Brandt, A., et al., (1985), Glub-2 promoter, Bx7 promoter, Gt3 promoter, Glub-1 promoter and Rp-6 promoter, particularly if these promoters are used in conjunction with transcription factors. The primary structure of a B1 hordein gene from barleyis provided in Carlsberg Res. Commun. 50, 333-345).

B. Signal/Targeting/Transport Sequences

In addition to encoding the protein of interest, the expression cassette or heterologous nucleic acid construct may encode a signal/targeting/transport peptide that allows processing and translocation of the protein, as appropriate. Exemplary signal/targeting/transport sequences, particularly for targeting proteins to intracellular bodies, such as vacuoles, are signal/targeting sequences associated with the monocot maturation-specific genes: glutelins, prolamines, hordeins, gliadins, glutenins, zeins, albumin, globulin, ADP glucose pyrophosphorylase, starch synthase, branching enzyme, Em, and lea. Exemplary sequences encoding a leader sequence for protein storage body are identified herein as SEQ ID NOS: 24-30.

In one preferred embodiment, the method is directed toward the localization of recombinant milk protein expression in a given subcellular compartment, in particular a protein-storage body, but also including the mitochondrion, endoplasmic reticulum, vacuoles, chloroplast or other plastidic compartment. For example, when recombinant milk protein expression is targeted to plastids, such as chloroplasts, in order for expression to take place the construct also employ the use of sequences to direct the gene to the plastid. Such sequences are referred to herein as chloroplast transit peptides (CTP) or plastid transit peptides (PTP). In this manner, when the gene of interest is not directly inserted into the plastid, the expression construct additionally contains a gene encoding a transit peptide to direct the gene of interest to the plastid. The chloroplast transit peptides may be derived from the gene of interest, or may be derived from a heterologous sequence having a CTP. Such transit peptides are known in the art. See, for example, Von Heijne et al., 1991; Clark et al., 1989; della-Cioppa et al., 1987; Romer et al., 1993; and Shah et al., 1986. Additional transit peptides for the translocation of the protein to the endoplasmic reticulum (ER) (Chrispeels, K., 1991), nuclear localization signals (Raikhel, 1992), or vacuole may also find use in the constructs of the present invention.

Another exemplary class of signal/targeting/transport sequences are sequences effective to promote secretion of heterologous protein from aleurone cells during seed germination, including the signal sequences associated with α-amylase, protease, carboxypeptidase, endoprotease, ribonuclease, DNase/RNase, (1-3)-β-glucanase, (1-3)(1-4)-β-glucanase, esterase, acid phosphatase, pentosamine, endoxylanase, β-xylopyranosidase, arabinofuranosidase, β-glucosidase, (1-6)-β-glucanase, perioxidase, and lysophospholipase.

Since many protein storage proteins are under the control of a maturation-specific promoter, and this promoter is operably linked to a leader sequence for targeting to a protein body, the promoter and leader sequence can be isolated from a single protein-storage gene, then operably linked to a milk-protein storage protein in the chimeric gene construction. One preferred and exemplary promoter-leader sequence is form the rice Gt1 gene, having an exemplary sequence identifed by SEQ ID NO:15. Alternatively, the promoter and leader sequence may eb derived from different genes. One preferred and exemplary promoter/leader sequence combination is the rice Glb promoter linked to the rice Gt1 leader sequence, as exemplified by SEQ ID NO: 16.

C. Protein Coding Sequences

The construct also includes the nucleic acid coding sequence for a heterologous protein, under the control of a promoter, preferably a seed-specific promoter. In accordance with the present invention, polynucleotide sequences which encode a heterologous anti-microbial protein, such as lysozyme or lactoferrin, include splice variants, fragments of such proteins, fusion proteins, modified forms or functional equivalents thereof, collectively referred to herein as “anti-microbial protein-encoding nucleic acid sequences”.

Such “anti-microbial protein-encoding nucleic acid sequences” may be used in recombinant expression vectors (also termed heterologous nucleic acid constructs), that direct the expression of an anti-microbial protein in appropriate host cells.

Due to the inherent degeneracy of the genetic code, a number of nucleic acid sequences which encode substantially the same or a functionally equivalent amino acid sequence may be generated and used to clone and express a given anti-microbial protein, as exemplified herein by the codon optimized coding sequences used to practice the invention (further described below). Thus, for a given anti-microbial protein-encoding nucleic acid sequence, it is appreciated that as a result of the degeneracy of the genetic code, a number of coding sequences can be produced that encode the same protein amino acid sequence. For example, the triplet CGT encodes the amino acid arginine. Arginine is alternatively encoded by CGA, CGC, CGG, AGA, and AGG. Therefore such substitutions in the coding region fall within the range of sequence variants covered by the present invention. Any and all of these sequence variants can be utilized in the same way as described herein for a “reference” anti-microbial-encoding nucleic acid sequence.

A “variant” anti-microbial protein-encoding nucleic acid sequence may encode a “variant” human anti-microbial amino acid sequence which is altered by one or more amino acids from the native anti-microbial protein sequence, both of which are included within the scope of the invention. Similarly, the term “modified form of”, relative to a given anti-microbial protein, means a derivative or variant form of an anti-microbial protein or the coding sequence therefor. That is, a “modified form of” a anti-microbial protein has a derivative sequence containing at least one nucleic acid or amino acid substitution, deletion or insertion. The nucleic acid or amino acid substitution, insertion or deletion may occur at any residue within the sequence, as long as the encoded amino acid sequence maintains the biological activity of the native anti-microbial protein, e.g., the bactericidal effect of lysozyme.

A “variant” anti-microbial protein-encoding nucleic acid sequence may encode a “variant” anti-microbial protein sequence which contains amino acid insertions or deletions, or both. Furthermore, a variant anti-microbial protein coding sequence may encode the same polypeptide as the reference polynucleotide or native sequence but, due to the degeneracy of the genetic code, has a nucleic acid coding sequence which is altered by one or more bases from the reference or native polynucleotide sequence.

The variant nucleic acid coding sequence may encode a variant amino acid sequence which contains a “conservative” substitution, wherein the substituted amino acid has structural or chemical properties similar to the amino acid which it replaces and physicochemical amino acid side chain properties and high substitution frequencies in homologous proteins found in nature (as determined, e.g., by a standard Dayhoff frequency exchange matrix or BLOSUM matrix). In addition, or alternatively, the variant nucleic acid coding sequence may encode a variant amino acid sequence which contains a “non-conservative” substitution, wherein the substituted amino acid has dissimilar structural or chemical properties to the amino acid which it replaces.

Standard substitution classes include six classes of amino acids based on common side chain properties and highest frequency of substitution in homologous proteins in nature, as is generally known to those of skill in the art and may be employed to develop variant anti-microbial protein-encoding nucleic acid sequences. A “variant” anti-microbial protein-encoding nucleic acid sequence may encode a “variant” anti-microbial protein sequence which contains a combination of any two or three of amino acid insertions, deletions, or substitution.

Anti-microbial protein-encoding nucleotide sequences also include “allelic variants” defined as an alternate form of a polynucleotide sequence which may have a substitution, deletion or addition of one or more nucleotides, which does not substantially alter the function of the encoded polypeptide.

The polynucleotides for use in practicing the invention include sequences which encode anti-microbial proteins and splice variants thereof, sequences complementary to the protein coding sequence, and novel fragments of the polynucleotide. The polynucleotides may be in the form of RNA or in the form of DNA, and include messenger RNA, synthetic RNA and DNA, cDNA, and genomic DNA. The DNA may be double-stranded or single-stranded, and if single-stranded may be the coding strand or the non-coding (anti-sense, complementary) strand. As will be understood by those of skill in the art, in some cases it may be advantageous to use an anti-microbial protein-encoding nucleotide sequences possessing non-naturally occurring codons. Codons preferred by a particular eukaryotic host (Murray et al., 1989) can be selected, for example, to increase the rate of heterologous protein expression or to produce recombinant RNA transcripts having desirable properties, such as a longer half-life, than transcripts produced from naturally occurring sequence. Codon-optimized sequences for use in practicing the invention are further described below.

An anti-microbial protein-encoding nucleotide sequence may be engineered in order to alter the protein coding sequence for a variety of reasons, including but not limited to, alterations which modify the cloning, processing and/or expression of the protein by maturing seeds.

Heterologous nucleic acid constructs may include the coding sequence for a given anti-microbial protein, a variant, fragment or splice variant thereof: (i) in isolation; (ii) in combination with additional coding sequences; such as fusion protein or signal peptide, in which the anti-microbial protein coding sequence is the dominant coding sequence; (iii) in combination with non-coding sequences, such as introns and control elements, such as promoter and terminator elements or 5′ and/or 3′ untranslated regions, effective for expression of the coding sequence in a suitable host; and/or (iv) in a vector or host environment in which the anti-microbial protein coding sequence is a heterologous gene.

Depending upon the intended use, an expression construct may contain the nucleic acid sequence which encodes the entire anti-microbial protein, or a portion thereof. For example, where anti-microbial protein sequences are used in constructs for use as a probe, it may be advantageous to prepare constructs containing only a particular portion of the anti-microbial protein encoding sequence, for example a sequence which is discovered to encode a highly conserved anti-microbial protein region.

Codon-optimized coding sequences for human milk anti-microbial proteins are identified herein by SEQ ID NOS; 1, 3, and 7-14. An expression vector used to practice the invention has at least 70%, preferably 80%, 85%, 90% or 95% or more sequence identity to the codon-optimized sequences.

Coding sequences for exemplary non-human acute-phase proteins are identified herein by SEQ ID NOS: 36, and 46-56. An expression vector used to practice the invention has at least 70%, preferably 80%, 85%, 90% or 95% or more sequence identity to the identified sequences.

Coding sequences for exemplary anti-microbial peptides are identified herein by SEQ ID NOS: 34-68, 40-41, and 43. An expression vector used to practice the invention has at least 70%, preferably 80%, 85%, 90% or 95% or more sequence identity to the identified sequences.

Condon-Optimized Sequence.

Coding sequences for other anti-microbial proteins are identified herein by SEQ ID NOS: 37, 45, and 57-59. An expression vector used to practice the invention has at least 70%, preferably 80%, 85%, 90% or 95% or more sequence identity to the identified sequences.

Additional codon sequences for anti-microbuial proteins are available from public gene databases, such as GENBANK, accessible through “www.ncbi.nlm.gov/GENBANK/”.

D. Codon Optimization

It has been shown that production of recombinant protein in transgenic barley grain was enhanced by codon optimization of the gene (Horvath et al., 2000; Jensen et al., 1996). The intent of codon optimization was to change an A or T at the third position of the codons of G or C. This arrangement conforms more closely with codon usage in typical rice genes (Huang et al., 1990a).

In order to obtain a high expression level for human lysozyme in rice cells, the coding sequence was codon optimized. The G+C content was thus increased from 46% to 68%. The codon optimized lysozyme coding sequence for use in practicing the invention is presented as SEQ ID NO:1.

Similarly, in order to obtain high level expression level of human lactoferrin (hLF) in rice cells, the native hLF coding sequence was codon optimized. Out of 693 codons used in the lactoferrin gene, 413 codons were changed by one or two nucleotides. The amino acid sequence of LF was unchanged. The codon optimized lactoferrin coding sequence for use in practicing the invention is presented as SEQ ID NO:3.

Codon optimized sequences for other human milk proteins are given as follows: for lactoferricin, SEQ ID NO: 7; for EGF, SEQ ID NO: 8; for IGF-1, SEQ ID NO: 9; for lactohedrin, SEQ ID NO: 10; for kappa-casein, SEQ ID NO: 11; for haptocorrin, SEQ ID NO: 12; for lactoperoxidase, SEQ ID NO: 13; for and for alpha-1-antitrypsin, SEQ ID NO: 14.

E. Transcription Factor Coding Sequences

In one embodiment of the invention, the transgenic plant is also transformed with the coding sequence of one or more transcription factors capable of stimulating the expression of a maturation-specific promoter. Specifically, the embodiment involves the use of the maize Opaque 2 (O2) and prolamin box binding factor (PBF) together with the rice endosperm bZip (Reb) protein as transcriptional activators of monocot storage protein genes. Exemplary sequence for these three transcription factors are given identified below as SEQ ID NOS: 31-33. Transcription factor sequences and constructs applicable to the present invention are detailed in co-owned PCT application No. PCT/US01/14234, International Publication number WO 01/83792 A1, published Nov. 8, 2001, which is incorporated herein by reference.

Transcription factors are capable of sequence-specific interaction with a gene sequence or gene regulatory sequence. The interaction may be direct sequence-specific binding in that the transcription factor directly contacts the gene or gene regulatory sequence or indirect sequence-specific binding mediated by interaction of the transcription factor with other proteins. In some cases, the binding and/or effect of a transcription factor is influenced (in an additive, synergistic or inhibitory manner) by another transcription factor. The gene or gene regulatory region and transcription factor may be derived from the same type (e.g., species or genus) of plant or a different type of plant. The binding of a transcription factor to a gene sequence or gene regulatory sequence may be evaluated by a number of assays routinely employed by those of skill in the art, for example, sequence-specific binding may be evaluated directly using a label or through gel shift analysis.

As detailed in the cited PCT application, the transcription factor gene is introduced into the plant in a chimeric gene containing a suitable promoter, preferably a maturation-specific seed promoter operably linked to the transcription factor gene. Plants may be stably transformed with a chimeric gene containing the transcription factor by methods similar to those described with respect to the milk-protein gene(s). Plants stably transformed with both exogeneous trancription factor(s) and milk-protein genes may be prepared by co-transforming plant cells or tissue with both gene constructs, selecting plant cells or tissue that have been co-transformed, and regenerating the transformed cells or tissue into plants. Alternativiely, different plants may be spearately transformed with exogeneous transcription factor genes and milk-protein genes, then crossed to produce plant hybrids containing by added genes.

F Additional Expression Vector Components

Expression vectors or heterologous nucleic acid constructs designed for operation in plants, comprise companion sequences upstream and downstream to the expression cassette. The companion sequences are of plasmid or viral origin and provide necessary characteristics to the vector to permit the vector to move DNA from bacteria to the plant host, such as, sequences containing an origin of replication and a selectable marker. Typical secondary hosts include bacteria and yeast.

In one embodiment, the secondary host is E. coli, the origin of replication is a colE1-type, and the selectable marker is a gene encoding ampicillin resistance. Such sequences are well known in the art and are commercially available as well (e.g., Clontech, Palo Alto, Calif.; Stratagene, La Jolla, Calif.).

The transcription termination region may be taken from a gene where it is normally associated with the transcriptional initiation region or may be taken from a different gene. Exemplary transcriptional termination regions include the NOS terminator from Agrobacterium Ti plasmid and the rice α-amylase terminator.

Polyadenylation tails (Alber et al., 1982) may also be added to the expression cassette to optimize high levels of transcription and proper transcription termination, respectively. Polyadenylation sequences include, but are not limited to, the Agrobacterium octopine synthetase signal, Gielen, et al., 1984 or the nopaline synthase of the same species, Depicker, et al., 1982.

Suitable selectable markers for selection in plant cells include, but are not limited to, antibiotic resistance genes, such as, kanamycin (nptIl), G418, bleomycin, hygromycin, chloramphenicol, ampicillin, tetracycline, and the like. Additional selectable markers include a bar gene which codes for bialaphos resistance; a mutant EPSP synthase gene which encodes glyphosate resistance; a nitrilase gene which confers resistance to bromoxynil; a mutant acetolactate synthase gene (ALS) which confers imidazolinone or sulphonylurea resistance; and a methotrexate resistant DHFR gene.

The particular marker gene employed is one which allows for selection of transformed cells as compared to cells lacking the DNA which has been introduced. Preferably, the selectable marker gene is one which facilitates selection at the tissue culture stage, e.g., a kanamyacin, hygromycin or ampicillin resistance gene.

The vectors of the present invention may also be modified to include intermediate plant transformation plasmids that contain a region of homology to an Agrobacterium tumefaciens vector, a T-DNA border region from Agrobacterium tumefaciens, and chimeric genes or expression cassettes (described above). Further, the vectors of the invention may comprise a disarmed plant tumor inducing plasmid of Agrobacterium tumefaciens.

In general, a selected nucleic acid sequence is inserted into an appropriate restriction endonuclease site or sites in the vector. Standard methods for cutting, ligating and E. coli transformation, known to those of skill in the art, are used in constructing vectors for use in the present invention. (See generally, Maniatis, et al., MOLECULAR CLONING: A LABORATORY MANUAL, 2d Edition (1989); Ausubel, etal., (c) 1987, 1988, 1989, 1990, 1993, CURRENT PROTOCOLS IN MOLECULAR BIOLOGY, John Wiley & Sons, New York, N.Y; and Gelvin, S. B., et al., eds. PLANT MOLECULAR BIOLOGY MANUAL, (1990), all three of which are expressly incorporated by reference, herein.

V. Generation of Transgenic Plants

Plant cells or tissues are transformed with expression constructs (heterologous nucleic acid constructs, e.g., plasmid DNA into which the gene of interest has been inserted) using a variety of standard techniques. Effective introduction of vectors in order to facilitate enhanced plant gene expression is an important aspect of the invention. It is preferred that the vector sequences be stably integrated into the host genome.

The method used for transformation of host plant cells is not critical to the present invention. The transformation of the plant is preferably permanent, i.e. by integration of the introduced expression constructs into the host plant genome, so that the introduced constructs are passed onto successive plant generations. The skilled artisan will recognize that a wide variety of transformation techniques exist in the art, and new techniques are continually becoming available.

Any technique that is suitable for the target host plant may be employed within the scope of the present invention. For example, the constructs can be introduced in a variety of forms including, but not limited to, as a strand of DNA, in a plasmid, or in an artificial chromosome. The introduction of the constructs into the target plant cells can be accomplished by a variety of techniques, including, but not limited to calcium-phosphate-DNA co-precipitation, electroporation, microinjection, Agrobacterium-mediated transformation, liposome-mediated transformation, protoplast fusion or microprojectile bombardment. The skilled artisan can refer to the literature for details and select suitable techniques for use in the methods of the present invention. Exemplary methods for plant transformation are given in Example 2.

When Agrobacterium is used for plant cell transformation, a vector is introduced into the Agrobacterium host for homologous recombination with T-DNA or the Ti- or Ri-plasmid present in the Agrobacterium host. The Ti- or Ri-plasmid containing the T-DNA for recombination may be armed (capable of causing gall formation) or disarmed (incapable of causing gall formation), the latter being permissible, so long as the vir genes are present in the transformed Agrobacterium host. The armed plasmid can give a mixture of normal plant cells and gall.

In some instances where Agrobacterium is used as the vehicle for transforming host plant cells, the expression or transcription construct bordered by the T-DNA border region(s) is inserted into a broad host range vector capable of replication in E. coli and Agrobacterium, examples of which are described in the literature, for example pRK2 or derivatives thereof. See, for example, Ditta et al., 1980 and EPA 0 120 515, expressly incorporated by reference herein. Alternatively, one may insert the sequences to be expressed in plant cells into a vector containing separate replication sequences, one of which stabilizes the vector in E. coli, and the other in Agrobacterium See, for example, McBride et al., 1990, wherein the pRiHRI (Jouanin, et al., 1985, origin of replication is utilized and provides for added stability of the plant expression vectors in host Agrobacterium cells.

Included with the expression construct and the T-DNA is one or more selectable marker coding sequences which allow for selection of transformed Agrobacterium and transformed plant cells. A number of markers have been developed for use with plant cells, such as resistance to chloramphenicol, kanamycin, the aminoglycoside G418, hygromycin, or the like. The particular marker employed is not essential to this invention, with a particular marker preferred depending on the particular host and the manner of construction.

For Agrobacterium-mediated transformation of plant cells, explants are incubated with Agrobacterium for a time sufficient to result in infection, the bacteria killed, and the plant cells cultured in an appropriate selection medium. Once callus forms, shoot formation can be encouraged by employing the appropriate plant hormones in accordance with known methods and the shoots transferred to rooting medium for regeneration of plants. The plants may then be grown to seed and the seed used to establish repetitive generations and for isolation of the recombinant protein produced by the plants.

There are a number of possible ways to obtain plant cells containing more than one expression construct. In one approach, plant cells are co-transformed with a first and second construct by inclusion of both expression constructs in a single transformation vector or by using separate vectors, one of which expresses desired genes. The second construct can be introduced into a plant that has already been transformed with the first expression construct, or alternatively, transformed plants, one having the first construct and one having the second construct, can be crossed to bring the constructs together in the same plant.

A. Plants

Host cells of the present invention include plant cells, both monocotyledenous and dicotyledenous. In one preferred embodiment, the plants used in the methods of the present invention are derived from monocots, particularly the members of the taxonomic family known as the Gramineae. This includes all members of the grass family of which the edible varieties are known as cereals. The cereals include a wide variety of species such as wheat (Triticum sps.), rice (Oryza sps.) barley (Hordeum sps.) oats, (Avena sps.) rye (Secale sps.), corn (maize) (Zea sps.) and millet (Pennisettum sps.). In practicing the present invention, preferred grains are rice, wheat, maize, barley, rye, triticale. Also preferred are dicots exemplified by soybean (Glycine spp.)

In order to produce transgenic plants that express anti-microbial protein, monocot plant cells or tissues derived from them are transformed with an expression vector comprising the coding sequence for a anti-microbial protein. Transgenic plant cells obtained as a result of such transformation express the coding sequence for a anti-microbial protein, such as lysozyme or lactoferrin. The transgenic plant cells are cultured in medium containing the appropriate selection agent to identify and select for plant cells which express the heterologous nucleic acid sequence. After plant cells that express the heterologous nucleic acid sequence are selected, whole plants are regenerated from the selected transgenic plant cells. Techniques for regenerating whole plants from transformed plant cells are generally known in the art.

Transgenic plant lines, e.g., rice, wheat, corn or barely, can be developed and genetic crosses carried out using conventional plant breeding techniques.

Production of recombinant proteins in monocot seeds, e.g., rice (Olyza sativa L.) seeds has the advantages that (a) high level expression make it an economically practical strategy, and (b) rice is a normal part of the diet of infants and children, has good nutritional value and low allergenicity. Thus, the use of rice as the basis for a food supplement is unlikely to introduce any risk and thereby eliminates the need for a high degree of purification when included in infant formula.

In addition, rice is the staple food crop of more than half the world's population. Recent reports on the production of provitamin A (beta-Carotene) in rice seeds exemplifies the need for value added food crops especially in the developing world (Ye et al., 2000) where rice is used as major food crop.

VI. Detecting Expression of Recombinant Anti-Microbial Proteins

Transformed plant cells are screened for the ability to be cultured in selective media having a threshold concentration of a selective agent. Plant cells that grow on or in the selective media are typically transferred to a fresh supply of the same media and cultured again. The explants are then cultured under regeneration conditions to produce regenerated plant shoots. After shoots form, the shoots are transferred to a selective rooting medium to provide a complete plantlet. The plantlet may then be grown to provide seed, cuttings, or the like for propagating the transformed plants. The method provides for efficient transformation of plant cells with expression of a gene of autologous or heterologous origin and regeneration of transgenic plants, which can produce a recombinant anti-microbial protein.

The expression of the recombinant anti-microbial protein may be confirmed using standard analytical techniques such as Western blot, ELISA, PCR, HPLC, NMR, or mass spectroscopy, together with assays for a biological activity specific to the particular protein being expressed.

Example 3 describes the characterization of human lysozyme produced in the seeds of transgenic rice plants. Analyses used to confirm that recombinant lysozyme produced in transgenic rice is essentially the same as the native form of the protein both in physical characteristics and biological activity included, SDS-PAGE, reverse IEF gel electrophoresis, Western blot analysis, enzyme linked immunosorbant assay (ELISA), enzymatic activity assay and bactericidal activity assay using indicator strains, Micrococcus luteus and E.coli strain JM109.

Example 4 describes the characterization of human lactoferrin produced in the seeds of transgenic rice plants. Analyses used to confirm that recombinant lactoferrin produced in transgenic rice is essentially the same as the native form of the protein both in physical characteristics and biological activity included, Southern blot, Western blot, ELISA, N-Terminal Amino Acid Sequencing, analysis of glycosylation and determination of sugar content, a determination of the isoelectric point, pH dependent iron release of rLF, bacteriostatic activity assay of rLF using enteropathogenic E. coli as the indicator strain.

VII. Improved Feed and Methods

The invention provides, in one aspect, an improved feed containing a flour, extract, or malt seed composition obtained from mature monocot seeds and one or more seed-produced anti-microbial proteins in substantially unpurified form. Exemplary anti-microbial proteins are lysozyme and lactoferrin, where lysozyme is preferably present in an amount between about 0.05 and 0.5 grams protein/kg feed, and lactoferrin, in an amount between 0.2 to 2 grams/protein/kg feed. The feed to which the seed composition is added may be any standard feed suitable for a given production animals, e.g., chickens or cattle, and typically includes plant-produced composnents, such as grains or grain flour from corn, rice, barley and/or wheat. Exemplary feed for chickens is given in Example 7. In accordance with the invention, the animal feed to which the seed composition is added contains little or no small-molecule antibiotic(s), i.e., antibiotic levels that are themselves ineffective to optimize weight gain in the production animal. To determine the amount of seed composition to be added to the feed, one first determines the approximate desired weight percent or concentration of the given anti-microbial protein or proteins in the final feed material. Typically, the amount of protein anti-microbial protein effective for optimal weight gain in production animals will be in the range 0.05 to 5 mg protein/gram dry weight of feed, e.g., between about 0.005 to 0.5 weight percent of the anti-microbial protein. Effective levels can be determined, for example, by feed studies of the type reported in Example 7, where increasing amounts of anti-microbial protein, in the range indicated above, are added to feed, and weight gain and intestinal characteristics determined after several days-weeks of feeding.

The amount of seed composition added to the feed will, of course, depend on the concentration of the anti-microbial protein in the seed composition, and this concentration can be readily determined by standard protein assay methods, as described in Examples 3 and 4 below. For a grain composition, the level of heterologous protein present will be roughly that produced in seeds, e.g., between 0.1 to 1% of total seed weight. In this case, the final amount of grain composition added to the feed may be in the range 1-30%, depending on the final required level of anti-microbial protein. For an extract composition, the heterologous protein may be concentrated to form up to 5-40% or more of the total extract weight, so a much smaller percentage of extract composition will be required to achieve the desired level of anti-microbial protein, for example, between 0.1 to 10% by weight, typically, 1-5% of the total feed weight. A malt concentration, which will contain a significant percent of malt sugars, in addition to native and heterologous proteins, will typically contain an amount of anti-microbial protein that is intermediate between that of grain and the extract, and the amount added to feed will, accordingly, typically fall within the ranges of the other two compositions.

As an example, it may be desired to have a final concentration of lysozyme between about 0.05 and 0.5 grams protein/kg feed, and lactoferrin, in an amount between 0.2 to 2 grams/protein/kg feed. Thus, if a seed composition is found to contain 10 g/kg lysozyme, about 20 grams of the composition would be added to make up a liter of formula with a final lysozyme concentration of about 0.2 g/liter.

Below are described methods for preparing each of the three types of milk-protein-containing seed compositions.

A. Flour Composition

The flour composition is prepared by milling mature monocot plant seeds, using standard milling and, optionally, flour purification methods, e.g., in preparing refined flour. Briefly, mature seeds are dehusked, and the dehusked seeds then ground into a fine flour by conventional milling equipment.

The flour may be added to feed in powdered, particulate, or liquid form, in an amount typically between 1 to 30% or more of the dry weight of the feed, depending on the desired final amount of anti-microbial protein needed, as described above. One exemplary flour composition includes at least lactoferrin and/or lysozyme, where lysozyme is preferably present in an amount between about 0.05 and 0.5 grams protein/kg feed, and lactoferrin, in an amount between 0.2 to 2 grams/protein/kg feed, in addition to other anti-microbial proteins. Flour containing two or more anti-microbial proteins may be prepared by combining flour from seeds that separately produce the different proteins, for example, equal amounts of a flour containing lysozyme and a flour containing lactoferrin. Alternatively, a multi-protein composition can be prepared as seed flour from plants monocot plants co-transformed with chimeric genes expressing different milk proteins, e.g., lactoferrin and lysozyme.

B. Extract Composition

This composition is prepared by milling flour to form a flour, extracting the flour with am aqueous buffered solution, and optionally, further treating the water-soluble extract to partially concentrate the extract and/or remove unwanted components. Details of exemplary methods for producing the extract composition are given in Example 6. Briefly, mature monocot seeds, such as rice seeds, are milled to a flour, and the flour then suspended in a buffered solution. The flour suspension is incubated with shaking for a period typically between 30 minutes and 4 hours, at a temperature between 20-55° C. The resulting homogenate is clarified either by filtration or centrifugation. The clarified filtrate or supernatant may be further processed, for example by untrafiltration or dialysis or both to remove contaminants such as lipids, sugars and salt. Finally, the material may dried, e.g., by lyophilization, to form a dry cake or powder. A variety of aqueous media are suitable for the extraction buffer, including phosphate buffered saline (PBS) and ammonium bicarbonate, as demonstrated in Example 6. Volatile buffers like ammonium bicarbonate, in which the salt components of the buffer are volatilized on drying, may obviate an additional salt removal step, and thus offer a significant processing advantage.

The extract combines advantages of high protein yields, essentially limiting losses associated with protein purification. At the same time, the anti-microbial proteins are in a form readily usable and available upon ingestion of the animal feed. One feature for use in a feed product is the low amount of seed starch present in the extract. In particular, the extract may increase the concentration of recombinant protein from about 0.5% in conventional approaches to over about 25% in the extract approach. Some extract approach even reached 40% depending on the expression level of recombinant protein. In addition, the extract approach removes starch granules, which require high gelling temperature, for example above about 75° C. Consequently, the extract approach provides more flexibility in processing the rice grain and the recombinant proteins into feed. In the limiting case where the extract is processed to near protein purification or homogeneity, the amount of anti-microbial protein present may be in the range 70-95% of the extract.

The extract can be formulated and added to animal feed in powdered, or dry particleized or tabletized or powder form, In one embodiment, the extract is added to feed in an amount between about 0.5 to 10% by weight, preferably 1-5% by dry weight of the feed. An exemplary feed contains both lactoferrin and lysozyme, where lysozyme is preferably present in an amount between about 0.05 and 0.5 grams protein/kg feed, and lactoferrin, in an amount between 0.2 to 2 grams/protein/kg feed. The extract may alternatively, or in addition, include one or more of the other anti-microbial proteins noted above.

As above, extract containing two or more milk proteins may be prepared by combining extracts from seeds that separately produce the different proteins, or by processing seeds from plants co-transformed with chimeric genes expressing different milk proteins, e.g., lactoferrin and lysozyme.

C. Malt Composition

In accordance with another embodiment, the invention provides a malt extract or malt syrup (“malf”) in which seed starches have been largely reduced to malt sugars, and the anti-microbial protein(s) are in an active, bioavailable form. A variety of feed products can be produced, depending on the type of malt used, the mashing program and the ways in which the wort is subsequently handled. If materials other than barley malt are used in the mash (such as starch from other grains), the resulting product is referred to herein as a sweetened malt. Malt extracts, which may have a syrupy consistency or may be powders, are made by mashing ground malt, usually barley malt, in conventional brewery equipment, collecting the wort and concentrating it or drying it. Modem production of food malt extracts and malt syrups has evolved into three basic grain stages: steeping, germination, and drying of the germinated seed, followed by three more steps involving liquefaction of the germinated grain, mashing of the germinated grain, lautering (filtering), and evaporation. Many variations of malt extracts or syrups are possible. Flavor, color, solids, enzymatic activity, and protein are the basic characteristics that can be adjusted during production to provide malts specific for given food applications. (See, generally, Eley; Hickenbottom, 1996, 1997a, 1997b, 1983; Lake; Moore; Moe; Sfat; Doncheck; Briggs, 1981, 1998; and Hough).

C1. Steeping

After the barley of choice has been cleaned of foreign material, it is graded to size and transferred to steep tanks equipped with water inlet and outlet pipes. Compressed air is fed from the tank bottom for vigorous aeration and mixing for the barley/water mixture. When the barley has reached a water content of 43-45%, steeping is stopped.

C2. Germination

The steeped barley is moved to germination floors or rooms depending on the particular malt house's capabilities and allowed to germinate under controlled temperature, air, and moisture conditions. Total germination varies from four to seven days, depending on the barley type, density end use of the malt, and the controls or germination method used. All aspects of germination must be kept in constant balance to ensure proper kernel modification and yield.

Many enzymatic systems are activated during germination. Two of the systems are the oxidative and reductive systems involved with the respiration phase. Other enzymes break down the endosperm cell structure, which in itself if a measure of germination rate when the pentose production is evaluated. The proteolytic enzymes release or active beta-amylase and also work on the proteins present to render them soluble. In fact, about 40% of the total protein is made soluble in water. Optimum germination activates a balanced enzyme system, which hydrolyzes the starch present.

C3. Kilning

Drying or kilning, when done at the proper time and optimum degree of starch modification, stops the germination. The heat also catalyzes additional reactions, notably flavor and color development. The heating step is carried out at conventional kilning time and temperature conditions well known to those in the field. When drying is complete, the sprouts and other extraneous materials are removed, and the kernels are then ready for further processing.

C4. Malt Extracts and Syrups

The malted barley (kernel) is coarsely ground in crushers and fed into mash tuns where it is mixed with water. During a series of time and temperature changes, some of the starch is converted into fermentable sugars by action of the natural alpha- and beta-amylases, better known as the diastatic system. If cereal adjuncts are to be added, which result in malt syrups with mellower and sweeter flavors than the extracts, they are added at this stage usually derived from the cereal grains, corn and rice, although barley, wheat, rye, millet and sorghum are sometimes used, derived from mature seeds that produce the desired recombinant milk proteins.

Once the mash batch has achieved the correct degree of hydrolysis, it is transferred to lauter tuns. The lauter tun has a slotted or false bottom a few inches above the real bottom to allow for filtration and is also equipped with some means of agitation. During this extraction stage, the amylytic enzymes liquefy additional insoluble starches, converting them to maltose and dextrins. At the same time, the proteolytic enzymes attach certain proteins converting them into simpler, soluble forms. After the appropriate conditions have been met, the liquid phase, or wort, is drawn from the lauter tuns into evaporators.

Evaporation of the wort is conducted under vacuum where it is converted into a syrup of about 80% solids. Depending on the temperatures used, malt extracts or syrups of high, medium, or zero enzymatic activity can be produced. Color and flavor also can be controlled during this stage. The finishing steps of filtering, cooling, and packaging complete the malt extract/syrup process.

C5. Transgenic Malt Extract

For a transgenic malt extract, the starting barley is a transgenic barley engineered to produce on or more anti-microbial proteins in the endosperm either in grain maturation or in the malting process, or at both times. Malting and processing times and conditions are adjusted so that the bioactivity of the target recombinant molecules is preserved and the bioavailability of the target recombinant molecule is maximized. The resulting malt extract may be added directly to animal feed, in a desired weight ratio. Studies conducted in support of the present invention demonstrate that recombinant anti-microbial proteins lysozyme and lactoferrin retain activity after malting for up to 288 hrs. Thus, the malting procedure is useful in that it allows for extraction of microbial proteins in bioavailable form, with little loss of protein activity, and in a final composition that can serve as a source of sugar in the feed.

C6. Transgenic Sweetened Malt

For a transgenic sweetened malt syrup or extract, the starting barley can be a non-transgenic barley, or a transgenic barley, or a mixture of both. The barley is processed as described, except that during the mashing process, a cereal adjunct is added in a form that it is converted during the mashing process with the concurrent retention and generation of bioavailability and bioactivity of the target recombinant molecule fond within the transgenic cereal adjunct. The use of a transgenic cereal adjunct enables the production in the malt syrup of the target recombinant molecule expressed in the transgenic grain endosperm.

Preferred malt extracts or syrups contain lactoferrin and/or lysozyme. The malt may alternatively, or in addition, include one or more of the antimicrobial proteins noted above, such as the antimicrobial milk proteins lactohedrin, kappa-casein, haptocorrin, lactoperoxidase, and alpha-1-antitrypsin. As above, malt containing two or more anti-microbial proteins may be prepared by combining or preparing malts from seeds that separately produce the different proteins, or by preparing a malt from the seeds of plants co-transformed with chimeric genes expressing different milk proteins, e.g., lactoferrin and lysozyme.

D. Improved Feed Method

In accordance with another important aspect of the invention, it has been discovered (see Examples 6 and 7) that the nutritionally enhanced feed of the invention provides the same or improved intestinal health and weight gain as feed supplemented with small-molecule antibiotics. The improved method includes substituting conventional feed with a feed supplemented with one or more small-molecule antibiotics or a feed that has been nutritionally enhanced by addition of the seed composition of present invention, containing one or more anti-microbial proteins in substantially unpurified form. Preferably, conventional feed is substituted with feed nutritionally enhanced by the addition of lysozyme or lactoferrin in the seed composition. Preferably, the feed may be supplemented with antibiotics such as roxarsone and bactiracin methylene disalicylate. The provision of feed supplemented with one or more small molecule antibiotics or a feed enhanced by the seed composition comprising one or more antimicrobial proteins results in a feed method with improved feed efficiency and improved intestinal health of the animals to which it is administered.

From the foregoing, it can be appreciated how various objects and features of the invention are met. The results presented herein demonstrate that milk proteins may be expressed at high levels in the seeds of transgenic plants. Once produced, the protein-containing grain of the invention finds utility in improved animal feed that may be fed to production animals. When fed to animals, the improved animal feed of the invention find utility in increasing the growth rate and feed conversion efficiency of the animals, particularly for animals in a typical production environment (i.e., a low-sanitation environment), thereby reducing or eliminating the need for administration of ST antibiotics. The production of high levels of anti-microbial proteins in grains, exemplified herein by rice, provides the distinct advantage that feed supplements may be prepared with little or no purification. In one preferred approach, the transgenic grain is ground (e.g., into flour) and directly added to a production-animal feed, without additional processing.

Transgenic seeds are ideal bioreactors, combining low production costs and low or minimal downstream processing costs prior to use. Seed grain proteins can accumulate to 9-19% of grain weight (Lásztitym 1996); the endosperm proteins are synthesized during grain maturation and stored in protein bodies for use in the germination and seedling growth of the next plant generation; grains can be stored for years without loss of functionality, and therefore the downstream processing can be conducted independently of growing seasons.

Below are described methods for making grain, extract and malt compositions from mature monocot seeds containing seed-produced milk proteins. The composition is added to a feed or feed product in powdered, liquid, or particulate form, in an amount sufficient to bring the amount of added milk protein to effective levels.

All publications, patents and patent applications are herein expressly incorporated by reference in their entirety to the same extent as if each individual publication, patent or patent application was specifically and individually indicated to be incorporated by reference in its entirety.

### EXAMPLE 1

### Expression Vectors for Generation of Transgenic Plants

In general, expression vectors were constructed using standard molecular biological techniques as described in Ausubel et al., 1987. The vectors contain a heterologous protein coding sequence for lactoferrin or lysozyme under the control of a rice tissue-specific promoter, as further described below.

A. An Expression Vector for Human Lysozyme Expression in Transgenic Rice Cells

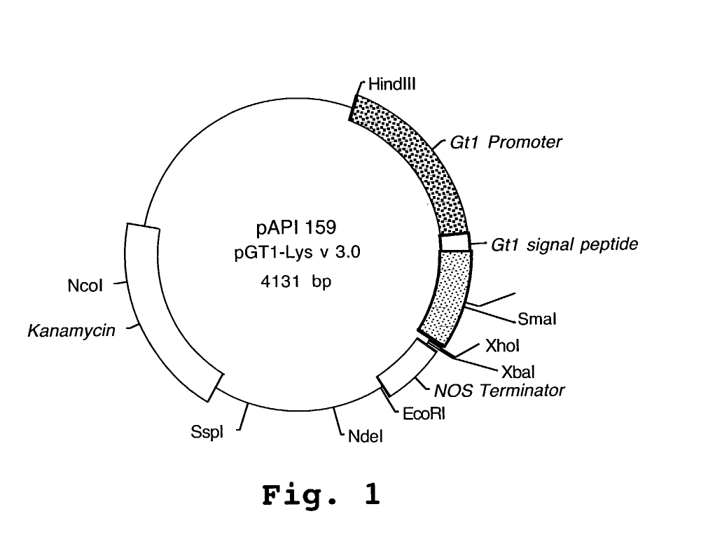

The synthesized lysozyme gene was cloned into an API base vector pAPI137 by conventional molecular cloning techniques (Sambrook et al., 1989). Plasmid pAPI137 contains the RAmy3D promoter (Huang et al., 1993), the codons for the RAmy3D signal peptide and the RAmy3D terminator. The RAmy3D promoter, isolated from the rice amylase gene family, is activated in rice calli by sugar starvation (Huang et al., 1993). The human lysozyme gene was placed between the sequences of the RAmy3D signal peptide and the RAmy3D terminator to give plasmid pAPI156 (FIG. 1) having a size of 4829 bp. Plasmid, pAPI76 carrying the bacterial hygromycin B phosphotransferase (hpt) gene was used for co-transformation of the calli to allow selection of the transformants.

Briefly, pAPI176 was created as following: A DNA fragment was amplified from a rice alpha-amylase gene RAmy1A (Huang et al., 1990b) and cloned into pBluescript KS+ at the SmaI/EcoRI restriction sites and the resulting plasmid was called p1AT. The PCR amplified fragment contained 297 bp of RAmy1A terminator. A BamHI DNA fragment from pGL2 (Shimamoto et al., 1989) was cloned into the BamHI site of p1AT and the resulting plasmid was called pAPI174. Finally a SacI/XbaI fragment amplified from glucanase gene, Gns9 (Romero et al., 1998) was inserted into pAPI174 using the same restriction sites. The PCR generated, Gns9 promoter fragment was confirmed by DNA sequencing. The resulting plasmid was named as pAPI176.

B. An Expression Vector for Human Lactoferrin Expression in Transgenic Rice

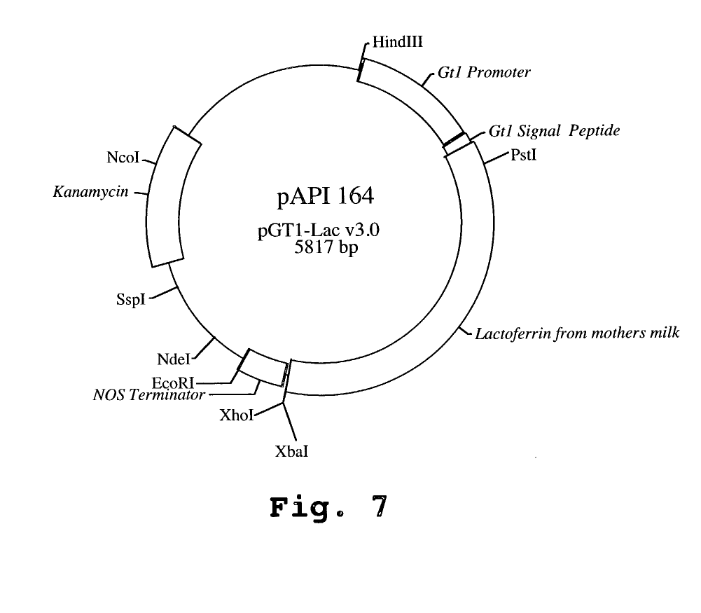

The hLF gene (Rey, 1990) was codon optimized and synthesized by Operon Technologies (California, USA). The plasmid containing the codon-optimized gene was called Lac-ger. Lac-ger was digested with SmaI/XhoI and the fragment containing the lactoferrin gene was cloned into pAPI141 that was partially digested with NaeI and completely digested with XhoI. The resulting plasmid was named pAPI164. For expression of hLF in rice seeds, the codon optimized gene was operably linked to the rice endosperm specific glutelin (Gt1) promoter and NOS terminator (FIG. 7).

The Gt1 promoter was cloned based on the published DNA sequence (Okita et al., 1989). Genomic DNA was isolated from a rice variety called M202 and the Gt1 promoter isolated by PCR. The primers used to amplify the fragment were MV-Gt1F1: 5′ ATC GM GCT TCA TGA GTA ATG TGT GAG CAT TAT GGG ACC ACG 3′ (SEQ ID NO:5) and Xba-Gt1-R1: 5′ CTA GTC TAG ACT CGA GCC ATG GGG CCG GCT AGG GAG CCA TCG CAC AAG AGG AA 3′ (SEQ ID NO:6). The PCR amplifications were carried out using the GeneAmp PCR system (model 2400, Perkin-Elmer) operated according to the manufacturers instructions. Basic cycling conditions were 30 cycles, after a 2 minute pre-denaturing step at 95° C., with a 30 second denaturing step at 95° C., a 30 second annealing step at specific temperature, and a 2 minute extension step at 72° C. The final extension step was 5 minutes at 72° C., followed by 4° C. soaking step. Reaction components per 50 μl volume, were 1 μg of genomic DNA or 1 ng of plasmid DNA, 2.5 μl of 5 μM primer mixture, 5 μl of 10 mM dNTP, 2.5 units of Taq polymerase (Perkin-Elmer), 5 μl of 10× PCR buffer (Perkin-Elmer).

The amplified fragment was then cloned in both orientations with the resulting plasmids designated pCRGT1 and pCRGT1 R. pCRGT1 R was digested with HindIII/XbaI and the fragment cloned into pAPI135 containing the kanamycin gene. The resulting plasmid was named as pAPI141.

To visualize and confirm the tissue specificity of the cloned promoter obtained by PCR, a GUS gene and NOS terminator was obtained from pRAJ275 (ClonTech, USA) and digested with EcoRI/NcoI. The fragment was inserted into pAPI141 and the resulting plasmid designated pAPI142.

The plasmid pAPI176 was constructed in three steps. A DNA fragment was amplified from a rice alpha-amylase gene, Ramy1A, (Huang et al., 1990b) and cloned into pBluescript KS+ at the SmaI/EcoRI restriction sites. The PCR amplified fragment contained 297 bp of Ramy1A terminator. The resulting plasmid was called p1AT. A BamHI DNA fragment from pGL2 (Shimamoto et al., 1989) was cloned in to BamHI site of p1AT. The BamHI fragment contained most of the hygromycin phosphotransferase (Hph) gene with deletion of four amino acids at C-terminus. This plasmid was called as pAPI174. Finally, a SacI/XbaI fragment amplified from glucanase gene, Gns9 (17) was inserted into pAPI174 using same restriction sites. The PCR generated, Gns9, promoter fragment was confirmed by DNA sequencing. The resulting plasmid was named as pAPI176.

### EXAMPLE 2

### Generation of Transgenic Plant Cells Expressing Anti-Microbial Proteins or Peptides

The procedure of microprojectile-mediated rice transformation (Chen et al., 1998 and Sivamani et al., 1996) was followed with modifications. Calli was raised from TP309 mature rice seeds, with calli two to four mm in diameter selected and placed on N6 media supplemented with 0.3 M mannitol and 0.3 M sorbitol for 20 hours before bombardment. Biolistic bombardment was carried out with the biolistic PDC-1000/He system (Bio-Rad, USA). Plasmids pAPI164 and pAPI176 were gold coated and co-bombarded at a ratio of 6:1 with a helium pressure of 1 100 psi. Two-day old bombarded calli were then transferred to N6 selection media supplemented with 20 mg/l hygromycin B and allowed to grow in the dark at 26° C. for 45 days.

In order to develop transgenic rice plants, the selected calli were transferred to pre-regeneration and regeneration media. When regenerated plants became 1-3 cm in height, the plantlets were transferred to rooting media consisting of half concentration of MS and 0.05 mg/l NAA. After two weeks, plantlets with developed roots and shoots were transferred to soil and kept under the cover of plastic container for a week. The plants were allowed to grow about 12 cm tall and shifted to the green house where they were grown up to maturity.

A. Generation of Human Lysozyme Expressing Transgenic Rice Cells and Plants

The synthetic human lysozyme (hLys) gene under the control of the RAmy3D promoter and terminator in the pAPI156 plasmid was used to generate sixty independent transformants by particle bombardment-mediated transformation.

Particle bombardment mediated transformation of rice was carried out as described above. (See Chen et al., 1998.) Briefly, rice calli derived from TP309 were bombarded with gold particles coated with plasmids pAPI156 and pAPI76 in a ratio of 6:1 using the helium biolistic particle delivery system, PDS 1000 (Bio-Rad, CA). Transformed calli were selected in the presence of hygromycin B (35 mg/L) on N6 (Sigma, Mo.).

Selected cell lines were maintained in culture media with 3% sucrose (Huang et al., 1993). Lysozyme expression was induced by sugar starvation. Briefly, AA medium (containing 3% sucrose) was removed by aspiration, followed by washing the cells three times with AA minus sucrose (AA-S). The cells were then incubated with AA-S at 40% (v/v) density for three and a half days to obtain the optimal level of lysozyme expression.

Transformants expressing lysozyme were identified by immunoblot analysis, turbidimetric rate determination with Micrococcus lysodeikticus or ELISA. Calli were ranked according to the expressed lysozyme level. Suspension cell cultures from the top lines were established following the procedure described previously (Huang et al., 1993). The amount of total protein (Bradford assay) and lysozyme (ELISA) was evaluated in selected calli (Table 1).

TABLE 1
Expression Level Of Human Milk Lysozyme In Transformed Calli

| | | Total protein | Lysozyme | Lysozyme/protein |
|---|---|---|---|---|
| Cell line | Calli (g) | (μg) | (μg) | (%) |
| 156-1 | 0.39 | 2626.5 | 65.7 | 2.5 |
| 156-5 | 0.38 | 5510 | 68.9 | 1.25 |
| 156-16 | 0.4 | 4815 | 120.4 | 2.5 |
| 156-19 | 0.44 | 2440 | 30.5 | 1.25 |
| 156-28 | 0.49 | 4910 | 24.6 | 0.5 |
| 156-43 | 0.56 | 8150 | 101.9 | 1.25 |
| 156-47 | 0.37 | 2472 | 6.2 | 0.25 |

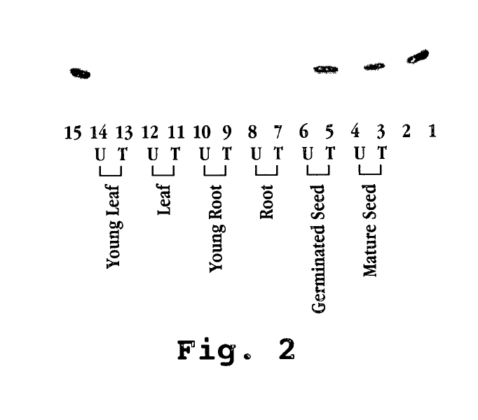

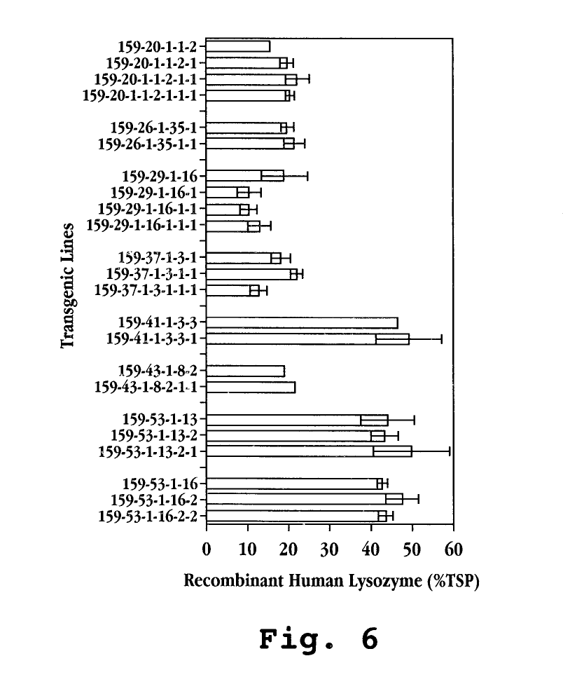

Transformed calli were selected as described above, then transferred to pre-regeneration and regeneration media. When regenerated plants became 1-3 cm in height, the plantlets were transferred to rooting media which consisted of half concentration of MS and 0.05 mg/l NAA. After two weeks, plantlets with developed roots and shoots were transferred to soil and kept under the cover of plastic container for a week. The plants were allowed to grow about 12 cm tall and shifted to the green house where they were grown up to maturity (RO plants). FIG. 2 illustrates the seed specific expression of human lysozyme in transgenic plants and FIG. 6 shows the expression level of human lysozyme in powdered R3 seeds taken from transgenic rice plants. In completing this analysis, the human lysozyme in powdered R3 seeds was extracted by mixing rice powder (prepared by grinding with a Kitchen Miller) with phosphate buffer saline (PBS) containing 0.35 N NaCl at 1 gm/40 mL for one hour. The whole homogenate was allowed to settle, 1 mL homogenate was removed and centrifuged at 4° C. and 14000 rpm for 15 min. The supernatant was removed and diluted as needed for lysozyme assay by ELISA.

Embryos from individual R1 seed (derived from RO plants) that showed a level of lysozyme expression that was greater than 10 μg/seed were saved and used to generate R1 plants. Briefly, seeds were dissected into embryo and endosperm portions. The endosperm was ground and assayed for lysozyme expression (as further described below). Embryos were sterilized in 50% commercial bleach for 25 minutes and washed with sterile H₂O three times for 5 minutes each. Sterilized embryos were placed in a tissue culture tube that contained MS solid medium. Embryos germinated and plantlets having about three inches shoots and healthy root systems were obtained in two weeks. The plantlets were then transferred to pots to obtain mature plants (R1).

B. Generation of Human Lactoferrin Expressing Transgenic Rice Cells and Plants

The synthetic human lysozyme gene under the control of the Gt1 promoter in the pAPI164 plasmid was used to generate over 100 independent transformants by particle bombardment-mediated transformation.

Particle bombardment mediated transformation of rice was carried out as described in (Chen et al., 1998). Briefly, rice calli derived from TP309 were bombarded with gold particles coated with plasmids pAPI164 and pAPI76 in a ratio of 6:1 using the helium biolistic particle delivery system, PDS 1000 (Bio-Rad, CA).

Two day old bombarded calli were then transferred to N6 selection media supplemented with 20 mg/l hygromycin B and allowed to grow in the dark at 26° C. for 45 days. The selected calli were then transferred to pre-regeneration and regeneration media. When regenerated plants became 1-3 cm in height, the plantlets were transferred to rooting media which consisted of half concentration of MS and 0.05 mg/l NAA. After two weeks, plantlets with developed roots and shoots were transferred to soil and kept under the cover of plastic container for a week. The plants were allowed to grow about 12 cm tall and shifted to the green house where they were grown up to maturity.

### EXAMPLE 3

### Characterization of Recombinant Human Lysozyme (rLys) Produced by Transgenic Rice Cells and Plants

A. Purification, SDS-PAGE and Reverse IEF Gel Electrophoresis

Induced calli or harvested cells from suspension cell cultures were ground with cold phosphate buffered-saline (PBS) with a protease inhibitor cocktail (2 μg/ml aprotonin, 0.5 μg/ml leupeptin, 1 mM EDTA and 2 mM Pefabloc). The protease inhibitor cocktail was excluded from the buffer used subsequently during the purification of the enzyme, since the inhibitors did not increase the lysozyme expression yield. Grinding was conducted with a pre-chilled mortar and pestle at approximately 2 ml buffer/g calli or cells. A clear homogenate was obtained by subjecting the resulting extract to centrifugation at 16,000× g for 10 minutes at 4 C.

SDS-PAGE was carried out using an 18% precast gel (Novex, CA). The resulting gel was stained with 0.1% Coomassie brilliant blue R-250 at 45% methanol and 10% glacial acetic acid for three hours. Gel destaining was conducted with 45% methanol and 10% glacial acetic acid until the desired background was reached.

Reverse IEF gel electrophoresis was carried out using a precast Novex pH 3-10 IEF gel according to the manufacturer's instructions (Novex, CA). About 30 μg of lysozyme was loaded onto the gel and electrophoresed at 100 V for 50 minutes followed by application of 200 V for 20 minutes. The gel was then fixed in 136 mM sulphosalicylic acid and 11.5% TCA for 30 minutes and stained in 0.1% Coomassie brilliant blue R-250, 40% ethanol, 10% glacial acetic acid for 30 minutes. The destaining solution contained 25% ethanol and 8% acetic acid.

B. Western Blot Analysis

A SDS-PAGE gel was electroblotted to a 0.45 μm nitrocellulose membrane using a Mini Trans-Blot Electrophoretic Transfer Cell (Bio-Rad, CA) and subsequently subjected to immuno-blotting analysis. The blot was blocked with 5% non-fat dry milk in PBS, pH 7.4 for at least two hours followed by three washes with PBS, pH 7.4 for 10 minutes each. The primary rabbit polyclonal antibody against human lysozyme (Dako A/S, Denmark) was diluted at 1:2000 in the blocking buffer and the blot was incubated in the solution for at least one hour. The blot was then washed with PBS three times for 10 minutes each. The secondary goat anti-rabbit IgG (H+L)-alkaline phosphatase conjugate (Bio-Rad, CA) was diluted in the blocking buffer at 1:4000. The membrane was then incubated in the secondary antibody solution for one hour and then washed three times. Color development was initiated by adding the substrate system BCIP-NBT (Sigma) and the process was stopped by rinsing the blot with H₂O once the desirable intensity of the bands had been achieved.

C. Enzyme Linked Immunosorbant Assay (ELISA)

An indirect sandwich ELISA was developed to quantify total lysozyme expressed in rice calli or cells and used as an alternative assay to determine the lysozyme expression yield. A direct sandwich ELISA for lysozyme quantification has been previously reported (Lollike et al., 1995, Taylor, 1992), however an alternate assay was developed as a key reagent used in the assay is no longer commercially available.

In carrying out the assay, rabbit anti-human lysozyme antibody (Dako D/K, Denmark) was used to coat a 96 well plate at 1:5000 diluted in PBS overnight at room temperature. After washing with PBS, the plate was blocked with 5% normal donkey serum (Jackson ImmunoResearch Laboratories, PA) in PBS for one hour. The plate was washed again with PBS. Lysozyme samples were diluted in 0.05% Tween in PBS and captured by adding to the plate and incubating for one hour. After washing the plate with PBS, sheep anti-human lysozyme at 1:1000 diluted with 0.05% Tween in PBS was added and incubated for one hour. The plate was washed again with PBS. Peroxidase-conjugated affinipure donkey anti-sheep IgG (H+L) diluted in 0.05% Tween in PBS at 1:10,000 was added and incubated for one hour. After a final wash of the plate with PBS, color was developed by incubating the plate with TMB substrate (Sigma, MO) for 5-15 minutes and the absorbance read at 655 nm.

D. Enzymatic Activity Assay For Lysozyme

An indirect sandwich ELISA was developed to quantify total lysozyme expressed in rice calli or cells and used as an alternative assay to determine the lysozyme expression yield. A direct sandwich ELISA for lysozyme quantification has been previously reported (Lollike et al., 1995, Taylor, 1992 #284), however an alternate assay was developed as the alkaline phosphatase (AP) conjugated sheep anti-human lysozyme is no longer commercially available.

In carrying out the assay, rabbit anti-human lysozyme antibody (Dako D/K, Denmark) was used to coat the plate at 1:5000 diluted in PBS overnight at room temperature. After washing with PBS, the plate was blocked with 5% normal donkey serum (Jackson ImmunoResearch Laboratories, PA) in PBS for one hour. The plate was washed again with PBS. Lysozyme samples were then diluted in 0.05% Tween in PBS and captured by incubating for one hour. After washing the plate with PBS, sheep anti-human lysozyme at 1:1000 diluted with 0.05% Tween in PBS was added and incubated for one hour. The plate was washed again with PBS. Peroxidase-conjugated affinipure donkey anti-sheep IgG (H+L) diluted in 0.05% Tween in PBS at 1:10,000 was added and incubated for one hour. After a final wash of the plate with PBS, color was developed by incubating the plate with TMB substrate (Sigma, MO) for 5-15 minutes and Absorbance was read at 655 nm.

E. Enzymatic Activity Assay For Lysozyme

A reliable and quantitative method was developed to analyze the expression level of enzymatically active lysozyme. The turbidimetric assay was developed using a 96-well microtiter plate format and based on the standard lysozyme assay that is carried out spectrophotometrically in cuvettes. A microtiter plate based method previously described for the detection of lysozyme release from human neutrophils had a detection range of 1-100 ng/ml (Moreira-Ludewig and Healy, 1992). The assay conditions were modified to maintain the linearity of detection up to 3.0 μg/ml.

The enzymatic activity of lysozyme was routinely determined by spectrophotometric monitoring of the decrease in turbidity at 450 nm of a suspension of Micrococcus luteus (M. lysodeikticus) cells (Shugar, 1952). Specifically, 250 μl of a 0.015% (w/v) Micrococcus leteus cell suspension was prepared in 66 mM potassium phosphate, pH 6.24 (buffer A). Cell suspensions were equilibrated at room temperature and the reaction was initiated by adding 10 μl samples containing lysozyme with concentrations from 0 to 2.4 μg/ml. Lysozyme activity was determined in a kinetic mode for 5 minutes at 450 nm. The concentration of lysozyme was then calculated by reference to the standard curve constructed with human milk-derived lysozyme.

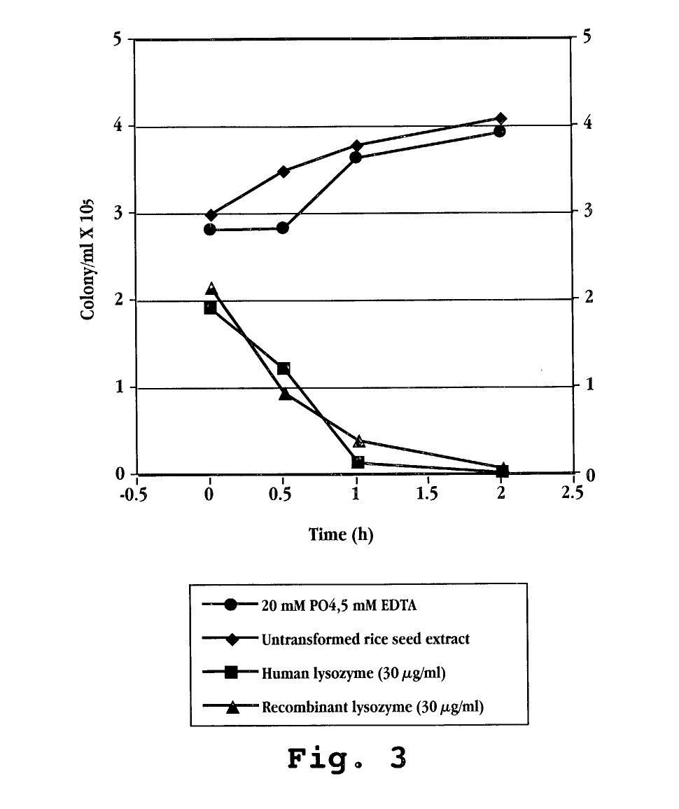

The enzymatic activity of human milk lysozyme and the rice calli derived lysozyme of the invention was compared. As shown in FIG. 3, the lysozyme effected reduction of the turbidity of Micrococcus leteus cell suspensions at 450 nm was very similar for lysozyme from the two sources, while buffer alone did not have any effect on the reduction of turbidity.

Three selected suspension cell culture lines were induced to express lysozyme and the yield estimated in parallel by ELISA and the enzymatic activity assay described above (Table 2). T-test analysis showed that there was no significant difference between the lysozyme concentration measured by ELISA and enzymatic activity assay (p<0.05). These results demonstrate that active recombinant human milk lysozyme is synthesized and maintained in rice callus cells and can be isolated without losing its activity.

Table 2. Comparison Of Lysozyme Yields Estimates By Enzymatic Activity Assay And ELISA.

| | Lysozyme yield by enzymatic | Lysozyme yield by ELISA |
|---|---|---|
| | activity assay (lysozyme/total | (lysozyme/total protein |
| Cell line | protein μg/mg) | μg/mg) |
| 156-5 | 25.8 +/− 6.3 | 30.3 +/− 3.9 |
| 156-16 | 32.1 +/− 5.7 | 32.9 +/− 3.2 |
| 156-31 | 47.0 +/− 6.2 | 42.3 +/− 7.0 |

F. Recombinant Human Lysozyme has Bactericidal Function

The sensitive lysis of Micrococcus luteus cells in a turbidimetric assay (FIG. 3) indicates that recombinant human lysozyme possesses enzymatic activity and functions as a bactericide. To confirm this with a gram-negative bacterium, a bactericidal assay was carried out using an E. coli strain (JM109) as a test organism (data not shown).

In carrying out the assay, an aliquot of overnight JM109 culture was grown in LB medium until mid log phase. A standard inoculum of mid-log phase JM109 at 2×10⁵ CFU (colony forming units)/ml was used in the bactericidal assay. Buffer (20 mM Sodium phosphate, pH 7.0, 0.5 mM EDTA) alone, buffer containing human milk lysozyme or rice cell culture derived lysozyme at about 30 μg/ml were sterilized by filtration. The mixture of cells and lysozyme solution was then incubated at 37 C for the specified length of time. One-fifth of the mixture volume was plated onto the LB agar plates and incubated overnight at 37 C in order to determine the number of colony forming units. At the concentration of 30 μg/ml, recombinant human lysozyme exhibited a similar bactericidal effect as lysozyme from human milk. There was no reduction of colony forming units using an extract from the non-transgenic control.

G. Purification of Lysozyme From Rice Calli, Suspension Cultures and Transgenic Rice

Five rice calli lines expressing high levels of lysozyme were propagated and induced by sucrose starvation. The calli or cells were ground by a Tissuemizer in extraction buffer (PBS, 0.35 M NaCl) at 2 ml buffer/g of wet calli. The resulting tissue homogenate was centrifuged at 25,000× g for 30 minutes at 4 C. The supernatant was removed and subjected to filtration through a pre-filter and then through a 0.45 μm nitrocellulose filter.

Approximately 1 liter of filtered supernatant from 500 grams of induced wet calli were then dialyzed against 50 mM sodium phosphate, pH 8.5 at 4 C overnight. The supernatant was loaded onto a 200 ml SP Sepharose fast flow column (XK26/40, Pharmacia) equilibrated with the loading buffer (50 mM sodium phosphate, pH 8.5) at a flow rate of four ml/min. The column was then washed with the same buffer until a baseline of A280 was achieved. Lysozyme was eluted by 0.2 M NaCl in the loading buffer and fractions containing lysozyme activity were pooled, concentrated and reapplied to a Sephacryl-100 column equilibrated and run with PBS at a flow rate of one ml/min. Proteins were eluted and separated by using PBS at a flow rate of one ml/min. Pure lysozyme fractions were identified by activity assay and total protein assay (Bradford). Finally the purity of lysozyme was confirmed by SDS-PAGE.

The five lines with the highest lysozyme expression level were selected and propagated continuously in petri dishes or shake flasks for lysozyme isolation and purification. A crude extract from rice callus contains both recombinant human lysozyme and large amounts of native rice proteins. Since the calculated pi of lysozyme is approximately 11, a strong cation exchange column, SP-Sepharose fast flow (Pharmacia), was chosen as the first column to separate the rice proteins from recombinant human lysozyme. Most of the rice proteins did not bind to the column when equilibrated with 50 mM sodium phosphate, pH 8.5. The recombinant human lysozyme, on the other hand, bound to the column and was eluted by 0.2 M NaCl. Rice proteins that co-eluted with recombinant human lysozyme, were separated from lysozyme by gel filtration through a Sephacryl S-100 column and highly purified recombinant human lysozyme was obtained.

R2 rice seeds from transgenic plants were dehusked and milled to flour using conventional methods. Lysozyme was extracted by mixing the rice flour with 0.35 N NaCl in PBS at 100 grams/liter at room temperature for one hour. The resulting mixture was subjected to filtration through 3 μm of a pleated capsule, then through 1.2 μm of a serum capsule and finally through a Suporcap 50 capsule with a 0.8 μm glass filter on top of 0.45 μm filter (Pall, MI).

The clear rice extract (1 liter) was then dialyzed against 50 mm sodium phosphate, pH 8.5 at 4° C. overnight and the dialyzed sample was loaded onto a cation exchange resion SP-Sepharose (Pharmacia Amersham), which was pre-conditioned with 50 mm sodium phosphate, pH 8.5 before loading. After loading, the column was washed with the same buffer until a base line A280 reading was achieved, then lysozyme was eluted with 0.2 N NaCl in 50 mm sodium phosphate, pH 8.5. Fractions containing lysozyme were pooled and reapplied to a Sephacryl S-100 column (Bio-Rad; equilibrated and run with PBS). Pure lysozyme fractions were identified by enzymatic assay and total protein assay (Bradford) and the purity of lysozyme was confirmed by SDS-PAGE.

H. Attributes of Recombinant Human Lysozyme Produced in Rice

(i). N-Terminal Amino Acid Sequencing

Recombinant human lysozyme (rLys) isolated from mature rice seed as described above, was separated by 18% SDS-PAGE followed by electroblotting to a PVDF membrane (Bio-Rad, CA). The lysozyme band was identified by staining the membrane with 0.1% Coomassie Brilliant Blue R-250 in 40% methanol and 1% glacial acetic acid for 1 minute. The stained PVDF membrane was immediately destained in 50% methanol until the band was clearly visible. After the blot was thoroughly washed with H₂O and air-dried, it was sequenced with a sequencer ABI 477 by Edman degradation chemistry at the Protein Structure Laboratory of the University of California at Davis. The results showed that the rLys produced in transgenic rice seed had an identical N-terminal sequences to the human lysozyme, as follows:

Recombinant Lys—LysVaLPheGluArg( )GluLeuAlaArgThr

Human Lys—LysValPheGluArgCysGluLeuAlaArgThr

Additionally, a number of structural and functional attributes of human lysozyme and recombinant lysozyme produced in rice were found to be the same, including molecular weight, pi, bactericidal effect with E. coli, thermal and pH stability and specific activity.

(ii). Thermal and pH stability of lysozyme

A human lysozyme standard and lysozyme from rice were diluted to a final concentration of 50 μg/ml in PBS and subjected to the following thermal treatment in a sequential mode: (1): 62 C for 15 minutes; (2): 72 C for 20 seconds; (3): 85 C for 3 minutes and finally; (4): 100 C for 8 seconds. Studies were conducted with 100 μl per tube and repeated three times. Aliquots were saved at the end of each treatment and the remaining lysozyme activity was measured by activity assay.

For studies on pH stability, lysozyme was dissolved in 0.9% NaCl at 100 μg/ml at pH 7.3, 5, 4, 3 and 2. The solutions were incubated at 24° C. for one hour. Experiments were conducted with 200 μl per tube and repeated three times. Remaining lysozyme was detected by lysozyme activity assay.

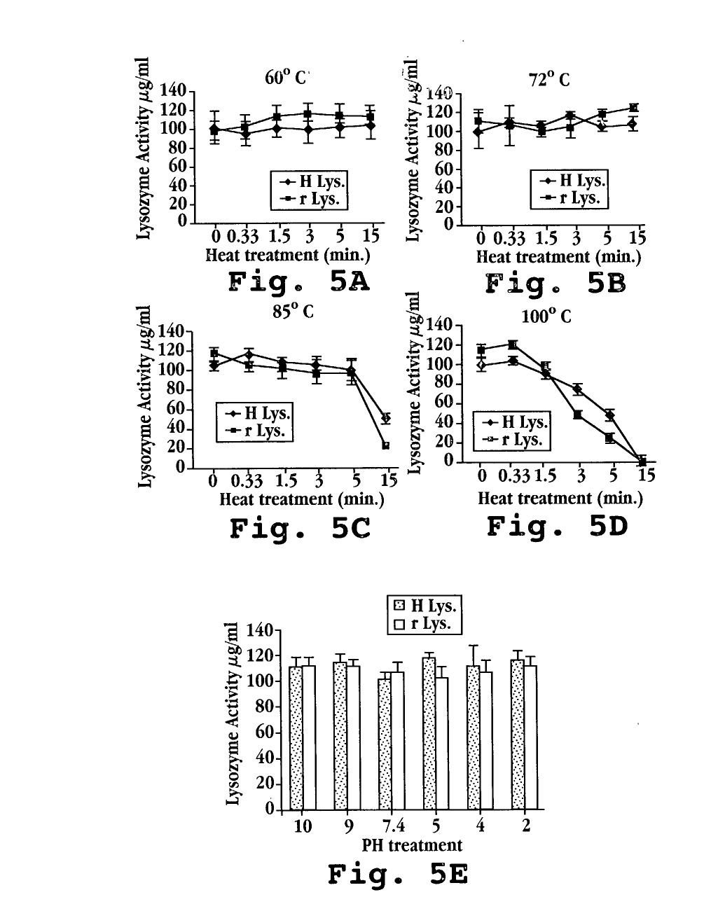

For biotechnological applications of the recombinant human lysozyme, its thermal and pH stability as well as its resistance to proteases is of decisive importance. In the results presented in FIG. 5, recombinant lysozyme exhibited the same degree of thermal stability in the temperature range from 62 C to 100 C as human milk lysozyme. The pH stability of recombinant and native lysozyme was comparable over the range of pH 2-7.3 (FIG. 5).

(iii). Determination of in vitro Protease Resistance of Lysozyme

Lysozyme was dissolved in 0.9% NaCl at 100 μg/ml. The pH of the solution was reduced to 3, 4 and 5 with HCl. Pepsin (Sigma, MO) (pepsin: lysozyme=1:22 (w/w)) was added and the solutions were incubated at 37° C. for one hour. Then the pH of all treatments was raised to pH 7 with bicarbonate. Pancreatin (Sigma, MO) (pancreatin: lysozyme=1:110 (w/w)) was added to the neutral solution and incubated at 37 C for two hours. The remaining lysozyme activity was measured by activity assay.

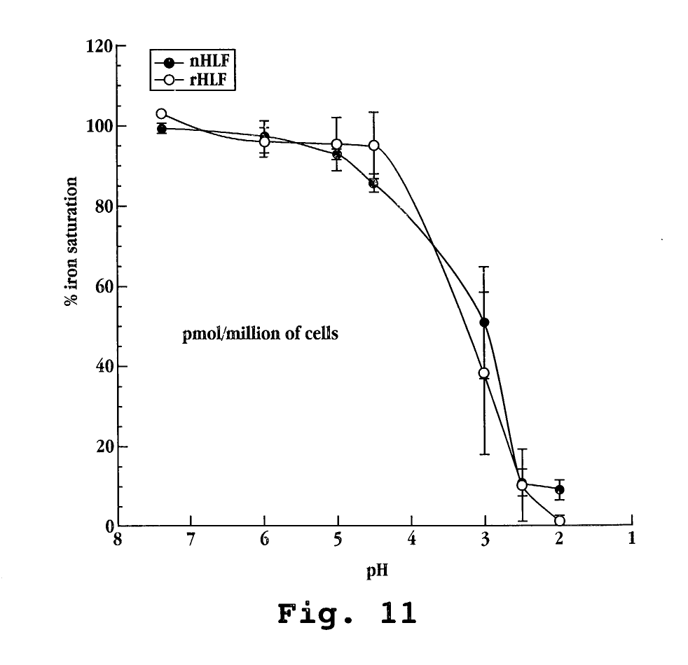

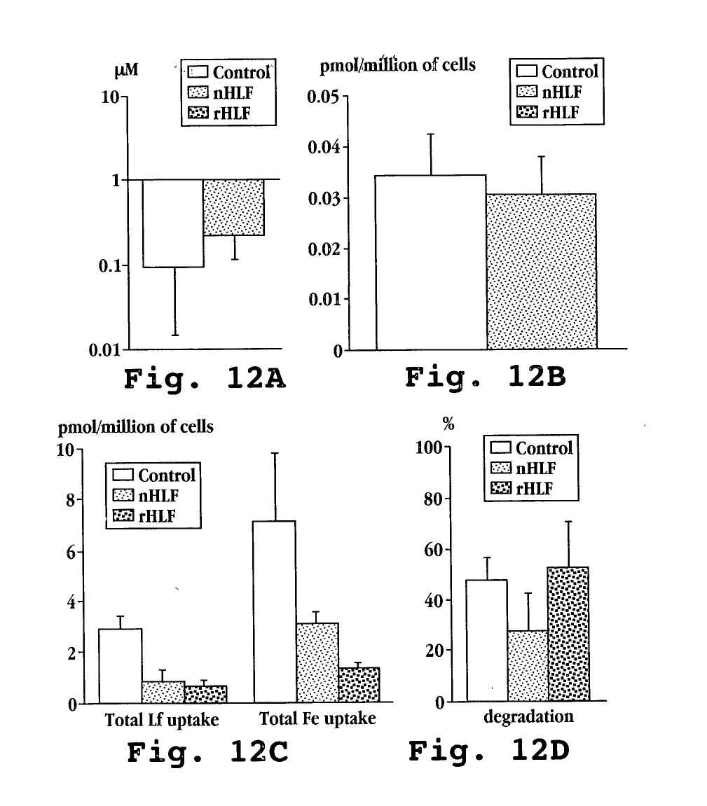

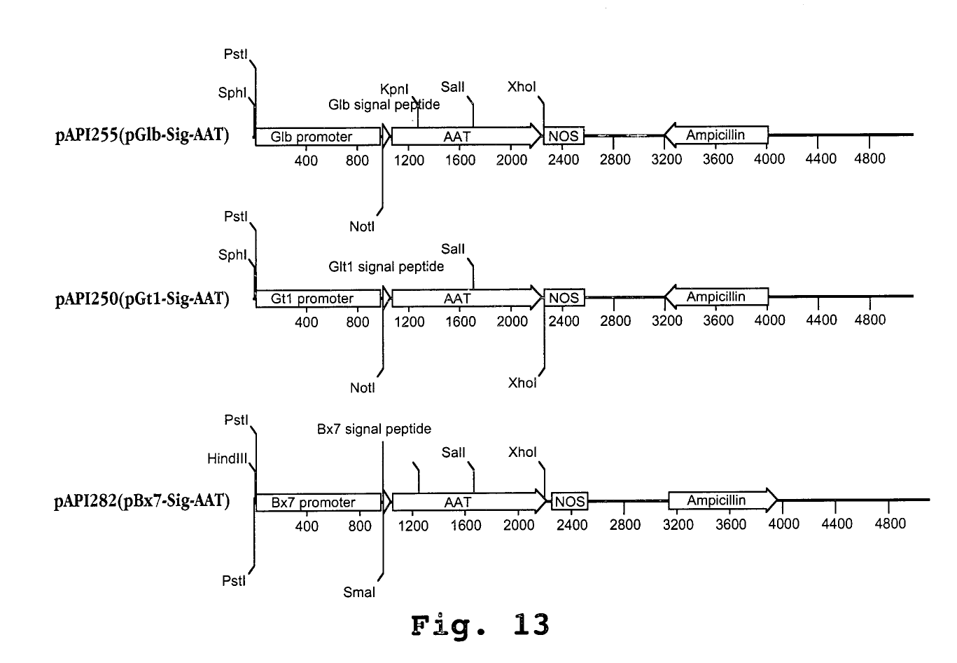

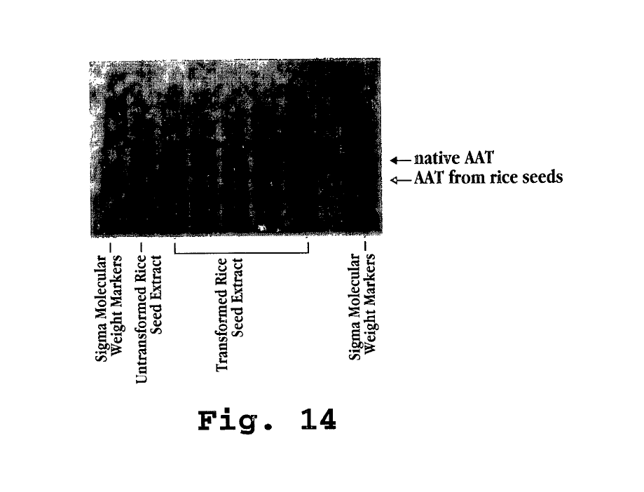

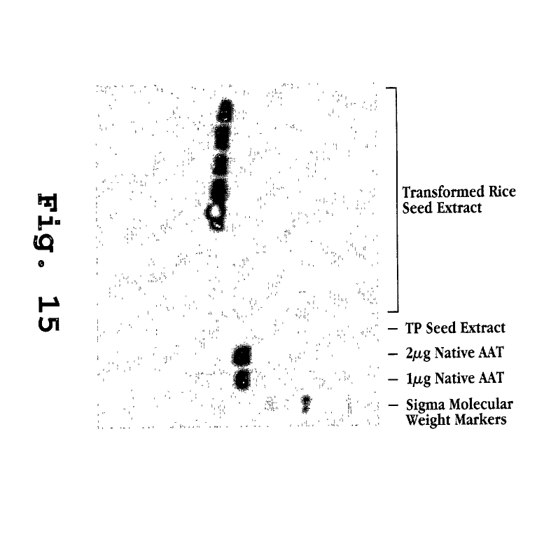

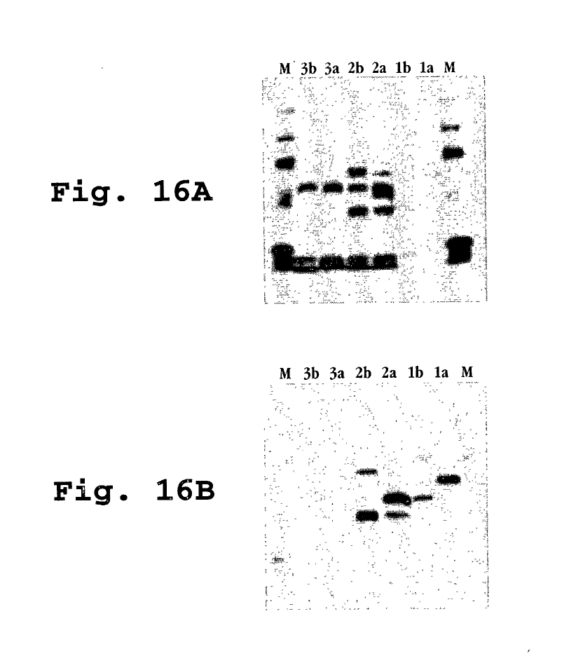

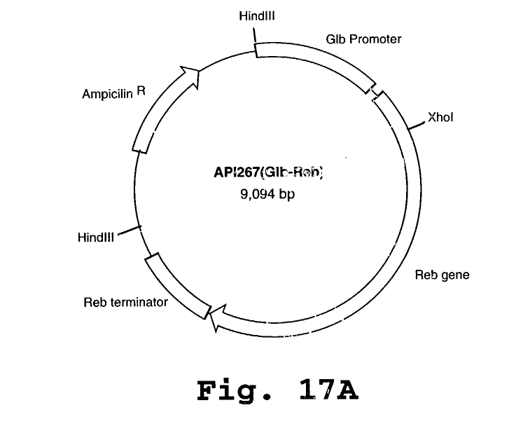

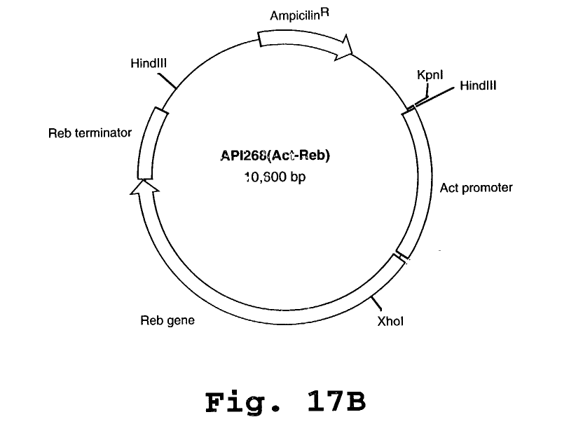

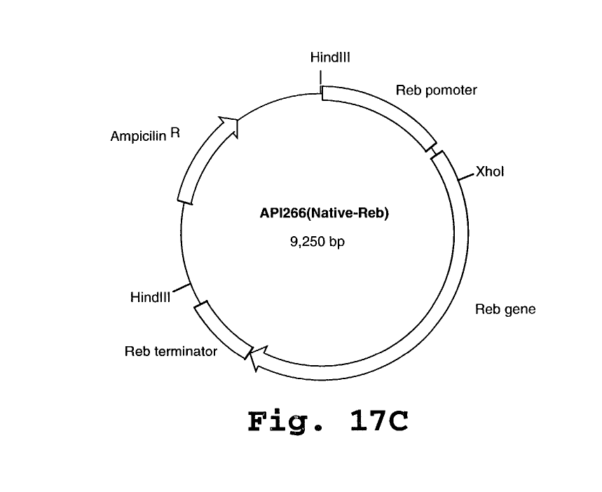

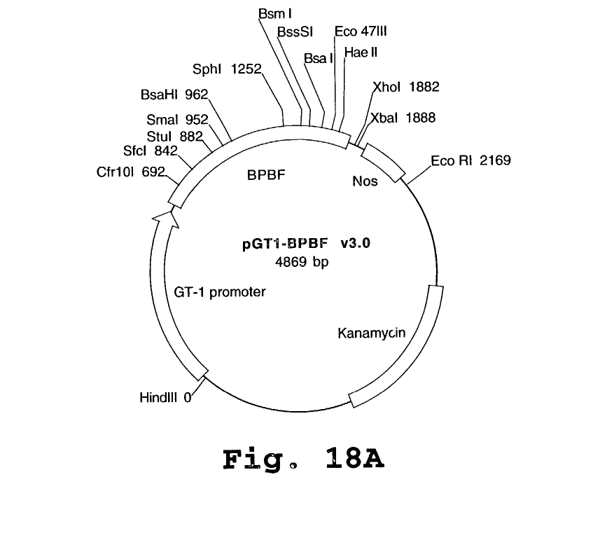

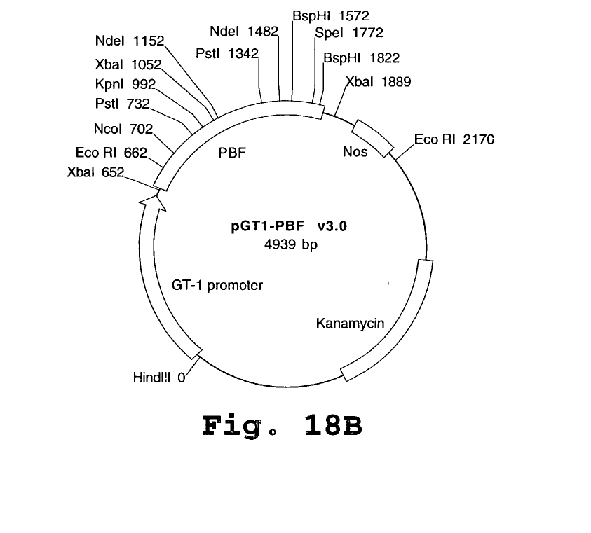

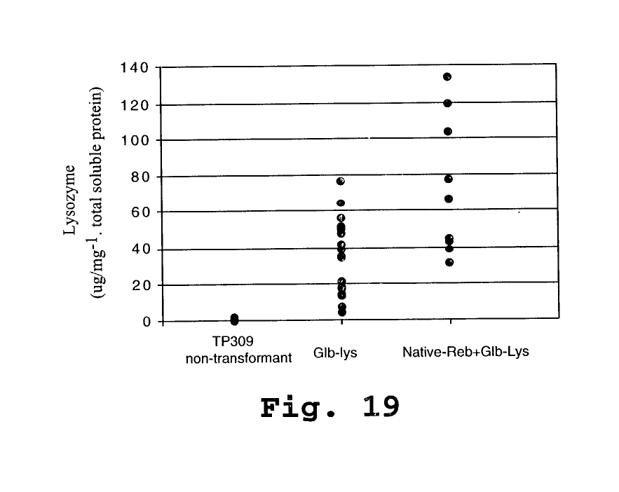

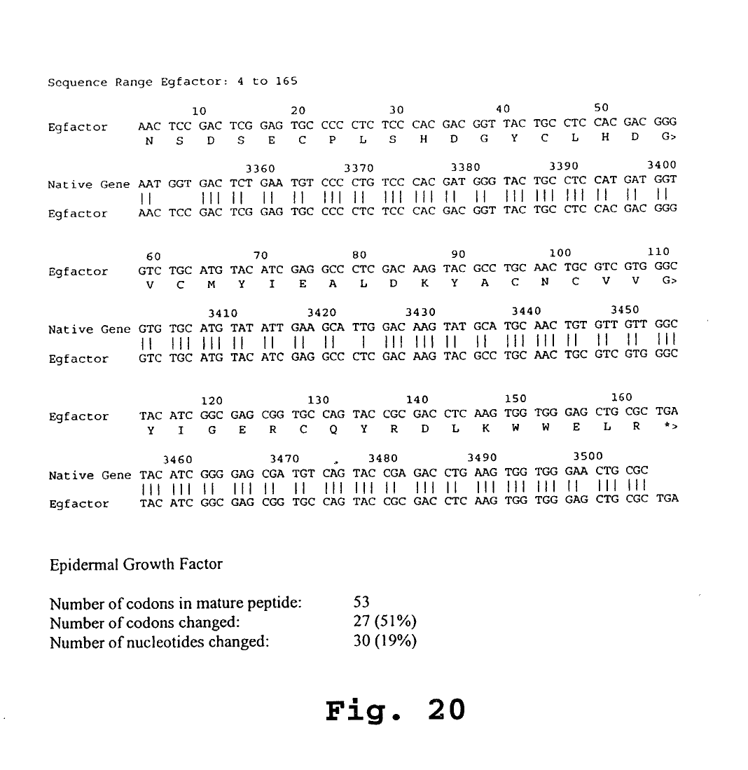

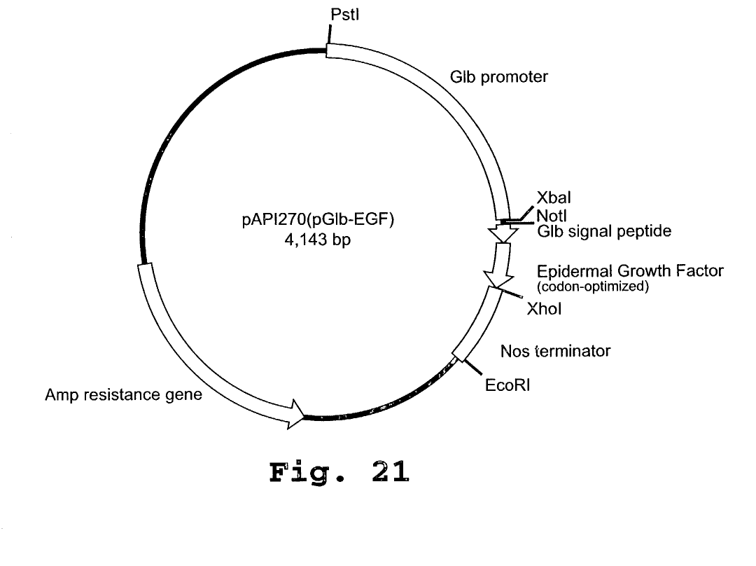

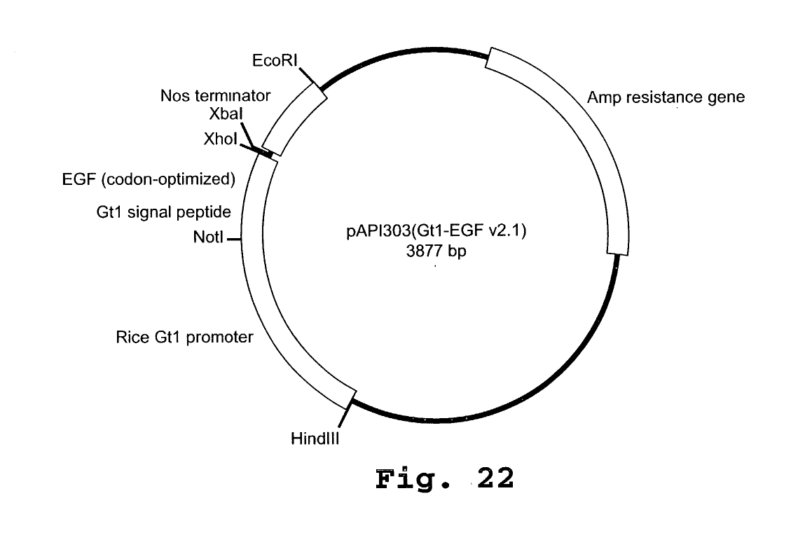

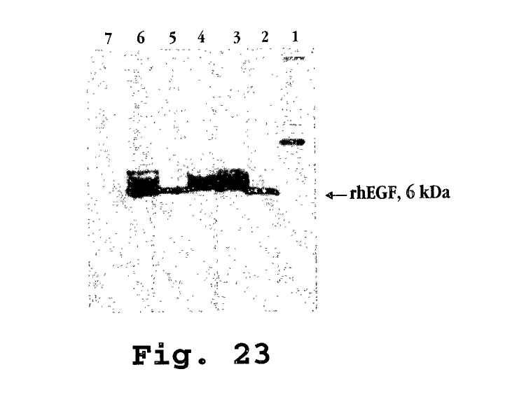

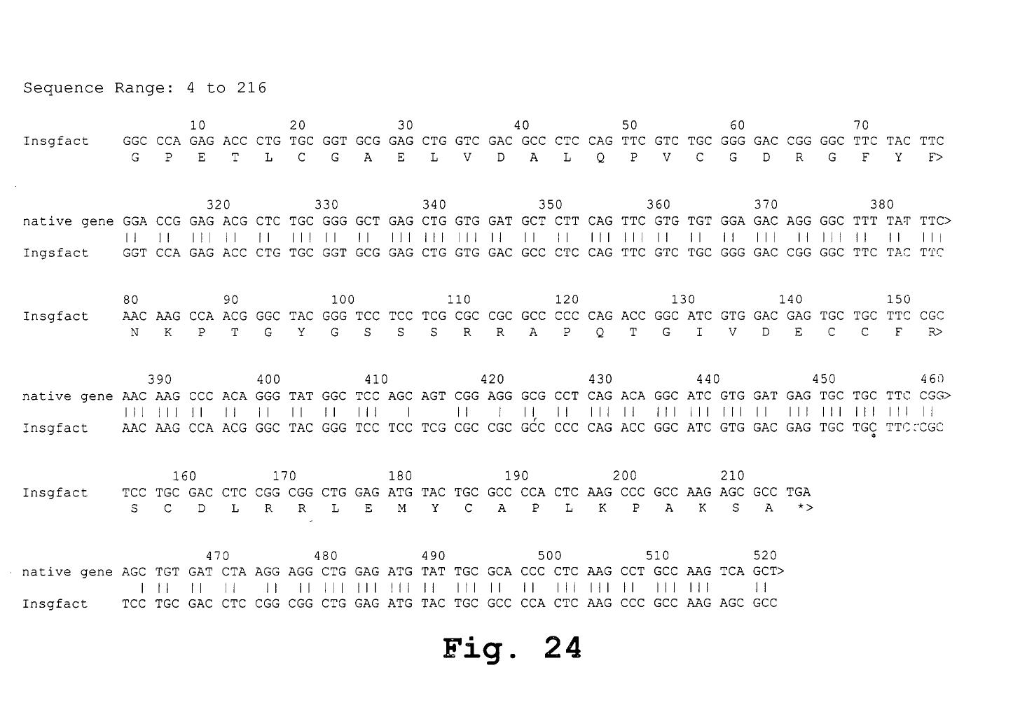

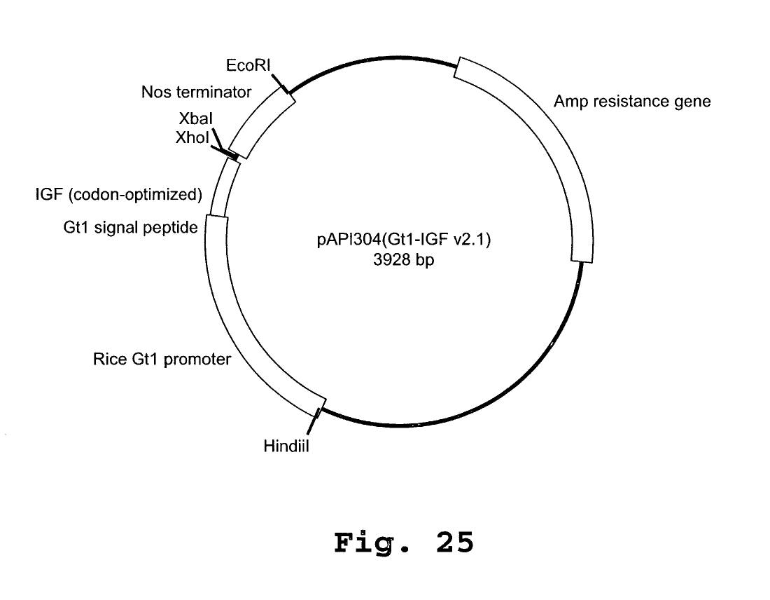

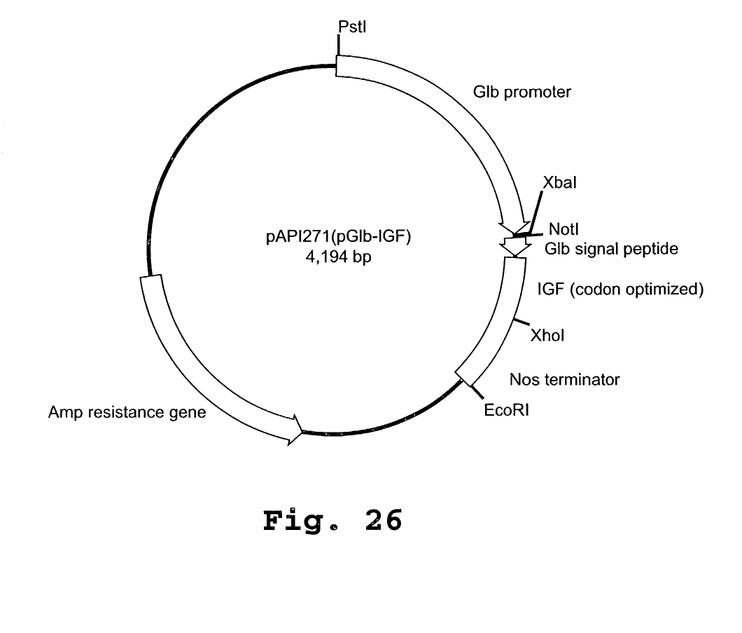

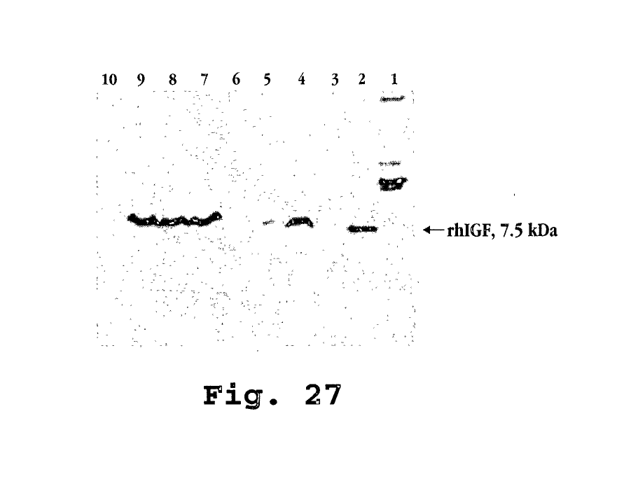

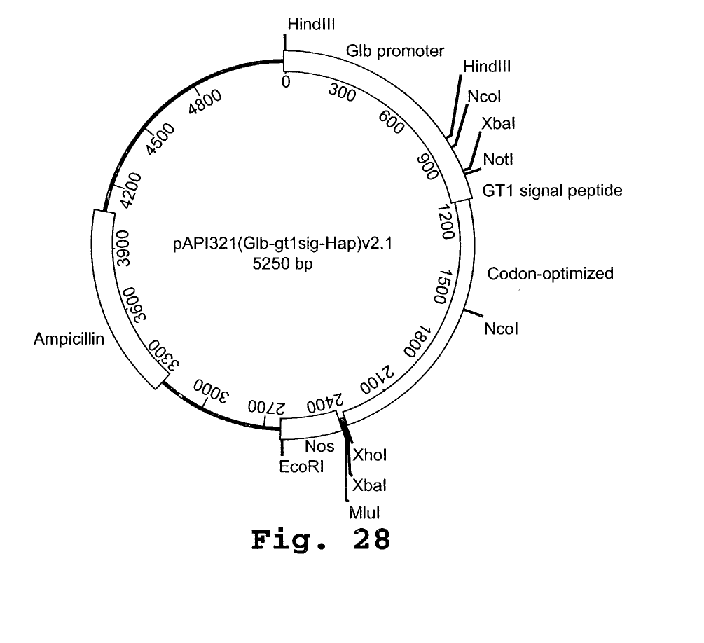

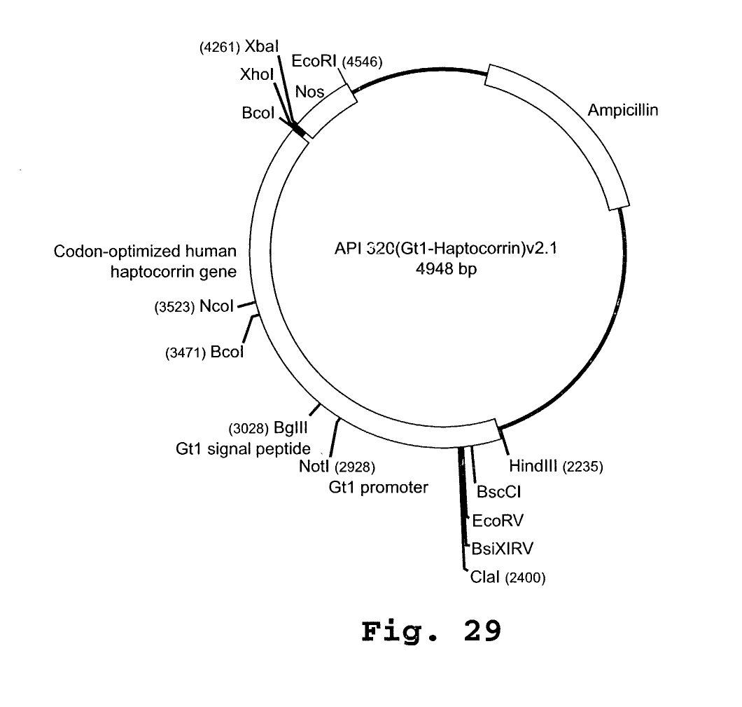

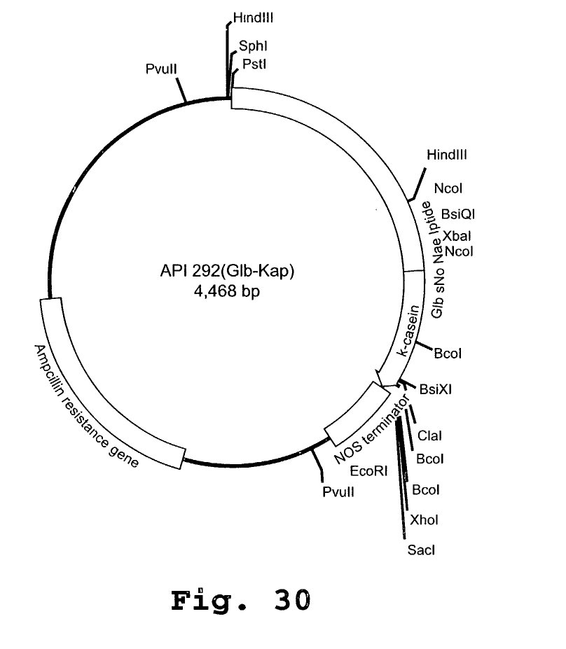

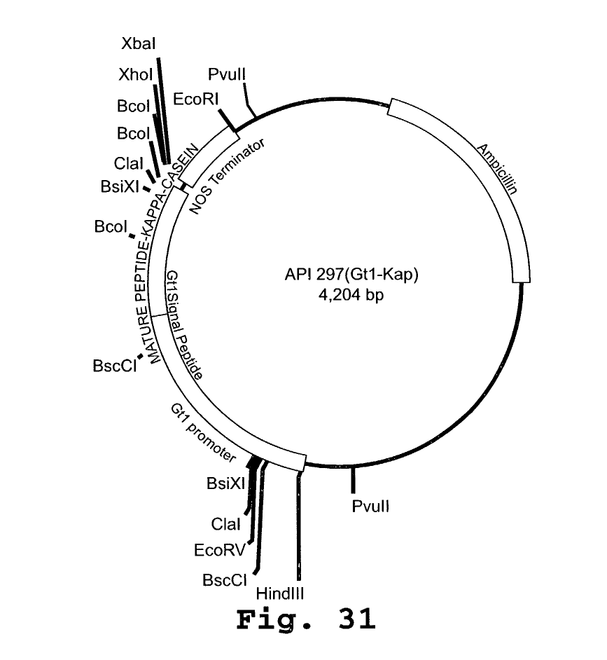

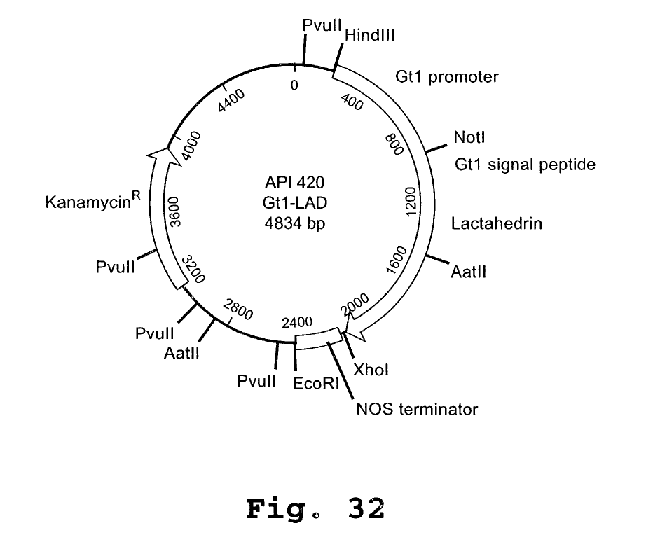

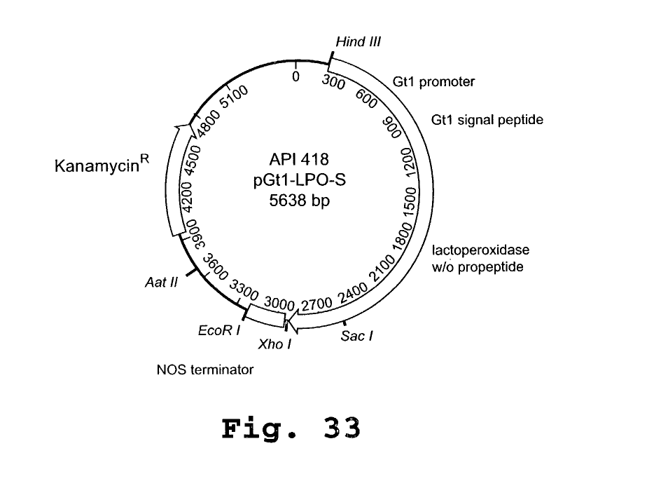

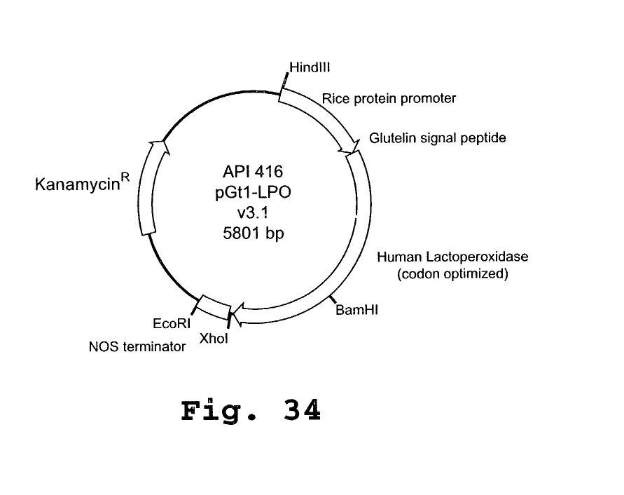

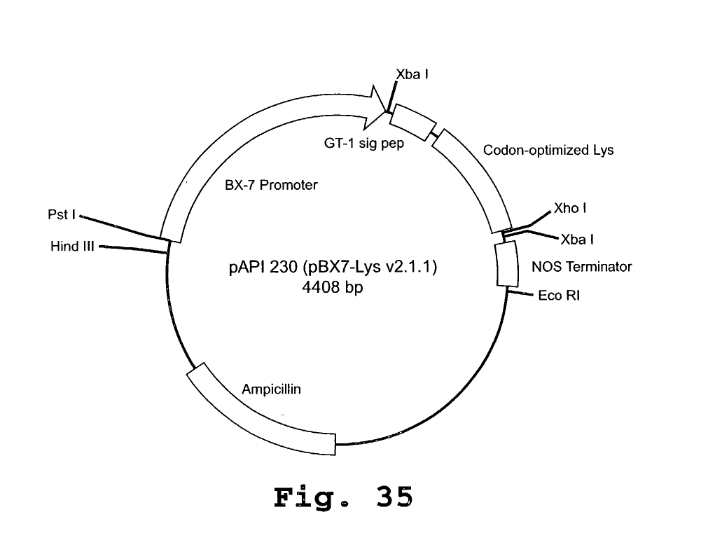

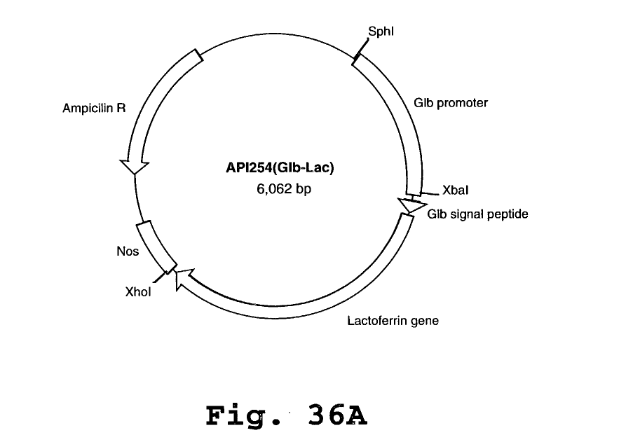

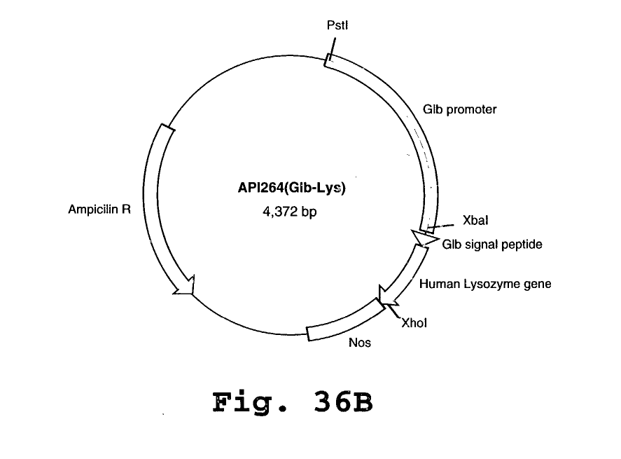

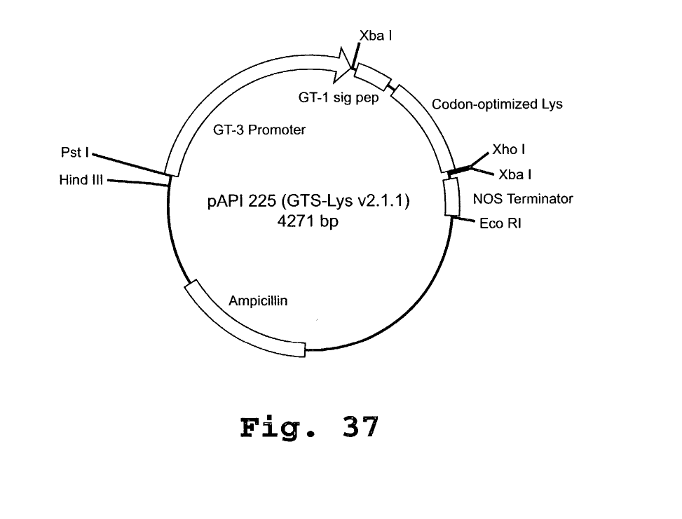

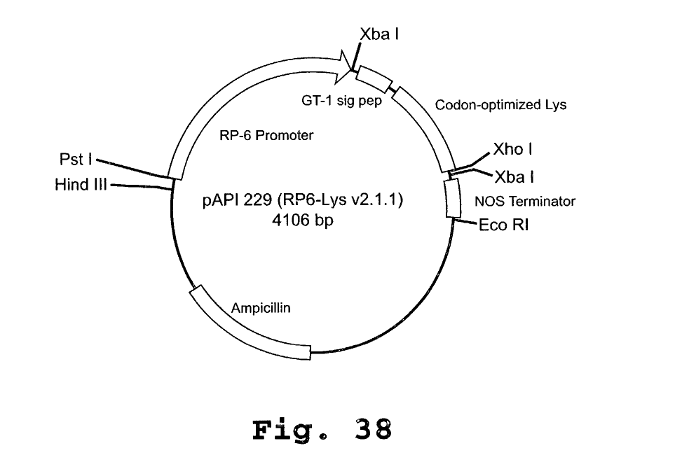

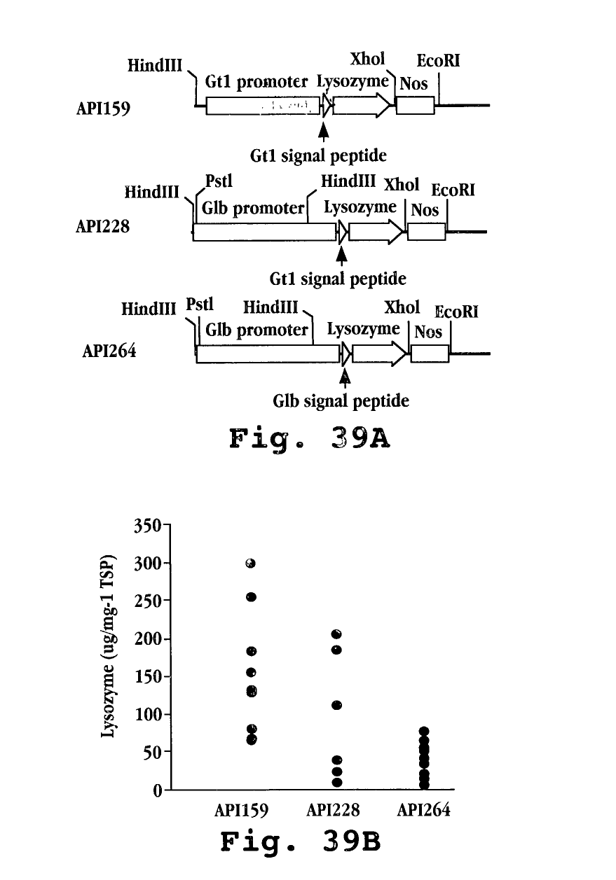

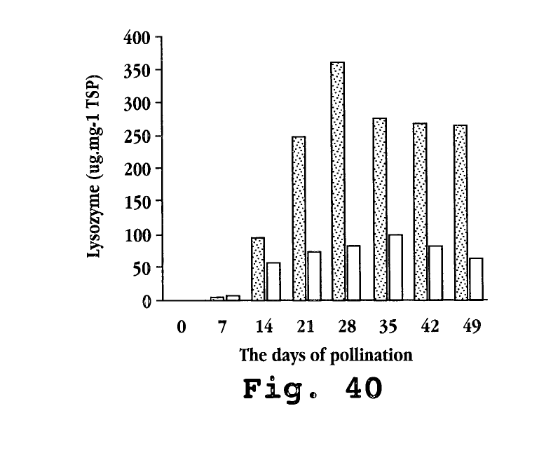

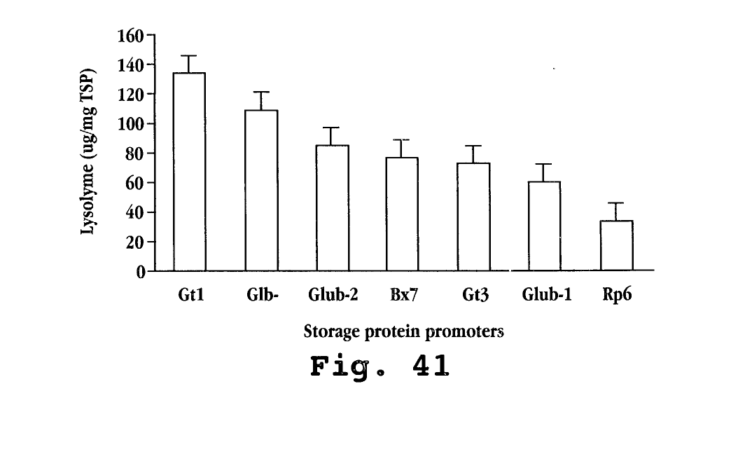

In in vitro digestion experiments with pepsin and pancreatin, the native and recombinant human lysozyme displayed very similar resistance to pepsin and pancreatin digestion (FIG. 11). Under these conditions, human albumin was degraded as demonstrated by SDS-PAGE (data not shown).

(iv). Biochemical Characterization of Lysozyme

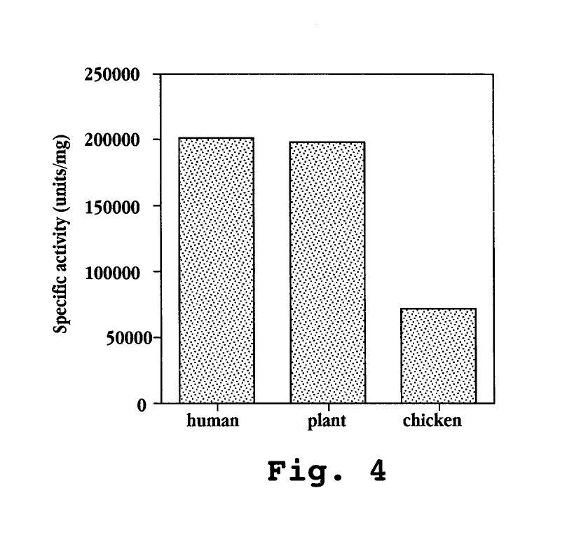

After recombinant human lysozyme was purified to near homogeneity, several biochemical characterizations were carried out to compare human milk lysozyme with recombinant human milk lysozyme derived from rice cells. The results summarized in Table 3 show that by SDS-PAGE, native human milk lysozyme and recombinant lysozyme migrated to the same position (FIG. 4).

Nucleotides encoding the rice Ramy3D signal peptide were attached to the human lysozyme gene in the expression vector pAPI156. Determination of the N-terminal amino acid sequence of the purified recombinant human lysozyme revealed an N-terminal sequence identical with that of native human lysozyme, as detailed above. Rice cells thus cleave the correct peptide bond to remove the RAmy3D signal peptide, when it is attached in the human lysozyme precursor.

The overall charge of recombinant and native human lysozyme were compared by isoelectric-focusing (IEF) gel electrophoresis and pi values determined. Since lysozyme is a basic protein with a calculated pi of 10.20, the pi comparison studies were carried out by reverse IEF gel electrophoresis. Recombinant and native human lysozyme displayed identical pi, indicating the same overall charge (data not shown).

Recombinant human lysozyme derived from transgenic rice had a specific activity similar to the native lysozyme (200,000 units/mg (Sigma, MO), whereas, lysozyme from chicken egg whites had the expected 3-4 fold lower specific activity (Sigma, MO).

Table 3. Comparison of Biochemical Characteristics of Human Milk Lysozyme and Recombinant Lysozyme

| | | | | Specific | |
|---|---|---|---|---|---|
| Lysozyme | N-terminal | Size | Glycosyla- | activity | |
| source | sequence | (kDa) | tion | (units/mg) | pl |
| Human | KVFER C ELART | 14 | No | 201,526 | 10.2 |
| milk | | | | | |
| rice | KVFER(−)*ELART | 14 | No | 198,000 | 10.2 |

The results described above demonstrate the ability to use rice calli or cell suspension cultures as a production system to express human lysozyme from milk. Over 60 individual transformants were screened by immunoblot, enzymatic activity assay and ELISA. Yields of recombinant human milk lysozyme reached 4% of soluble cell proteins. Although the mechanism is not part of the invention, the high expression level may be explained by the utilization of the strong RAmy3D promoter (Huang et al., 1993) and the codon-optimized gene.

When the gene construct for the human alpha-1-antitrypsin (AAT) precursor containing the rice RAmy3D signal peptide was expressed in rice cells, the precursor AAT was processed and secreted and AAT was detected only in the media (Terashima et al., 1999a; Terashima et al., 1999b). In contrast, the majority of recombinant human lysozyme produced by rice calli according to the methods described above was not detected in the culture media, but remained associated with the calli.

The plant derived human milk lysozyme obtained by the methods of the present invention was identical to endogenous human lysozyme in electrophoretic mobility, molecular weight, overall surface charges and specific bactericidal activity.

### EXAMPLE 4

### Characterization of Recombinant Human Lactoferrin (rLF) Produced by Transgenic Rice Plants

A. Southern Blot Analysis.

About three grams of young leaf were collected and ground with liquid nitrogen into a very fine powder. The DNA was isolated according to the procedure as described in Dellaporta SL et al., 1983, and purified by phenol-chloroform extraction. Approximately 5 μg of ECoRI and HindIII digested DNA from each line was used to make blot for Southern analysis. The ECL™ direct nucleic acid labeling and detection system (Amersham, USA) was used for analysis.

The lactoferrin gene copy number was estimated to be from 2 to 10 as determined by Southern blot hybridization using EcoRI and HindIII digested genomic DNA. The API164-12-1 (R₀) transgenic plant line was subjected to Southern analysis together with ten Western blot positive, field grown R₁ lines. A typical Southern blot shows that there are at least three fragments above the original plasmid derived plant transformation unit (3156 bp). All the LF inserts appear to be inherited from the original Ro transgenic plant event (lane 2) to R1

(lane 3-11) generation.

B. Protein Isolation and Western Blot.

Rice seeds were ground with 1 ml of 0.35 N NaCl in phosphate buffer saline (PBS), pH 7.4 using an ice-cold mortar and pestle and the resulting homogenate was centrifuged at 15000 rpm for 15 min at 4° C. The supernatant was used as a protein extract and about 1/25 or 1/50 of the salt soluble content was loaded onto a 10% pre cast gel (Novex, USA) and electrophoresis was carried according to the manufacturer's instructions. For total protein detection, the polyacyramide gel was stained with 0.1% Coomassie brilliant blue R-250 (dissolved in 45% methanol and 10% glacial acetic acid) for at least three hours and destained with 45% methanol and 10% glacial acetic acid until the desired background was achieved.

For Western blot analysis, SDS-PAGE gels were electroblotted onto a 0.45 μm nitrocellulose membrane with a Mini-Trans-Blot Electrophoretic Transfer Cell System (Bio-Rad, USA) and subsequently subjected to immuno-blotting analysis. The blot was blocked with 5% non-fat dry milk in PBS for at least two hours followed by three washes with PBS for 10 minutes each. The primary rabbit polyclonal antibody against hLF (Daka A/S, Denmark) was diluted at 1:2500 in the blocking buffer and the blot was incubated in the solution for one hour. The blot was washed with PBS for three times with 10 minutes each. The secondary goat anti-rabbit IgG (H+L)-alkaline phosphatase conjugated (Bio-Rad, USA) was diluted in the blocking buffer at 1:5000 ratio. The membrane was incubated in the secondary antibody solution for one hour and followed by three washes with PBS. Color development was initiated by adding the substrate system BCIP-NBT (Sigma, USA) and the process was stopped by rinsing the blot with H₂O once the desirable intensity of the bands was achieved.

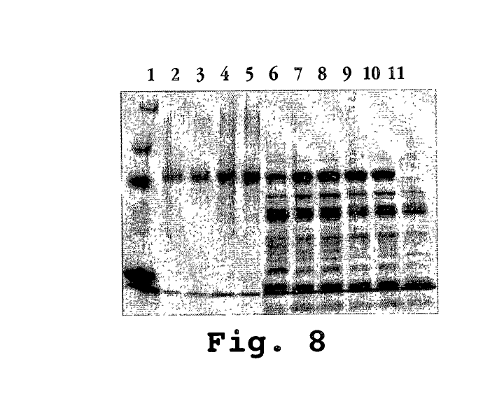

Fifteen R₀ plants were grown to maturity, seeds were harvested from 11 fertile plants and individual seeds analyzed by Western blot to detect the expression of rLF. Coomassie blue staining was carried out to compare the mobility of rLF with native human lactoferrin (hLF) (FIG. 8), with 40 μg of total protein loaded onto each lane, along with 40 ng of native purified hLF per lane as the positive control.

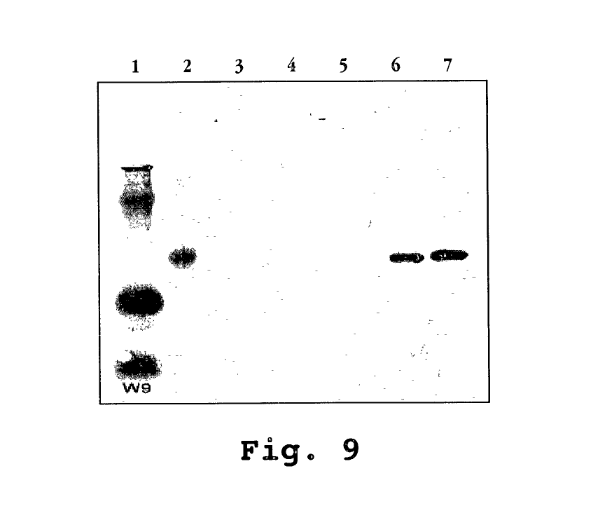

Estimation of total rLF by ELISA indicated that from 93 μg to 130 μg rLF was expressed in transformed rice seeds. A typical Western blot analysis (FIG. 9) illustrates that both rLF and native hLF migrate at approximately the same rate with the molecular weight about 80 kDa, consistent with that determined by other researchers (Wang et al., 1984).

C. Protein Purification.

Rice seeds from R₂ homozygous generation were dehusked and milled to flour conventionally. Recombinant lactoferrin was extracted by mixing the rice flour with 0.35 N NaCl in PBS at 100 g/l at room temperature for two hours. The resulting mixture was centrifuged at 15,000 rpm for one hour at 4° C. The collected supernatant was subjected to the following steps of filtration before loading onto a Sepharose column. First, the supernatant was run through a few layers of cheesecloth. Then the filtrate was passed sequentially through an 8 μm paper, 1 μm paper and a 0.25 μm nitrocellulose membrane. The clear protein solution was loaded onto a ConA Sepharose column (Pharmacia, XK 26) which had been equilibrated with 0.5 N NaCl in 20 mM Tris, pH 7.4 (binding buffer) at a flow rate at 4 ml/min. After the loading was complete, the column was washed with binding buffer until the baseline at A₂₈₀ nm was achieved. Lactoferrin was eluted with 0.1N mannoside in the binding buffer. Fractions containing lactoferrin were pooled and loaded onto a second column SP-Sepharose (Bio-Rad, USA) which has been equilibrated with 0.4 N NaCl in 50 mM sodium phosphate, pH 8.0 (binding buffer) at the flow rate 4 ml/min. Then the column was washed with the binding buffer until the baseline at A₂₈₀ nm was obtained. Lactoferrin was eluted by 1 N NaCl in 50 mM sodium phosphate, pH 8.0 and the fractions containing LF were pooled and dialyzed against PBS. Finally the purity of LF was assessed by SDS-PAGE and stored at −80° C.

D. Enzyme Linked Immunosorbant Assay (ELISA).

ELISA was conducted using seed extracts, isolated as described above, with total protein assayed using the Bradford method (Bradford, 1976). The ELISA was based on a typical sandwich format generally known in the art. Briefly, 96 well plates were coated with rabbit anti-human lactoferrin antibody (Daka A/S, Denmark), then rLF and control samples were added to individual wells of the plate and incubated for 1 hour at 35° C. Rabbit anti-human lactoferrin horseradish peroxidase conjugate (Biodesign, USA) was then added to each well and incubated for 1 hour at 35° C., followed by addition of the tetramethylbenzidine substrate (Sigma, USA) and incubation for 3 minutes at room temperature. The reaction was stopped by adding 1 N H₂SO₄ to each well. The plates were read at dual wavelengths of 450 and 650 nm in a Microplate Reader (Bio-Rad, model 3550) and the data was processed by using Microplate Manager III (Bio-Rad). The results of an analysis of 10 homozygous selected lines showed that from 93 μg to 130 μg rLF was expressed per seed.

E. Selection of Plants for Advance Generations.

At least 20-40 seeds from 11 independent lines were analyzed. Individual R₁ seeds were cut into half and endospermic halves were subjected to analysis by Western blot with the positive corresponding embryonic halves germinated on 3% sucrose medium with 0.7% agar. The seedlings were transplanted to the field for R₁ generation. Out of 11 individual lines, 3 lines were expressed. A total of 38 plants were grown in the field derived from the 3 expressed mother lines. Based on the agronomic character (Table 4) of those 38 plants, 28 plants were selected.

It was observed that all the Western positive R₁ seeds were opaque to pinkish in color in comparison to control seeds, so this criteria was applied in screening the R₂ seeds. Mature R₂ seeds were harvested at maturity and dehusked. The pinkish R₂ seeds were confirmed by Western dot blot and ELISA as expressing rLF (data not presented). Finally 10 homozygous R₂ lines were selected and grown in the field in order to advance the generation.

Table 4. Comparison of Phenotypic Characteristics of Native TP-309 and Transformed TP-309 Rice Seeds

| | | | 1000 seed | |
|---|---|---|---|---|
| | Effective | Blank | weight | μg of |
| Source | tiller | grain (%) | (g) | rLF/seed |
| TP-309 | 43 | 5.0 | 25 | |
| Homozygous | 42 | 19.7 | 20.2 | 125 |
| transgenic lines | | | | |

During R₂ and R₃ generation the percentage of blank seeds was higher in homozygous transgenic lines than in the non-transgenic control. This affected the 1000 seed weight. However, in the R₄ generation no significant differences in phenotypic character were observed in homozygous transgenic lines when compared to non-transformed TP309 (Table 4).

F. Attributes Of Recombinant Human Lactoferrin Produced in Rice

Physical characterization of the rLF showed there was no significant difference between the rLF and a commercially available purified form of hLF based on N-terminal amino acid sequencing, and physical characteristics of rLF such as molecular weight as determined by MALDI-MS, HPLC profile of which showed a comparable peptide map, pH dependent iron release and bacteriostatic activity, using the analyses described below.

(i). N-Terminal Amino Acid Sequencing.

Purified rLF from rice seeds was resolved by 10% SDS-PAGE, followed by electroblotting to PVDF membrane (Bio-Rad, USA). The target band was identified by staining the membrane with 0.1% Coomassie brilliant blue R-250 in 40% methanol and 1% glacial acetic acid for 1 minute. The stained PVDF membrane was immediately destained in 50% methanol until the band is clearly visible. The blot was thoroughly washed with ddH₂O and air dried. Finally this sample was sent to the Protein Structure Laboratory in University of California at Davis (CA, USA) for sequencing analysis.

(ii). Detection of Glycosylation and Determination of Sugar Content

Glycosylation of the recombinant human lactoferrin produced in rice was analyzed by an immunoblot kit for glycoprotein detection (Bio-Rad, USA) per instructions from the manufacturer. An increase of molecular weight of lactoferrin due to carbohydrate content was determined by Matrix Assisted Laser Desorption Ionization-Mass spectrometry (MALDI-MS) (PE Applied Biosystems, Voyager System).

Recombinant lactoferrin produced in rice is glycosylated as evident from the binding to Con A resin, the positive staining by glycoprotein detection kit as well as the larger detected mass as compared to the calculated mass (76.2 kDa) based on the peptide backbone. MALDI-MS showed that seed derived recombinant lactoferrin has molecular weight of 78.5 kD while human milk lactoferrin is 80.6 kDa (Table 5). The difference could be due to the lesser degree of glycosylation in the rice seed-derived lactoferrin.

(iii). Determination of Isoelectric Point of Lactoferrin.

Reverse isoelectric focusing (IEF) gel electrophoresis was carried out with a precast Novex IEF gel, pH 3-10 according to the manufacturer instruction. About 30 μg of purified rLF was loaded and the running condition was 100 V for 50 minutes and 200 V for 20 minutes. The gel was then fixed in 136 mM sulphosalicylic acid and 11.5% TCA for 30 minutes, stained in 0.1% Coomassie brilliant blue R-250, 40% ethanol, 10% glacial acetic acid for 30 minutes and destained in a solution containing 25% ethanol and 8% acetic acid. (iv). Comparison of Physical Characteristics of rLF with Native hLF.

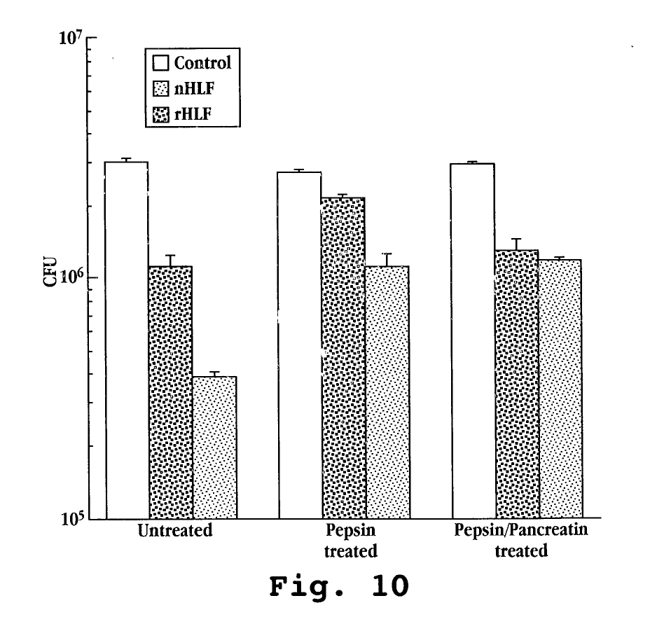

The HPLC profile of native and rLF showed a comparable peptide map. This confirmed that LF from the two sources have an identical amino acid sequence (data not presented). Additional comparisons confirm that human lactoferrin produced in transgenic rice closely resembles native human lactoferrin, as evidenced by (1) the N-terminal sequence of purified rLF from homozygous R₂ seeds and hLF (Dakao A/S, Denmark), which were shown to be identical (Table 5); (2) the isoelectric point (pl) of native and rice seed derived LF which is the same, indicating that they have similar surface charges (Table 5); (3) the pH dependent iron release of rLF which was shown to be closely related to that of native hLF (FIG. 10); and (4) the bacteriostatic activity of rHLf which was shown to be similar to that of native human lactoferrin (nHLf) on enteropathogenic E. coli (EPEC; FIG. 11) and confirmed the presence of active recombinant LF in extracts derived from transformed rice seeds.

Table 5. Physical Characterization Data for Human (hLF) and Rice Seed Derived Recombinant Lactoferrin (rLF)

| | | | | | Sugar |
|---|---|---|---|---|---|
| LF | Size | | | Glycos- | content |
| source | (kDa) | N-terminal sequence | pl | ylated | (%) |
| hLF | 80.6 | GlyArgArgArgArgSerValGln | 8.2 | YES | 5.5 |
| | | TrpCysAla | | | |
| rLF | 78.5 | GlyArgArgArgArgSerValGln | 8.2 | YES | 2.9 |
| | | Trp( )Ala | | | |

(v.) Iron Content and Nutrient Value Determination of Rice Seeds

The iron content of R₂ homozygous seeds was determined. Two grams of dry mature seeds from each transformed and non transformed line were weighed and wet-ashed with HNO₃ and H₂O₂ solution at 110° C. (Goto et al., 1999). The ash was dissolved in 1 N HCl solution. The iron content was then measured by absorbance of Fe-O-phenanthrolin at 510 nm, using a Sigma kit (Sigma, USA) per instructions of manufacturer.

The different values of nutrient facts of homozygous transgenic seeds and non transgenic seeds were measured by standard procedure at A & L Western Agricultural Laboratories (Modesto, Calif., USA).

The different values of nutrient facts of homozygous transgenic seeds and non transgenic seeds were measured by standard procedure at A & L Western Agricultural Laboratories (Modesto, Calif., USA).

A comparative analysis of transgenic lactoferrin-expressing rice seeds with non transformed native Teipei-309 showed that there is no significant difference between transformed and non transformed seeds in nutrient value with the exception that the concentration of iron is 50% greater (Table 6). The increased level of iron may be the reason for the opaqueness and pink coloration of the rLF expressing transgenic rice seeds.

There was no difference noticed during the seed germination of transgenic seeds, the phenotype of R₂ R₃ and R₄ plants was vigorous and the seed yield was similar to that of non-transgenic Teipei-309 plants (data not shown).

Table 6. Comparison of Nutrition Value (in mg) Per 100 Gram of Non Transformed and Transformed Rice Seeds

| Source | Carbohydrate | Protein | Fat | Ca | K | Na | Fe | Water | Calories |
|---|---|---|---|---|---|---|---|---|---|
| TP-309 | 76.0 | 8.7 | 2.4 | 9 | 370 | <10 | 0.8 | 11.3 | 369 |
| Homozygous | 75.7 | 8.7 | 2.2 | 8 | 330 | | 1.2 | 11.8 | 367 |
| transformed | | | | | | | | | |
| lines | | | | | | | | | |

(vi). Tissue Specificity and Stability of rLF

An endosperm specific rice glutelin promoter was used to express recombinant lactoferrin in maturing or matured seeds. To confirm the tissue specificity of the expressed lactoferrin, protein was extracted from root, shoot, leaf beside mature seed and subjected to Western blot and the results indicated that there was no detectable expression of rLF except in the seed/endosperm (results not shown). Furthermore, the presence of rLF in 5 day old germinated seeds showed the stability of stored rLF within the plant cell during germination.

(vii). Iron Saturation And pH Dependent Iron Release

Lactoferrin was incubated with 2M excess ferric iron (FeCl₃:NTA=1:4) and sodium bicarbonate (Fe:HCO³⁻=1:1) for 2 h at room temperature. Excess free iron was removed by using a PD-10 desalting column (Pharmacia, USA) and the iron saturation level was determined by the A₂₈₀/A₄₅₆ ratio. Both native hLF and rLF were completely saturated by iron. Holo hLF was incubated in buffers with a pH between 2 and 7.4, at room temperature for 24 h. Free iron released from hLF was removed and the iron saturation level was determined by A₂₈₀/A₄₅₆ ratio.

The results showed that iron release was similar for both hLF and rLF. Iron release began around pH 4 and was completed around pH 2 (FIG. 10). The iron binding was reversible since iron-desaturated rLF was re-saturated by raising the pH to 7 (data not shown). The similarity in pH dependent iron release of rLF to that of the hLF standard demonstrated that rLF is able to adapt the appropriate tertiary structure for proper iron binding and release (Salmon, Legrand et al. 1997).

(viii). Antimicrobial Activity: Effect Of In vitro Digestion

Lactoferrin is known to inhibit the growth of a variety of bacterial species based on its iron chelation and direct bactericidal properties. The anti-microbial effect of rLF extracted from rice seeds was tested following treatment using an in vitro digestion model with an enzymatic system containing pepsin (an enzyme active in stomach) and pancreatin (an enzyme active in deodenum).

LF proteins were dissolved in PBS at 1 mg/ml, and either left untreated, pepsin treated (0.08 mg/ml at 37° C. for 30 min), or pepsin/pancreatin treated (0.016 mg/ml at 37° C. for 30 min). LF proteins were sterilized by passing through a membrane filter with a pore size of 0.2 μm [Rudloff, 1992]. The filter sterilized LF (0.5μg/ml) was incubated with 10⁴ colony forming unit (CFU) enteropathogenic E. coli (EPEC)/μl in 100 μl sterile synthetic broth (1.7%: AOAC) containing 0.1% dextrose and 0.4 ppm ferrous sulfate at 37° C. for 12 h and colony forming units (CFU) were determined.

Starting with an enteropathogenic E. coli (EPEC) concentration of 10⁴ CFU (colony forming units), the untreated samples of rLF reached up to 10^{6.5} CFU after 12 h of incubation at 37° C. in comparison to hLF, which produced up to 10⁶ CFU. An in vitro digestion model using an enzymatic system containing pepsin (enzyme active in stomach) and pancreatin (enzyme active in deodenum) with moderate shaking to imitate the transit of protein through infant gut [Rudloff, 1992] was used. rLf and nHLf were treated with active pepsin and pancreatic enzymes and exposed to 10⁴ CFU EPEC cells for 12 h at 37° C. (FIG. 11). Both the native human lactoferrin standard (nHLf) and the recombinant rice-derived lactoferrin (rLf) remained active in inhibiting growth of enteropathogenic E. coli, indicating that both nHLf and rHLf are resistant to protease digestion.

### EXAMPLE 5

### Resistance of the Recombinant Lysozyme and Lactoferrin to Intestinal Digestion In vivo

The established protective actions of lysozyme and lactoferrin require that they survive in a biologically active form following passage through the stomach and into the small intestine and both human lysozyme and lactoferrin are known to possess sufficient protection against denaturation and hydrolysis to be efficacious in humans. The pH gradients and the digestive enzymes in chickens and humans are similar suggesting that the molecules should survive passage through the chicken's digestive tract. In order to evaluate the resistance of recombinant rice-derived lysozyme and lactoferrin to the digestive process of humans or chickens, the survival of lysozyme and lactoferrin at 2 ages: 3 days of age and 21 days of age was evaluated. At 3 days of age, the digestive tract of chicks is immature and levels of digestive enzymes are low. At 21 days, the rate of digestive enzyme production is at adult levels and digestibility of proteins is maximal; providing a maximal challenge to the survival of the target molecules.

At 21 days of age, one chick per pen is killed and the contents of their intestines removed. IN carrying out the analysis, segments of approximately 1.5 cm in length are flushed with saline and fixed in 10% buffered formalin (pH 7.0), embedded with paraffin, sectioned (5 mm), stained with hematoxylin-eosin, and mounted. This procedure is performed by a commercial laboratory (California Veterinary Services, West Sacramento Calif.). The histological sections are evaluated for: thickness of the lamina propria; villus height—from the base of the lamina propria to the apex of the villus; crypt depth between adjacent villi. Morphometric data is collected on 10 different villi per animal on each of the two different serial sections. Measurements are made and analyzed by computer-aided light microscope analysis at magnifications between 10 to 1000× using Image-Pro-Plus analysis software for the PC.

Separate studies may be carried out to determine the survivability of lysozymes and lactoferrin in the digestive tract of chickens.

In carrying out the study, on the day of the test, food is removed for 4 hours to insure that a 20 g aliquot of the experimental diets are consumed with 10 minutes. At 15, 20, 40 and 60 minutes after consumption of experimental diets, 4 chicks per treatment are killed. The gastrointestinal tract is removed and divided into 6 sections: proventriculus, gizzard, duodenum, jejunum, ileum, and hindgut. Each section is flushed with 1 volume of physiological saline and the contents collected into sterile plastic tubes.

Following removal of solids by centrifugation, soluble proteins can be tested for activity. In case of lysozyme, the test is a measurement of hydrolysis of Micrococcus lysodeiciticus (Sigma Chemical Company) using chicken lysozyme as a standard. In the case of lactoferrin, the material is tested using published protocols for determining lactoferrin binding to CACO-2 cells. Human lactoferrin (Sigma Chemical Company) is used as a standard. Chromium marker concentration can be determined by flame atomic absorption spectrophotometry, with concentrations expressed as μg/μg of chromium.

### EXAMPLE 6

### Effect of Lysozyme Supplemented Feed on the Feed Utilization and Growth of Chickens

Various feed samples were prepared to test the effect of transgenic rice-derived rLys, supplemented animal feed on feed utilization and animal growth (Table 7).

TABLE 7
Composition of Feed Samples

| Diet # | Type | Components |
|---|---|---|
| 1 | negative | A standard corn-based diet containing no antibiotic |
| | control | supplements |
| 2 | negative | A corn-based diet containing no antibiotics, but sup- |
| | control | plemented with 15% non-transgenic control rice. |
| 3 | positive | A corn-based diet containing a standard sub-thera- |
| | control | peutic level of antibiotics (Bacitracin + Roxarsone) |
| 4 | Test diet | A non-antibiotic diet, substituted with 10% trans- |
| | | genic (TG) rice containing rLys to give a final |
| | | lysozyme level of 0.03% |
| 5 | Test diet | A non-antibiotic diet, substituted with 10% trans- |
| | | genic rice containing rLys and 5% transgenic rice |
| | | containing rLac to give final lysozyme and lacto- |
| | | ferrin levels of 0.03% and 0.02% respectively |

rLys concentrations are based on 2 g/kg lysozyme in the transgenic rice and each of the experimental diets also contains a non-absorbable marker (chromium) in order to follow passage of the non-absorbed digesta.

The presence of lysozyme in each of the feed compositions was confirmed by Western blot.

Chickens (male Cobb broiler chickens; n=48) were individually housed and fed the control diet ad libitum prior to being given a test diet at 3 days and 3 weeks of age. The control diet (Diet #1) is a standard reference chicken diet recommended by the National Academy of Science, with the exception that 10% ground rice is used in place of ground corn.

On the day of hatching, two hundred forty chickens (male Cobb broiler chickens) were assigned to each of the 5 treatment groups with 8 pens per treatment and 5 chicks per pen. Beginning on the first day post-hatch, chickens received experimental diets and water ad libitum. Chickens were weighed and feed intake recorded on days 1, 5. 10, 15, 20, 25, 30 and 35.

The cages used for the study had previously been used for 3 production cycles of chickens. They were not cleaned or disinfected between cycles of chicken production, permitting the build up of feces, dust, and dander. The rate of air-turnover in the room housing the chickens was reduced to levels similar to that seen in a commercial broiler production barn. These sanitation practices were intended to mimic commercial conditions where antibiotics are proven to provide increased growth and feed conversion efficiency.

The results demonstrate that feeding growing chickens a diet containing recombinant lysozyme results in a feed conversion efficiency that is better than sub-therapeutic antibiotics. As shown in Table 8, the growth rate of chickens as measured in grams of weight gained per chick per day is comparable, even at the level of just 0.2% added transgenic grain, to that seen with antibiotic or chicken lysozyme controls. Similarly, growth as a factor of feed efficiency, or grams of weight gained per gram of feed, was on the order of that seen in antibiotic and chicken lysozyme controls.

TABLE 8
Weight and Feed Intake and Feed Efficiency of Chickens
Fed Various Diets

| | | Gain | Feed | Feed |
|---|---|---|---|---|
| | Diet | (g/chick/day) | Consumed | Efficiency |
| Diet # | composition | Day 0-21 | Day 0-21 | Day 0-21 |
| 1 | Standard Corn-based | 33.82 | 51.08 | 0.732 |
| | Diet | | | |
| 2 | Standard Diet with 15% | 38.03 | 52.18 | 0.72 |
| | rice | | | |
| 3 | Standard Diet + antibi- | 34.43 | 50.48 | 0.754 |
| | otics | | | |
| 4 | Standard Diet + 10% TG | 33.53 | 48.5 | 0.766 |
| | rice containing rLys | | | |
| 5 | Standard Diet + 10% TG | 34.03 | 49.02 | 0.766 |
| | rice containing rLys and | | | |
| | 5% TG rice containing | | | |
| | rLac | | | |

### EXAMPLE 7

### Effect of Supplemented Feed on Intestinal tract of Chickens

Two studies conducted to demonstrate that rice that has been genetically produced to express human lactoferrin (LF) or lysozyme (Lz) protects the intestinal tract similar to sub-therapeutic antibiotics.

A. Expression of Lactoferrin or Lysozyme in Rice

Two transgenic rice strains were produced to express either lactoferrin or lysozyme (Huang et al., 2002). Briefly, rice callus from the rice strain Taipei 309 was transformed with plasmids carrying genes for LF and LZ under the control of rice glutelin 1 gene promoter. Transgenic plants were screened for high level of expression of both recombinant proteins. Selected lines, 159-53 and 164-12 were propagated to produce sufficient amount of rice seed for these experiments. LF and LZ rice expressed 2.5 and 4.0 g/kg of recombinant protein as determined by ELISA. Taipei 309, which is the conventional rice (CONV) that served as the host for transgenic plant production, served as a control. All rice was dehusked to yield brown rice and then ground using a comminuting machine (Fitzpatrick Inc, Chicago, Ill.).

B. Preparation and Management of poultry

One-day old male Cobb broiler chicks (Foster Farms, Delhi, Calif.) were raised in Petersime brooder batteries (Petersime Incubator Co., Gettysburg, Ohio) located in an environmentally controlled room (25 C) with 24 hrs of light. Chicks were provided water and commercial chick starter for ad libitum consumption. The batteries had not been cleaned after their previous use in order to provide a level of sanitation conducive for an antibiotic response. When the chicks were 3 days of age, experimental chicks were selected for uniform body weight from a two-fold larger population and randomly assigned to dietary treatments. Chicks had ad libitum access to both feed and water and were exposed to a 24-hour light cycle. All experiments and procedures were approved by the Campus Animal Care and Use Committee.

C. Diet Formulation

Corn-soy-rice basal diets were formulated to meet or exceed the nutrient needs of young growing broiler chicks suggested by NRC (1994). All experimental diets were formulated to contain the same amount of rice by substituting transgenic rice for CONV rice as shown in Tables 1 and 2. A range of levels of each test rice was chosen for study in order to determine a minimally efficacious level. The 10.0% LZ diet used in study 1 was analyzed to contain 176 mg/kg lysozyme. Following 6 months of storage at room temperature, it contained 152 mg/kg lysozyme, indicating that this protein was stable to storage.

TABLE 9
Composition of Diets from Studies 1 and 2

| | Study 1 | Study 2 | Study 2 |
|---|---|---|---|
| Ingredient, g/kg | Corn-soy-rice | Corn-soy-rice | Corn-soy |
| Corn | 354 | 408 | 551 |
| Soy meal (48.5%) | 320 | 343 | 342 |
| Rice¹ | 200 | 150 | — |
| Poultry Greese | 57.9 | 43.1 | 51.0 |
| Meat with Bone Meal | 40.5 | — | — |
| Feather Meal | — | 21.2 | 21.2 |
| Calcium carbonate | — | 7.6 | 8.0 |
| Tricalcium phosphate | — | 19.1 | 18.7 |
| Calcium phosphate | 18.5 | — | — |
| Vitamin-mineral premix² | 1.00 | 1.00 | 1.00 |
| Choline | 0.70 | 0.84 | 0.91 |
| Sodium chloride | 4.03 | 2.21 | 2.04 |
| D-L Methionine | 2.78 | 2.03 | 1.97 |
| L-Lysine | — | — | 0.14 |
| ME, kcal/kg | 3,199 | 3,201 | 3,201 |
| Crude protein, % | 22.15 | 22.29 | 22.29 |
| Crude fat, % | 8.07 | 6.69 | 7.85 |
| Available Lys, % | 1.20 | 1.15 | 1.15 |
| Available Met + Cys, % | 0.95 | 0.88 | 0.88 |

¹Three types of rice (conventional rice, or rice expressing lactoferrin or lysozyme) at variable levels depending upon the treatment.
²Vitamins and minerals were provided in the form and level described in NRC (1994) Standard Reference Diet for Chicks.
Corn-soy diet for study 2 only.

TABLE 10
Types of Rice in Dietary Treatments Used in Studies 1 and 2

| | % of the Diet | |
|---|---|---|
| Dietary Treatment | Conventional Rice | Transgenic Rice |
| Study 1 | | |
| CONV | 20 | 0 |
| 0.1% LF | 19.9 | 0.1 |
| 1.0% LF | 19.0 | 1.0 |
| 5.0% LF | 15.0 | 5.0 |
| Human lactoferrin¹ | 20 | 0 |
| 0.2% LZ | 19.8 | 0.2 |
| 10.0% LZ | 10.0 | 10.0 |
| 0.1% LF + 0.2% LZ | 19.7 | 0.3 |
| 5.0% LF + 10% LZ | 5.0 | 15.0 |
| Antibiotics² | 20 | 0 |
| Study 2 | | |
| Corn-soy | 0 | 0 |
| CONV | 15 | 0 |
| 10% LZ | 5.0 | 10.0 |
| 5.0% LF + 10% LZ | 0 | 15.0 |
| Antibiotics | 15 | 0 |

¹Incorporated at 0.2 g/kg diet.
²Antibiotic treatments contained roxarsone (3-nitro-4-hydroxypherylarsonic acid; Pfzier, Inc. New York, NY) and bactiracin methylene disalicylate (Schering-Plough Animal Health, Omaha, NE 68127) at 0.25 g/kg diet and 0.5 g/kg diet, respectively.

D. Study 1

Study 1 compared 10 corn-soy diets containing 20% of various LF, LZ or conventional rice (CONV). 300 3-day old chicks were randomly assigned to one of 10 dietary treatments as shown in Table 2. Each dietary treatment consisted of six replicates, with five chicks per replicate. Chick and feeder weights were determined on day 1 and 17.

Intestinal samples were taken on the last day of study 1 and 2. Sections (2.5 cm) from one chick per replicate were obtained from the duodenum at the apex of the pancreas, the jejunum at a position midway between Meckel's diverticulum and the entrance of the bile ducts, the ileum at a position midway between Meckel's diverticulum and the ileum-cecal junction, and the ceca at a point midway along its length (study 2 only). Samples were flushed with saline, fixed in 10% buffered formalin (pH 7.0), embedded with paraffin, thin sectioned and stained with hematoxylin-eosin (IDEXX Veterinary Services, Inc., Sacramento, Calif.). For enumeration of intraepithelial and lamina propria leukocytes sections were fixed in acetone, re-dried, incubated with mouse anti-chicken CD45 monoclonal antibody (Southem Biochemical Associates, Birmingham, Ala.) for 1 hour and then rinsed in PBS.

Sections were incubated with rabbit anti-mouse Ig tagged with peroxidase with 0.5% bovine serum albumin for 1 hour and rinsed. Peroxidase activity was developed by incubating sections with 0.01% H₂O₂ and 3,3′-diamino-benzidine-tetrahydrachloride. The slides were counterstained with hematoxylin-eosin. The number of leukocytes in 10 villi per section and the number of leukocytes in the lamina propria underneath and within these 10 villi were enumerated. Cells with endogenous peroxidase activity (primarily heterophils) were also enumerated as described by Vervelde and Jeurissen (Vervelde, L. and Jeurissen, S. H., 1993). For each intestinal sample, villi height, villi width, crypt depth, lamina propria thickness, number of lamina propria leukocytes, and number of intra-epithelial leukocytes were estimated using Image-Pro-Plus software (Media Cybernetics, Silver Spring, Md.).

Data were analyzed for main effect of diet using the general linear model (Minitab; State College, Pa.). When main effects were significant (P<0.05), differences due to dietary treatment were determined using Tukey's means comparisons. Chicks fed diets containing 0.1% LF, 1% LF, 5% LF, human lactoferrin, 0.2% LZ, 10% LZ, or 0.1% LF +0.2% LZ did not differ from chicks fed CONV in any of the parameters measured. Feed intake and body weight gain were not affected by dietary treatments (P>0.05), and averaged 36.10 g/chick/day and 28.96 g/chick/day, respectively. Chicks fed 5% LF +10% LZ had significantly greater feed conversion compared to chicks fed CONV (Table 3). Chicks fed Antibiotic also tended (P =0.058) to have greater feed conversion compared to those fed CONV.

TABLE 11
Effect of Dietary Treatment on Feed Efficiency (Study 1)

| | Feed Efficiency (g body weight |
|---|---|
| Dietary Treatment | gain/g feed consumed |
| CONV | 0.79 ± 0.1^{a} |
| 5% LF + 10% LZ | 0.84 ± 0.1^{b} |
| Antibiotics | 0.82 ± 0.1^{c} |

Values are means ±SEM. Means in a column not sharing common superscripts are significantly different (P<0.05).

Histological characteristics of the duodenum, jejunum, and ileum are presented in Table 4.

TABLE 12
Effect of Dietary Treatment on Intestine Histology (Study 1)

| | | |
|---|---|---|
| | Intra-epithelial | Lamina propria |
| Lamina propria | leukocytes | leukocytes |
| thickness (μm) | (#/villi) | (#/villi) |

Duodenum

| | | | |
|---|---|---|---|
| CONV | 101^{b} | 4.8 | 34.3 |
| 5% LF + 10% LZ | 82^{a} | 4.0 | 24.5 |
| Antibiotic | 85^{ab} | 4.75 | 25.5 |
| SEM¹ | 3.06 | 0.73 | 3.35 |
| P value | 0.015 | 0.543 | 0.196 |

Jejunum

| | | | |
|---|---|---|---|
| CONV | 101^{b} | 8.0 | 38^{b} |
| 5% LF + 10% LZ | 97^{ab} | 5.0 | 21^{ab} |
| Antibiotic | 84^{a} | 2.5 | 14^{a} |
| SEM¹ | 3.26 | 1.06 | 3.67 |
| P value | 0.011 | 0.061 | 0.008 |

lleum

| | | | |
|---|---|---|---|
| CONV | 105 | 0.38 | 34 |
| 5% LF + 10% LZ | 86 | 0.34 | 17 |
| Antibiotic | 83 | 0.39 | 18 |
| SEM¹ | 6.5 | 0.03 | 3.67 |
| P value | 0.111 | 0.494 | 0.068 |

¹Values are means of 6 observations.

Means in a column within intestinal segment not sharing common subscripts are significantly different (P<0.05).

There were no significant differences in villus height, villus width, or crypt depth due to dietary treatments in any intestinal segment (data not shown). Chicks fed 5% LF+10% LZ had significantly thinner lamina propria in the duodenum compared to those fed CONV (P<0.05). Chicks fed Antibiotic had jejuni with significantly thinner lamina propria and lower counts of lamina propria leukocytes compared to chicks fed CONV (P<0.05). Chicks fed 5% LF+10% LZ or Antibiotics tended (P=0.068) to have lower counts of lamina propria leukocytes in the ileum compared to those fed CONV.

E. Study 2

A second study was designed to confirm the results of study 1 using twice the number of replicates per treatment in order to examine more subtle effects of treatments. Study 2 compared 5 corn-soy diets containing experimental rice combinations totaling 155 rice. 360 3-day old chicks were randomly assigned to one of 5 dietary treatments (Table 2) with 12 replicates per treatment and 6 chicks per replicate (42 chicks per treatment). Chick and feeder weights were determined on day 1 and 19. Chicks fed the corn soy diet, which was devoid of rice, did not differ from chicks fed CONV in any of the parameters measured. There was no significant difference (P>0.05) in body weight gain due to dietary treatments and averaged 37.89 g/chick/day. Chicks fed 5% LF+10% LZ or 10% LZ had significantly lower feed intake compared to those fed CONV (Table 5). Chicks fed either 10% LZ, 5% LF+10% LZ, or Antibiotics had greater feed efficiency compared to those chicks fed CONV (Table 5). As in study 1, there were no differences in body weight gain, food intake, or feed efficiency between chicks fed LF or LZ rice and those fed Antibiotics.

TABLE 13
Effect of Dietary Treatment on Food Intake and
Feed Efficiency (Study 2)

| | | Feed Efficiency |
|---|---|---|
| | | (g body weight |
| Dietary Treatment | Food Intake (g/chick/day) | gain/g feed consumed) |
| CONV | 52.18 ± 1.09^{b} | 0.72 ± 0.01^{a} |
| 10% LZ | 48.05 ± 1.11^{a} | 0.77 ± 0.01^{b} |
| 5% LF + 10% LZ | 49.02 ± 1.23^{a} | 0.77 ± 0.01^{b} |
| Antibiotic | 50.48 ± 1.15^{ab} | 0.75 ± 0.01^{b} |

Values are means ± SEM. Means in a column not sharing common superscripts are significantly different (P < 0.05).

Chicks fed 10% LZ, 5% LF +10% LZ, or Antibiotics had significantly greater villus height in the duodenum compared to chicks fed CONV as shown in Table 6. Chicks fed CS+10% LZ or Antibiotics had significantly thinner lamina propria in the ileum and fewer leukocytes in the ileal lamina propria compared to chicks fed CONV. There were no other significant differences due to diet in villus width, crypt depth, or intra-epithelial leukocytes in any intestinal segment.

TABLE 14
Effect of Dietary Treatment on Intestine Histology (Study 2)

| | Lamina propria | Villus Height | Lamina propria |
|---|---|---|---|
| | thickness (μm) | (μm) | leukocytes (#/villi) |
| Duodenum | | | |
| CONV | 81 | 743^{a} | 24 |
| 5% LF + 10% LZ | 77 | 884^{b} | 21.5 |
| Antiobiotic | 82 | 882^{b} | 23.3 |
| SEM¹ | 2.46 | 18.3 | 2.1 |
| P value | 0.69 | 0.016 | 0.93 |
| Ileum | | | |
| CONV | 99^{b} | 365 | 28.3^{b} |
| 5% LF + 10% LZ | 88^{ab} | 421 | 25.2^{ab} |
| Antiobiotic | 75^{a} | 356 | 18.7^{a} |
| SEM¹ | 3.2 | 12.6 | 1.5 |
| P value | 0.03 | 0.36 | 0.02b |

¹ Values are means of 12 observations.

Means in a column not sharing common superscripts are significantly different (P,0.05). The results described above demonstrate that the combination of 5% LF+10% LZ was more efficacious at improving feed efficiency and histological indices of intestinal health than 10% LZ alone. LF alone was without effect. These results demonstrate the potential of rice expressing lactoferrin and lysozyme to serve as an alternative to antibiotics in broiler diets.

TABLE 15
Brief Description of the Sequences

| | SEQ ID |
|---|---|
| Description | NO |
| Codon optimized lysozyme coding sequence: | 1 |
| AAAGTCTTCGAGCGGTGCGAGCTGGCCCGCACGCTCAAGCGGCTCGGCAT | |
| GGACGGCTACCGGGGCATCAGCCTCGCCAACTGGATGTGCCTCGCCAAGT | |
| GGGAGTCGGGCTACAACACCCGCGCAACCAACTACAACGCCGGCGACCG | |
| CTCCACCGACTACGGCATCTTCCAGATCAACTCCCGCTACTGGTGCAACGA | |
| CGGCAAGACGCCCGGGGCCGTCAACGCCTGCCACCTCTCCTGCTCGGCC | |
| CTGCTGCAAGACAACATCGCCGACGCCGTCGCGTGCGCGAAGCGCGTCGT | |
| CCGCGACCCGCAGGGCATCCGGGCCTGGGTGGCCTGGCGCAACCGCTGC | |
| CAGAACCGGGACGTGCGCCAGTACGTCCAGGGCTGCGGCGTCTGA | |
| Amino acid sequence based on codon optimized | 2 |
| lysozyme coding sequence: | |
| KVFERCELARTLKRLGMDGYRGISLANWMCLAKWESGYNTRATNYNAGDRST | |
| DYGIFQINSRYWCNDGKTPGAVNACHLSCSALLQDNIADAVACAKRVVRDPQG | |
| IRAWVAWRNRCQNRDVRQYVQGCGV | |
| Codon optimized lactoferrin coding sequence: | 3 |
| GGGCGGCGGCGGCGCTCGGTGCAGTGGTGCGCCGTGTCCCAG | |
| CCCGAGGCGACCAAGTGCTTCCAGTGGCAGCGCAACATGCGGAAGGTGC | |
| GCGGCCCGCCGGTCAGCTGCATCAAGCGGGACTCCCCCATCCAATGCATC | |
| CAGGCCATCGCGGAGAACCGCGCCGACGCGGTCACCCTGGACGGCGGGT | |
| TCATCTACGAGGCGGGGCTCGCCCCGTACAAGCTCCGCCCGGTGGCGGC | |
| GGAGGTGTACGGCACCGAGCGCCAGCCGCGCACGCACTACTACGCGGTG | |
| GCCGTCGTCAAGAAGGGCGGGTCCTTCCAGCTCAACGAGCTGCAGGGCCT | |
| GAAGTCGTGCCACACGGGCCTCCGGCGGACGGCGGGCTGGAACGTGCCC | |
| ATCGGCACCCTGCGCCCCTTCCTGAACTGGACCGGCCCGCCGGAGCCGAT | |
| CGAGGCCGCCGTGGCCCGCTTCTTCAGCGCCTCCTGCGTCCCCGGCGCC | |
| GACAAGGGCCAGTTCCCGAACCTCTGCCGGCTCTGCGCCGGGACGGGCG | |
| AGAACAAGTGCGCCTTCTCCTCGCAGGAGCCGTACTTCTCCTACTCGGGC | |
| GCGTTCAAGTGCCTCCGCGACGGGGCCGGCGACGTGGCGTTCATCCGCG | |
| AGTCCACCGTGTTCGAGGACCTCTCCGACGAGGCGGAGCGGGACGAGTAC | |
| GAGCTGCTGTGCCCCGACAACACCCGCAAGCCGGTGGACAAGTTCAAGGA | |
| CTGCCACCTGGCGCGGGTGCCCTCGCACGCGGTCGTCGCCCGCAGCGTC | |
| AACGGCAAGGAGGACGCGATCTGGAACCTCCTCCGCCAGGCCCAGGAGAA | |
| GTTCGGCAAGGACAAGTCCCCCAAGTTCCAGCTCTTCGGGAGCCCCAGCG | |
| GCCAGAAGGACCTCCTCTTCAAGGACTCCGCGATCGGCTTCTCCCGCGTC | |
| CCCCCGCGCATCGACTCCGGCCTGTACCTCGGCTCCGGGTACTTCACCGC | |
| GATCCAGAACCTCCGGAAGAGCGAGGAGGAGGTGGCGGCGCGGCGGGCC | |
| CGCGTCGTGTGGTGCGCCGTGGGCGAGCAGGAGCTGCGGAAGTGCAACC | |
| AGTGGAGCGGCCTGAGCGAGGGGTCGGTGACCTGCTCGTCCGCCAGCAC | |
| CACCGAGGACTGCATCGCGCTCGTCCTCAAGGGGGAGGCCGACGCGATG | |
| AGCCTCGACGGGGGGTACGTCTACACCGCCGGCAAGTGCGGCCTGGTCC | |
| CGGTCCTGGCGGAGAACTACAAGTCGCAGCAGTCCAGCGACCCCGACCCG | |
| AACTGCGTGGACCGCCCCGTCGAGGGCTACCTCGCCGTGGCCGTCGTGC | |
| GCCGGTCCGACACCTCCCTGACGTGGAACAGCGTCAAGGGCAAGAAGAGC | |
| TGCCACACCGCCGTGGACCGCACCGCCGGCTGGAACATCCCGATGGGCC | |
| TCCTCTTCAACCAGACCGGCTCCTGCAAGTTCGACGAGTACTTCTCCCAGT | |
| CCTGCGCCCCCGGCTCGGACCCCCGCTCCAACCTGTGCGCCCTCTGCATC | |
| GGGGACGAGCAGGGCGAGAACAAGTGCGTGCCCAACAGCAACGAGCGGT | |
| ACTACGGCTACACGGGGGCCTTCCGCTGCCTGGCGGAGAACGCCGGGGA | |
| CGTCGCGTTCGTGAAGGACGTGACCGTGCTGCAAAACACGGACGGGAACA | |
| ACAACGAGGCGTGGGCGAAGGACCTCAAGCTCGCCGACTTCGCCCTGCTG | |
| TGCCTCGACGGCAAGCGCAAGCCCGTCACCGAGGCGCGGTCCTGCCACC | |
| TGGCGATGGCCCCCAACCACGCCGTCGTCTCCCGCATGGACAAGGTCGAG | |
| CGCCTCAAGCAGGTGCTCCTGCACCAGCAGGCCAAGTTCGGCCGGAACGG | |
| CAGCGACTGCCCGGACAAGTTCTGCCTGTTCCAGTCGGAGACCAAGAACC | |
| TCCTCTTCAACGACAACACCGAGTGCCTGGCGCGCCTCCACGGCAAGACC | |
| ACCTACGAGAAGTACCTCGGCCCGCAGTACGTCGCCGGCATCACCAACCT | |
| CAAGAAGTGCTCCACCTCCCCCCTCCTGGAGGCGTGCGAGTTCCTCCGCA | |
| AGTGA | |
| Amino acid sequence based on codon optimized | 4 |
| lactoferrin coding sequence: | |
| GRRRRSVQWCAVSQPEATKCFQWQRNMRKVRGPPVSCIKRDSPIQCIQAIAE | |
| NRADAVTLDGGFIYEAGLAPYKLRPVAAEVYGTERQPRTHYYAVAVVKKGGSF | |
| QLNELQGLKSCHTGLRRTAGWNVPIGTLRPFLNWTGPPEPIEAAVARFFSASC | |
| VPGADKGQFPNLCRLCAGTGENKCAFSSQEPYFSYSGAFKCLRDGAGDVAFI | |
| RESTVFEDLSDEAERDEYELLCPDNTRKPVDKFKDCHLARVPSHAVVARSVNG | |
| KEDAIWNLLRQAQEKFGKDKSPKFQLFGSPSGQKDLLFKDSAIGFSRVPPRIDS | |
| GLYLGSGYFTAIQNLRKSEEEVAARRARVVWCAVGEQELRKCNQWSGLSEGS | |
| VTCSSASTTEDCIALVLKGEADAMSLDGGYVYTAGKCGLVPVLAENYKSQQSS | |
| DPDPNCVDRPVEGYLAVAVVRRSDTSLTWNSVKGKKSCHTAVDRTAGWNIPM | |
| GLLFNQTGSCKFDEYFSQSCAPGSDPRSNLCALCIGDEQGENKCVPNSNERY | |
| YGYTGAFRCLAENAGDVAFVKDVTVLQNTDGNNNEAWAKDLKLADFALLCLD | |
| GKRKPVTEARSCHLAMAPNHAVVSRMDKVERLKQVLLHQQAKFGRNGSDCP | |
| DKFCLFQSETKNLLFNDNTECLARLHGKTTYEKYLGPQYVAGITNLKKCSTSPL | |
| LEACEFLRK | |
| MV-Gt1-F1 primer: | 5 |
| 5′ATC GAA GCT TCA TGA GTA ATG TGT GAG CAT TAT GGG ACC ACG 3′ | |
| Xba-Gt1-R1 primer: | 6 |
| 5′CTA GTC TAG ACT CGA GCC ATG GGG CCG GCT | |
| AGG GAG CCA TCG CAC AAG AGG AA 3′ | |

What is claimed is:

1. An improved feed for production animals, comprising
one or more plant-derived feed ingredients, substantially unsupplemented with small-molecule antibiotics, and
as an additive a seed composition containing a flour, extract, or malt obtained from mature monocot seeds and one or more heterologous seed-produced anti-microbial proteins in substantially unpurified form.

2. The feed of claim 1, wherein the one or more seed-produced anti-microbial protein(s) present in the food are milk proteins selected from the consisting of lactoferrin, lysozyme, lactoferricin, lactohedrin, kappa-casein, haptocorrin, lactoperoxidase, alpha-1-antitrypsin, and immunoglobulins.

3. The feed of claim 2, wherein said the seed-produced proteins are lysozyme and lactoferrin.

4. The feed of claim 3, wherein lysozyme is present in an amount between about 0.05 and 0.5 grams protein/kg feed, and lactoferrin, in an amount between 0.2 to 2 grams/protein/kg feed.

5. The feed of claim 1, wherein the one or more seed-produced anti-microbial protein(s) present in the food are acute-phase, non-milk proteins selected from the consisting of C-reactive protein, serum amyloid A; ferritin, haptoglobin, seromucoids, ceruloplasmin, 15-keto-13,14-dihydro-prostaglandin F2 alpha, fibrinogen, alpha-1-acid glycoprotein, mannose binding protein, lipopolysaccharide binding protein, alpha-2 macroglobulin and defensins.

6. The feed of claim 1, wherein the one or more seed-produced anti-microbial protein(s) present in the food are antimicrobial peptides selected from the group consisting of cecropin, magainin, defensins, tachyplesin, parasin I, buforin I, PMAP-23, moronecidin, anoplin, gambicin, and SAMP-29.

7. The feed of claim 1, wherein the one or more seed-produced anti-microbial protein(s) present in the food are antimicrobial proteins selected from the group consisting: CAP37, granulysin, secretory leukocyte protease inhibitor, CAP18, ubiquicidin, bovine antimicrobial protein-1, Ace-AMP1, tachyplesin, big defensin, Ac-AMP2, Ah-AMP1, and CAP18.

8. The feed of claim 1, wherein
(a) the flour is prepared by milling mature monocot seeds,
(b) the extract is prepared by suspending milled flour in a buffered aqueous medium; and
(c) the malt is prepared by (i) steeping barley seeds to a desired water content, (ii) germinating the stepped barley, (iii) drying the germinated seeds, under conditions effective to stop germination, (iv) crushing the dried seeds, (v) optionally, adding crushed seeds from a non-barley monocot plant, (vi) forming a mixture of crushed seeds in water, and (vii) malting the crushed seed mixture until a desired malt is achieved, where at least one of the barley or non-barley monocot seeds is stably transformed to produce such anti-microbial protein(s).

9. The feed of claim 8, wherein step (v) includes adding to the crushed dried barley seeds, mature rice transgenic seeds that produce such anti-microbial protein.

10. In a method for achieving high growth rates in production animals, by feeding animals a feed supplemented with sub-therapeutic levels of one or more small-molecule antibiotics, an improvement comprising
replacing the small-molecule antibiotic(s) in the feed with a seed composition containing a flour, extract, or malt obtained from mature monocot seeds and one or more seed-produced heterologous anti-microbial proteins in substantially unpurified form.

11. The improved method of claim 10, wherein the one or more seed-produced protein(s) present in the feed additive are milk protein(s) selected from the consisting of lactoferrin, lysozyme, lactoferricin, lactohedrin, kappa-casein, haptocorrin, lactoperoxidase, alpha-1-antitrypsin, and immunoglobulins.

12. The improved method of claim 11, wherein the one or more seed-produced proteins are lysozyme and lactoferrin, wherein lysozyme where lysozyme is present in an amount between about 0.05 and 0.5 grams protein/kg feed, and lactoferrin, in an amount between 0.2 to 2 grams/protein/kg feed.

13. The improved method of claim 10, wherein the one or more seed-produced anti-microbial protein(s) present in the food are acute-phase, non-milk proteins selected from the consisting of C-reactive protein, serum amyloid A; ferritin, haptoglobin, seromucoids, ceruloplasmin, 15-keto-13,14-dihydro-prostaglandin F2 alpha, fibrinogen, alpha-1-acid glycoprotein, mannose binding protein, lipopolysaccharide binding protein, alpha-2 macroglobulin and defensins.

14. The improved method of claim 10, wherein the one or more seed-produced anti-microbial protein(s) present in the food are antimicrobial peptides selected from the group consisting of cecropin, magainin, defensins, tachyplesin, parasin l,buforin 1, PMAP-23, moronecidin, anoplin, gambicin, and SAMP-29.

15. The improved method of claim 10, wherein the one or more seed-produced anti-microbial protein(s) present in the food are antimicrobial proteins selected from the group consisting: CAP37, granulysin, secretory leukocyte protease inhibitor, CAP18, ubiquicidin, bovine antimicrobial protein-1, Ace-AMP1, tachyplesin, big defensin, Ac-AMP2, Ah-AMP1, and CAP18.

16. A method of producing a feed for production animals, comprising
(a) obtaining a monocot plant that has been stably transformed with a first chimeric gene having (i) a transcriptional regulatory region from a monocot gene having a seed maturation-specific promoter, (ii) operably linked to said transcriptional regulatory region, a leader DNA sequence encoding a monocot seed-specific transit sequence capable of targeting a linked polypeptide to an endosperm-cell organelle, and (iii) a protein-coding sequence encoding a heterologous anti-microbial protein,
(b) cultivating the transformed plant under seed-maturation conditions,
(c) harvesting mature seeds from the cultivated plant,
(d) extracting from the harvested seeds, a flour, extract, or malt composition containing the human milk protein in substantially unpurified form, and
(e) adding the composition to an animal feed that is substantially free of small-molecule antibiotics.

17. The method of claim 16, wherein the seed-produced protein(s) present in the feed additive are milk protein(s) selected from the group consisting of human or animal lactoferrin, lysozyme, lactoferricin, lactohedrin, kappa-casein, haptocorrin, lactoperoxidase, alpha-1-antitrypsin, and immunoglobulins.

18. The method of claim 17, wherein said the seed-produced proteins present in the feed additive are lysozyme and lactoferrin, where lysozyme is present in an amount between about 0.05 and 0.5 grams protein/kg feed, and lactoferrin, in an amount between 0.2 to 2 grams/protein/kg feed.

19. The method of claim 17, wherein the protein coding sequence is selected from the group of codon-optimized sequences identified by SEQ ID NOS: 1, 3, 7, and 10-15.

20. The method of claim 16, wherein the one or more seed-produced anti-microbial protein(s) present in the food are acute-phase, non-milk proteins selected from the consisting of C-reactive protein, serum amyloid A; ferritin, haptoglobin, seromucoids, ceruloplasmin, 15-keto-13,14-dihydro-prostaglandin F2 alpha, fibrinogen, alpha-1-acid glycoprotein, mannose binding protein, lipopolysaccharide binding protein, alpha-2 macroglobulin and defensins.

21. The method of claim 20, wherein the protein coding sequence is selected from the group identified by SEQ ID NOS: 36 and 46-56.

22. The method of claim 16, wherein the one or more seed-produced anti-microbial protein(s) present in the food are antimicrobial peptides selected from the group consisting of cecropin, magainin, defensins, tachyplesin, parasin l,buforin 1, PMAP-23, moronecidin, anoplin, gambicin, and SAMP-29.

23. The method of claim 22, wherein the protein coding sequence is selected from the group identified by SEQ ID NOS: 34-68, 40-41, and 43.

24. The method of claim 16, wherein the one or more seed-produced anti-microbial protein(s) present in the food are antimicrobial proteins selected from the group consisting: CAP37, granulysin, secretory leukocyte protease inhibitor, CAP18, ubiquicidin, bovine antimicrobial protein-1, Ace-AMP1, tachyplesin, big defensin, Ac-AMP2, Ah-AMP1, and CAP18.

25. The method of claim 24, wherein the protein coding sequence is selected from the group identified by SEQ ID NOS: 37, 45, and 57-59.

26. The method of claim 16, wherein the anti-microbial protein(s) constitute at least 0.25 weight percent of the total protein in the harvested mature seeds.

27. The method of claim 16, wherein
(a) the flour is prepared by milling mature monocot seeds,
(b) the extract is prepared by suspending milled flour in a buffered aqueous medium; and
(c) the malt is prepared by (i) steeping barley seeds to a desired water content, (ii) germinating the stepped barley, (iii) drying the germinated seeds, under conditions effective to stop germination, (iv) crushing the dried seeds, and (v) after mixing the crushed seeds with water, malting the crushed seed mixture until a desired malt is achieved.

28. The method of claim 27, wherein the malt is further prepared by adding to the crushed dried seeds, mature non-barley transgenic monocot seeds that produce a heterologous, anti-microbial protein.

29. The method of claim 16, wherein the monocot plant obtained is further transformed with a second chimeric gene having (i) a transcriptional regulatory region from a monocot gene having a seed maturation-specific promoter, (ii) operably linked to said transcriptional regulatory region, a transit DNA sequence encoding a monocot seed-specific transit sequence capable of targeting a linked polypeptide to an endosperm-cell organelle, and (iii) a protein-coding sequence encoding a second heterologous, anti-microbial protein.

30. The method of claim 16, wherein the transcriptional regulatory region in the chimeric gene is from the promoter of a gene selected from the group of rice glutelins, rice globulins, oryzins, and prolamines, barley hordeins, wheat gliadins and glutenins, maize zeins and glutelins, oat glutelins, and sorghum kafirins, millet pennisetins, and rye secalins genes.

31. The method of claim 30, wherein the leader sequence in the chimeric gene is from the gene selected from the group of rice glutelins, rice globulins oryzins, and prolamines, barley hordeins, wheat gliadins and glutenins, maize zeins and glutelins, oat glutelins, and sorghum kafirins, millet pennisetins, and rye secalins genes.

32. The method of claim 31, wherein the transcriptional regulatory region in the chimeric gene is a rice glutelin Gt1 promoter, and the leader DNA sequence is a rice glutelin Gt1 signal sequence capable of targeting a linked polypeptide to a protein storage body.

33. The method of claim 32, wherein glutelin Gt1 promoter and glutelin Gt1 signal sequence are included within the sequence identified by SEQ ID NO:15.

34. The method of claim 31, wherein the transcriptional regulatory region in the chimeric gene is a rice globulin Glb promoter, and the leader DNA sequence is a rice glutelin Gt1 signal sequence capable of targeting a linked polypeptide to a protein storage body.

35. The method of claim 34, wherein the globulin Glb promoter and glutelin Gt1 signal sequence are included within the sequence identified by SEQ ID NO:16.

36. The method of claim 16, wherein the transformed monocot plant further comprises a nucleic acid that encodes at least one transcription factor selected from the group consisting of Reb, O2 and PBF, and an active fragment thereof.

37. The method of claim 36, wherein the transcription factor is O2 and/or PBF.


SEQUENCE LISTING (60 sequences)

SEQ ID NO: 1 - DNA, 393 bp, Homo sapiens
aaagtcttcgagcggtgcgagctggcccgcacgctcaagcggctcggcatggacggctaccggggcatcagcctcgccaactggatgtgcctcgccaagtgggagtcgggctacaacacccgcgcaaccaactacaacgccggcgaccgctccaccgactacggcatcttccagatcaactcccgctactggtgcaacgacggcaagacgcccggggccgtcaacgcctgccacctctcctgctcggccctgctgcaagacaacatcgccgacgccgtcgcgtgcgcgaagcgcgtcgtccgcgacccgcagggcatccgggcctgggtggcctggcgcaaccgctgccagaaccgggacgtgcgccagtacgtccagggctgcggcgtctga

SEQ ID NO: 2 - protein, 130 aa, Homo sapiens
KVFERCELARTLKRLGMDGYRGISLANWMCLAKWESGYNTRATNYNAGDRSTDYGIFQINSRYWCNDGKTPGAVNACHLSCSALLQDNIADAVACAKRVVRDPQGIRAWVAWRNRCQNRDVRQYVQGCGV

SEQ ID NO: 3 - DNA, 2079 bp, Homo sapiens
gggcggcggcggcgctcggtgcagtggtgcgccgtgtcccagcccgaggcgaccaagtgcttccagtggcagcgcaacatgcggaaggtgcgcggcccgccggtcagctgcatcaagcgggactcccccatccaatgcatccaggccatcgcggagaaccgcgccgacgcggtcaccctggacggcgggttcatctacgaggcggggctcgccccgtacaagctccgcccggtggcggcggaggtgtacggcaccgagcgccagccgcgcacgcactactacgcggtggccgtcgtcaagaagggcgggtccttccagctcaacgagctgcagggcctgaagtcgtgccacacgggcctccggcggacggcgggctggaacgtgcccatcggcaccctgcgccccttcctgaactggaccggcccgccggagccgatcgaggccgccgtggcccgcttcttcagcgcctcctgcgtccccggcgccgacaagggccagttcccgaacctctgccggctctgcgccgggacgggcgagaacaagtgcgccttctcctcgcaggagccgtacttctcctactcgggcgcgttcaagtgcctccgcgacggggccggcgacgtggcgttcatccgcgagtccaccgtgttcgaggacctctccgacgaggcggagcgggacgagtacgagctgctgtgccccgacaacacccgcaagccggtggacaagttcaaggactgccacctggcgcgggtgccctcgcacgcggtcgtcgcccgcagcgtcaacggcaaggaggacgcgatctggaacctcctccgccaggcccaggagaagttcggcaaggacaagtcccccaagttccagctcttcgggagccccagcggccagaaggacctcctcttcaaggactccgcgatcggcttctcccgcgtccccccgcgcatcgactccggcctgtacctcggctccgggtacttcaccgcgatccagaacctccggaagagcgaggaggaggtggcggcgcggcgggcccgcgtcgtgtggtgcgccgtgggcgagcaggagctgcggaagtgcaaccagtggagcggcctgagcgaggggtcggtgacctgctcgtccgccagcaccaccgaggactgcatcgcgctcgtcctcaagggggaggccgacgcgatgagcctcgacggggggtacgtctacaccgccggcaagtgcggcctggtcccggtcctggcggagaactacaagtcgcagcagtccagcgaccccgacccgaactgcgtggaccgccccgtcgagggctacctcgccgtggccgtcgtgcgccggtccgacacctccctgacgtggaacagcgtcaagggcaagaagagctgccacaccgccgtggaccgcaccgccggctggaacatcccgatgggcctcctcttcaaccagaccggctcctgcaagttcgacgagtacttctcccagtcctgcgcccccggctcggacccccgctccaacctgtgcgccctctgcatcggggacgagcagggcgagaacaagtgcgtgcccaacagcaacgagcggtactacggctacacgggggccttccgctgcctggcggagaacgccggggacgtcgcgttcgtgaaggacgtgaccgtgctgcaaaacacggacgggaacaacaacgaggcgtgggcgaaggacctcaagctcgccgacttcgccctgctgtgcctcgacggcaagcgcaagcccgtcaccgaggcgcggtcctgccacctggcgatggcccccaaccacgccgtcgtctcccgcatggacaaggtcgagcgcctcaagcaggtgctcctgcaccagcaggccaagttcggccggaacggcagcgactgcccggacaagttctgcctgttccagtcggagaccaagaacctcctcttcaacgacaacaccgagtgcctggcgcgcctccacggcaagaccacctacgagaagtacctcggcccgcagtacgtcgccggcatcaccaacctcaagaagtgctccacctcccccctcctggaggcgtgcgagttcctccgcaagtga

SEQ ID NO: 4 - protein, 690 aa, Homo sapiens
GRRRRSVQWCAVSQPEATKCFQWQRNMRKVRGPPVSCIKRDSPIQCIQAIAENRADAVTLDGGFIYEAGLAPYKLRPVAAEVYGTERQPRTHYYAVAVVKKGGSFQLNELQGLKSCHTGLRRTAGWNVPIGTLRPFLNWTGPPEPIEAAVARFFSASCVPGADKGQFPNLCRLCAGTGENKCAFSSQEPYFSYSGAFKCLRDGAGDVAFIRESTVFEDLSDEAERDEYELLCPDNTRKPVDKFKDCHLARVPSHAVVARSVNGKEDAIWNLLRQAQEKFGKDKSPKFQLFGSPSGQKDLLFKDSAIGFSRVPPRIDSGLGSGYFTAIQNLRKSEEEVAARRARVVWCAVGEQELRKCNQWSGLSEGSVTCSSASTTEDCIALVLKGEADAMSLDGGYVYTAGKCGLVPVLAENYKSQQSSDPDPNCVDRPVEGYLAVAVVRRSDTSLTWNSVKGKKSCHTAVDRTAGWNIPMGLLFNQTGSCKFDEYFSQSCAPGSDPRSNLCALCIGDEQGENKCVPNSNERYYGYTGAFRCLAENAGDVAFVKDVTVLQNTDGNNNEAWAKDLKLADFALLCLDGKRKPVTEARSCHLAMAPNHAVVSRMDKVERLKQVLLHQQAKFGRNGSDCPDKFCLFQSETKNLLFNDNTECLARLHGKTTYEKYLGPQYVAGITNLKKCSTSPLLEACEFLRK

SEQ ID NO: 5 - DNA, 42 bp, Artificial Sequence
  primer
atcgaagcttcatgagtaatgtgtgagcattatgggaccacg

SEQ ID NO: 6 - DNA, 53 bp, Artificial Sequence
  primer
ctagtctagactcgagccatggggccggctagggagccatcgcacaagaggaa

SEQ ID NO: 7 - DNA, 72 bp, Artificial Sequence
  codon optimized lactoferricin coding sequence based on Homo sapiens sequence
accaagtgcttccagtggcagcgcaacatgcggaaggtgcgcggcccgccggtcagctgcatcaagcgggac

SEQ ID NO: 8 - DNA, 162 bp, Artificial Sequence
  codon optimized EGF coding sequence based on Homo sapiens sequence
aactccgactcggagtgccccctctcccacgacggttactgcctccacgacggggtctgcatgtacatcgaggccctcgacaagtacgcctgcaactgcgtcgtgggctacatcggcgagcggtgccagtaccgcgacctcaagtggtgggagctgcgctga

SEQ ID NO: 9 - DNA, 213 bp, Artificial Sequence
  codon optimized IGF-1 coding sequence based on Homo sapiens sequence
ggcccggagaccctctgcggcgccgagctcgtggacgccctccagttcgtgtgcggcgaccgcggcttctacttcaacaagccgaccggctacggcagcagcagccgccgcgccccgcagaccggcatcgtggacgagtgctgcttccgcagctgcgacctccgccgcctggagatgtactgcgccccgctcaagcccgccaagagcgcctga

SEQ ID NO: 10 - DNA, 1095 bp, Artificial Sequence
  codon optimized lactohedrin coding sequence based on Homo sapiens sequence
ctggacatctgctcgaagaacccgtgccacaacggcgggctctgcgaggagatcagccaggaggtgcggggcgacgtgttcccctcgtacacctgcacctgcctgaagggctacgccgggaaccactgcgagacgaagtgcgtggagcccctggggatggagaacggcaacatcgccaactcccagatcgccgcctcctccgtgcgggtgaccttcctcggcctccagcactgggtcccggagctggcccggctcaaccgggcgggcatggtgaacgcgtggaccccctcgtccaacgacgacaacccgtggatccaagtgaacctgctccgccgcatgtgggtcaccggcgtggtcacccaaggcgccagccgcctggccagccacgagtacctcaaggccttcaaggtcgcctacagcctcaacggccacgagttcgacttcatccacgacgtcaacaagaagcacaaggagttcgtgggcaactggaacaagaacgcggtccacgtgaacctcttcgagacccccgtcgaggcccagtacgtccgcctctaccccacgagctgccacaccgcctgcacgctccgcttcgagctgctggggtgcgagctgaacgggtgcgcgaacccgctggggctcaagaacaacagcatccccgacaagcagatcacggcctcgtcgtcgtacaagacctggggcctgcacctcttctcgtggaacccgagctacgcccggctggacaagcagggcaacttcaacgcctgggtcgccgggagctacgggaacgaccagtggctccaggtggacctcggcagctccaaggaggtcaccggcatcatcacgcagggggcccgcaacttcggctccgtgcagttcgtggcctcctacaaggtggcctactcgaacgacagcgccaactggaccgagtaccaggacccgcgcaccgggtccagcaagatcttccccggcaactgggacaaccacagccacaagaagaacctgttcgagacccccatcctcgcccggtacgtccgcatcctccccgtcgcttggcacaaccggatcgcgctccggctggagctcctcggctgctga

SEQ ID NO: 11 - DNA, 489 bp, Artificial Sequence
  codon optimized kappa-casein coding sequence based on Homo sapiens sequence
gaggtccaaaaccagaagcagcccgcctgccacgagaacgacgagcgccccttctaccagaagaccgcaccctacgtcccgatgtactacgtcccgaacagctacccctactacggtacgaacctgtaccagcgccgcccggccatcgctatcaacaacccctacgtcccccggacctactacgcgaacccggccgtggtgcggccccacgcgcagatcccgcagcggcagtacctgccaaacagccacccccccaccgtggtgcggcggcccaacctccacccgagcttcatcgctatcccccccaagaagatccaggacaagatcatcatcccgaccatcaacaccatcgccaccgtggagccgacgccagcccccgcgaccgagcccacggtggacagcgtcgtgaccccagaggcgttctccgaatcgatcatcacctccacccccgagaccaccacggtggccgtcacgccgccgacggcatga

SEQ ID NO: 12 - DNA, 1233 bp, Artificial Sequence
  codon optimized haptocorrin coding sequence based on Homo sapiens sequence
gagatctgcgaggtctccgaggagaactacatccgcctcaagcccctcctgaacaccatgatccagagcaactacaaccggggcacgtcggccgtgaacgtcgtgctctccctgaagctcgtgggcatccagatccagaccctcatgcagaagatgatccagcagatcaagtacaacgtgaagagccgcctctcggacgtgtccagcggcgagctggcgctcatcatcctcgcgctcggcgtgtgccggaacgcggaggagaacctcatctacgactaccacctcacggacaagctggagaacaagttccaggccgagatcgagaacatggaggcccacaacggcaccccgctgaccaactactaccagctcagcctggacgtcctcgcgctctgcctgttcaacgggaactactccaccgccgaggtggtcaaccacttcacccccgagaacaagaactactacttcggctcgcagttctccgtggacaccggggccatggccgtcctggccctcacctgcgtgaagaagtccctcatcaacggccagatcaaggccgacgagggctccctgaagaacatctcgatctacaccaagagcctcgtggagaagatcctcagcgagaagaaggagaacgggctgatcggcaacaccttctcgaccggcgaggcgatgcaggccctgttcgtgagcagcgactactacaacgagaacgactggaactgccagcagaccctcaacacggtcctgaccgagatcagccagggcgcgttcagcaaccccaacgccgccgcccaggtcctgccggccctgatgggcaagaccttcctcgacatcaacaaggacagctcctgcgtgtccgcgagcggcaacttcaacatctccgccgacgagccgatcacggtgacgccgcccgacagccagtcgtacatctccgtgaactacagcgtgcggatcaacgagacctacttcacgaacgtgacggtcctcaacggctcggtcttcctgagcgtgatggagaaggcgcagaagatgaacgacacgatcttcggcttcacgatggaggagcgcagctggggcccctacatcacctgcatccagggcctctgcgccaacaacaacgaccgcacctactgggagctgctgagcggcggcgagccgctgagccagggggccggcagctacgtggtccgcaacggcgagaacctggaggtccggtggagcaagtactga

SEQ ID NO: 13 - DNA, 2061 bp, Artificial Sequence
  codon optimized lactoperoxidase coding sequence based on Homo sapiens sequence
caaacgacccggacgtcggcgatctccgacacggtctcgcaggccaaggtgcaagtcaacaaggcattcctggattcgcgcacgcggctgaagaccgcgatgtcgtccgagaccccgacgagccggcagctgagcgagtacctcaagcacgcgaaggggcggacgcgcaccgccatccgcaatggccaagtgtgggaggaatccctgaagcggctgcggcagaaggcgtcgctcaccaacgtgaccgacccgtccctcgacctgaccagcctctccctggaggtcggctgcggcgccccggcgcccgtcgtgcgctgcgacccctgctcgccataccgcacgatcacgggcgactgcaacaaccggcggaagccggcactgggggctgcgaaccgcgccctcgcgcgctggctccccgccgagtacgaggacggcctcagcctccccttcggttggacccccggcaagacgcgcaacggcttcccgctcccgctcgctcgcgaggtcagcaacaagatcgtcggttacctgaacgaggagggggtcctcgaccaaaaccgctccctcctcttcatgcagtgggggcagatcgtggaccacgacctggacttcgccccggacacggagctgggctccagcgagtacagcaagacccagtgcgacgaatactgcatccagggcgacaactgcttcccgatcatgttccccccgaacgacccgaaggcgggcacccagggcaagtgcatgccgttcttccgggcaggcttcgtctgcccgacccccccgtacaagtccctcgcgcgcgagcagatcaacgcgctcacgtccttcctcgacgccagcttcgtctacagcagcgagccgtccctcgccagccgcctccgcaacctcagcagccccctcggcctcatggcggtcaaccaggaggtgtcggaccacggcctcccatacctgccgtacgacagcaagaagccgtccccctgcgagttcatcaacaccaccgcgcgcgtcccgtgcttcctcgccggcgattcgcgggcgagcgagcacatcctcctcgccacgagccacaccctgttcctccgcgagcacaaccgcctcgcccgggagctgaagcgcctcaacccgcagtgggacggcgagaagctctaccaggaggcccggaagatcctcggcgctttcgtccagatcatcaccttccgggactacctccccatcctgctcggtgaccacatgcagaagtggatccccccctaccaaggctactccgagagcgtggacccgcgcatctccaacgtcttcacgttcgcgttccgcttcgggcacctggaggtgccgtcgtcgatgttccgcctcgacgagaactaccagccctggggcccagagccggagctgccgctccacaccctgttcttcaacacctggcggatggtcaaggacggcggcatcgacccgctcgtgcgcgggctcctggctaagaagtcgaagctcatgaagcagaacaagatgatgaccggcgagctgcgcaacaagctgttccagcccacccaccgcatccacgggttcgacctggctgcaatcaacacccagcggtgccgcgaccacggccagcccggctacaactcgtggcgcgcgttctgcgacctctcccagccacagacgctggaggagctcaacaccgtgctcaagagcaagatgctcgccaagaagctgctcgggctctacggcacgcccgacaacatcgacatctggatcggggccatcgcggagccgctcgtggagcgcgggcgcgtcggcccgctgctcgcgtgcctcctgggcaagcaattccaacagatccgcgacggggaccggttctggtgggagaaccccggcgtgttcaccaacgagcagaaggattcgctccaaaagatgagcttctcccgcctggtgtgcgacaacacccgcatcaccaaggtcccgcgcgacccattctgggccaactcctacccgtacgacttcgtggactgctccgccatcgacaagctcgacctgtccccctgggcatcggtgaagaactga

SEQ ID NO: 14 - DNA, 1185 bp, Artificial Sequence
  codon optimized alpha-1-antitrypsin coding sequence based on Homo sapiens sequence
gaggacccgcagggcgacgccgcccagaagaccgacaccagccaccacgaccaggaccacccgacgttcaacaagatcaccccgaatttggccgaattcgccttcagcctgtaccgccagctcgcgcaccagtccaactccaccaacatcttcttcagcccggtgagcatcgccaccgccttcgccatgctgtccctgggtaccaaggcggacacccacgacgagatcctcgaagggctgaacttcaacctgacggagatcccggaggcgcagatccacgagggcttccaggagctgctcaggacgctcaaccagccggactcccagctccagctcaccaccggcaacgggctcttcctgtccgagggcctcaagctcgtcgataagttcctggaggacgtgaagaagctctaccactccgaggcgttcaccgtcaacttcggggacaccgaggaggccaagaagcagatcaacgactacgtcgagaaggggacccagggcaagatcgtggacctggtcaaggaattggacagggacaccgtcttcgcgctcgtcaactacatcttcttcaagggcaagtgggagcgcccgttcgaggtgaaggacaccgaggaggaggacttccacgtcgaccaggtcaccaccgtcaaggtcccgatgatgaagaggctcggcatgttcaacatccagcactgcaagaagctctccagctgggtgctcctcatgaagtacctggggaacgccaccgccatcttcttcctgccggacgagggcaagctccagcacctggagaacgagctgacgcacgacatcatcacgaagttcctggagaacgaggacaggcgctccgctagcctccacctcccgaagctgagcatcaccggcacgtacgacctgaagagcgtgctgggccagctgggcatcacgaaggtcttcagcaacggcgcggacctctccggcgtgacggaggaggcccccctgaagctctccaaggccgtgcacaaggcggtgctcacgatcgacgagaaggggacggaagctgccggggccatgttcctggaggccatccccgtgtccatcccgcccgaggtcaagttcaacaagcccttcgtcttcctgatgatcgagcagaacacgaagagccccctcttcatggggaaggtcgtcaaccccacgcagaagtga

SEQ ID NO: 15 - DNA, 786 bp, Artificial Sequence
  Rice Gt1 promoter and Gt1 leader coding sequence
catgagtaatgtgtgagcattatgggaccacgaaataaaaagaacattttgatgagtcgtgtatcctcgatgagcctcaaaagttctctcaccccggataagaaacccttaagcaatgtgcaaagtttgcattctccactgacataatgcaaaataagatatcatcgatgacatagcaactcatgcatcatatcatgcctctctcaacctattcattcctactcatctacataagtatcttcagctaaatgttagaacataaacccataagtcacgtttgatgagtattaggcgtgacacatgacaaatcacagactcaagcaagataaagcaaaatgatgtgtacataaaactccagagctatatgtcatattgcaaaaagaggagagcttataagacaaggcatgactcacaaaaattcacttgcctttcgtgtcaaaaagaggagggctttacattatccatgtcatattgcaaaagaaagagagaaagaacaacacaatgctgcgtcaattatacatatctgtatgtccatcattattcatccacctttcgtgtaccacacttcatatatcataagagtcacttcacgtctggacattaacaaactctatcttaacatttagatgcaagagcctttatctcactataaatgcacgatgatttctcattgtttctcacaaaaagcggccgcttcattagtcctacaacaacatggcatccataaatcgccccatagttttcttcacagtttgcttgttcctcttgtgcgatggctccctagcc

SEQ ID NO: 16 - DNA, 1055 bp, Artificial Sequence
  Rice Glb promoter and Gt1 leader coding sequence
ctgcagggaggagaggggagagatggtgagagaggaggaagaagaggaggggtgacaatgatatgtggggcatgtgggcacccaattttttaattcattcttttgttgaaactgacatgtgggtcccatgagatttattatttttcggatcgaatcgccacgtaagcgctacgtcaatgctacgtcagatgaagaccgagtcaaattagccacgtaagcgccacgtcagccaaaaccaccatccaaaccgccgagggacctcatctgcactggttttgatagttgagggacccgttgtatctggtttttcgattgaaggacgaaaatcaaatttgttgacaagttaagggaccttaaatgaacttattccatttcaaaatattctgtgagccatatataccgtgggcttccaatcctcctcaaattaaagggcctttttaaaatagataattgccttctttcagtcacccataaaagtacaaaactactaccaacaagcaacatgcgcagttacacacattttctgcacatttccgccacgtcacaaagagctaagagttatccctaggacaatctcattagtgtagatacatccattaatcttttatcagaggcaaacgtaaagccgctctttatgacaaaaataggtgacacaaaagtgttatctgccacatacataacttcagaaattacccaacaccaagagaaaaataaaaaaaaatctttttgcaagctccaaatcttggaaacctttttcactctttgcagcattgtactcttgctctttttccaaccgatccatgtcaccctcaagcttctacttgatctacacgaagctcaccgtgcacacaaccatggccacaaaaaccctataaaaccccatccgatcgccatcatctcatcatcagttcattaccaacaaacaaaagaggaaaaaaaacatatacacttctagtgattgtctgattgatcatcaatctagaggcggccgcatggctagcaaggtcgtcttcttcgcggcggcgctcatggcggccatggtggccatctccggc

SEQ ID NO: 17 - DNA, 976 bp, Artificial Sequence
  Bx7 promoter
ctgcaggccagggaaagacaatggacatgcaaagaggtaggggcagggaagaaacacttggagatcatagaagaacataagaggttaaacataggagggcataatggacaattaaatctacattaattgaactcatttgggaagtaaacaaaatccatattctggtgtaaatcaaactatttgacgcggatttactaagatcctatgttaattttagacatgactggccaaaggtttcagttagttcatttgtcacggaaaggtgttttcataagtccaaaactctaccaacttttttgcacgtcatagcatagatagatgttgtgagtcattggatagatattgtgagtcagcatggatttgtgttgcctggaaatccaactaaatgacaagcaacaaaacctgaaatgggctttaggagagatggtttatcaatttacatgttccatgcaggctaccttccactactcgacatggttagaagttttgagtgccgcatatttgcggaagcaatggcactactcgacatggttagaagttttgagtgccgcatatttgcggaagcaatggctaacagatacatattctgccaaaccccaagaaggataatcactcctcttagataaaaagaacagaccaatgtacaaacatccacacttctgcaaacaatacaccagaactaggattaagcccattacgtggctttagcagaccgtccaaaaatctgttttgcaagcaccaattgctccttacttatccagcttcttttgtgttggcaaactgcccttttccaaccgattttgtttcttctcacgctttcttcataggctaaactaacctcggcgtgcacacaaccatgtcctgaaccttcacctcgtccctataaaagcccatccaaccttacaatctcatcatcacccacaacaccgagcaccccaatctacagatcaattcactgacagttcactgatctaga

SEQ ID NO: 18 - DNA, 1009 bp, Artificial Sequence
  Glub-2 promoter
ctgcagtaatggatacctagtagcaagctagcttaaacaaatctaaattccaatctgttcgtaaacgttttctcgatcgcaattttgatcaaaactattgaaaacctcaattaaaccattcaaaatttttaatatacccaacaagagcgtccaaaccaaatatgtaaatatggatgtcatgataattgacttatgacaatgtgattatttcatcaagtctttaaatcattaattctagttgaaggtttatgttttcttatgctaaagggttatgtttatataagaatattaaagagcaaattgcaatagatcaacacaacaaatttgaatgtttccagatgtgtaaaaatatccaaattaattgttttaaaatagttttaagaaggatctgatatgcaagtttgatagttagtaaactgcaaaagggcttattacatggaaaattccttattgaatatgtttcattgactggtttattttacatgacaacaaagttactagtatgtcaataaaaaaatacaaggttacttgtcaattgtattgtgccaagtaaagatgacaacaaacatacaaatttatttgttcttttatagaaacacctaacttatcaaggatagttggccacgcaaaaatgacaacatactttacaattgtatcatcataaagatcttatcaagtataagaactttatggtgacataaaaaataatcacaagggcaagacacatactaaaagtatggacagaaatttcttaacaaactccatttgttttgtatccaaaagcataagaaatgagtcatggctgagtcatgatatgtagttcaatcttgcaaaattgcctttttgttaagtattgttttaacactacaagtcacatattgtctatacttgcaacaaacactattaccgtgtatcccaagtggccttttcattgctatataaactagcttgatcggtctttcaactcacatcaattagcttaagtttccattagcaactgctaatagct

SEQ ID NO: 19 - DNA, 839 bp, Artificial Sequence
  Gt3 promoter
ctgcagtgtaagtgtagcttcttatagcttagtgctttactatcttcacaagcacatgctatagtattgttccaagatgaaagaataattcatccttgctaccaacttgcatgatattatatttgtgaatatcctatctcttggcttataatgaaatgtgctgctgggttattctgaccatggtatttgagagcctttgtatagctgaaaccaacgtatatcgagcatggaacagagaacaaaatgcaaggatttttttattctggttcatgccctggatgggttaatatcgtgatcatcaaaaaagatatgcataaaattaaagtaataaatttgctcataagaaaccaaaaccaaaagcacatatgtcctaaacaaactgcattttgtttgtcatgtagcaatacaagagataatatatgacgtggttatgacttattcactttttgtgactccaaaatgtagtaggtctaactgattgtttaaagtgatgtcttactgtagaagtttcatcccaaaagcaatcactaaagcaacacacacgtatagtccaccttcacgtaattctttgtggaagataacaagaaggctcactgaaaaataaaagcaaagaaaaggatatcaaacagaccattgtgcatcccattgatccttgtatgtctatttatctatcctccttttgtgtaccttacttctatctagtgagtcacttcatatgtggacattaacaaactctatcttaacatctagtcgatcactactttacttcactataaaaggaccaacatatatcatccatttctcacaaaagcattgagttcagtcccacaaaatctaga

SEQ ID NO: 20 - DNA, 1302 bp, Artificial Sequence
  Glub-1 promoter
ctgcagagatatggattttctaagattaattgattctctgtctaaagaaaaaaagtattattgaattaaatggaaaaagaaaaaggaaaaaggggatggcttctgctttttgggctgaaggcggcgtgtggccagcgtgctgcgtgcggacagcgagcgaacacacgacggagcagctacgacgaacgggggaccgagtggaccggacgaggatgtggcctaggacgagtgcacaaggctagtggactcggtccccgcgcggtatcccgagtggtccactgtctgcaaacacgattcacatagagcgggcagacgcgggagccgtcctaggtgcaccggaagcaaatccgtcgcctgggtggatttgagtgacacggcccacgtgtagcctcacagctctccgtggtcagatgtgtaaaattatcataatatgtgtttttcaaatagttaaataatatatataggcaagttatatgggtcaataagcagtaaaaaggcttatgacatggtaaaattacttacaccaatatgccttactgtctgatatattttacatgacaacaaagttacaagtacgtcatttaaaaatacaagttacttatcaattgtagtgtatcaagtaaatgacaacaaacctacaaatttgctattttgaaggaacacttaaaaaaatcaataggcaagttatatagtcaataaactgcaagaaggcttatgacatggaaaaattacatacaccaatatgctttattgtccggtatattttacaagacaacaaagttataagtatgtcatttaaaaatacaagttacttatcaattgtcaagtaaatgaaaacaaacctacaaatttgttattttgaaggaacacctaaattatcaaatatagcttgctacgcaaaatgacaacatgcttacaagttattatcatcttaaagttagactcatcttctcaagcataagagctttatggtgcaaaaacaaatataatgacaaggcaaagatacatacatattaagagtatggacagacatttctttaacaaactccatttgtattactccaaaagcaccagaagtttgtcatggctgagtcatgaaatgtatagttcaatcttgcaaagttgcctttccttttgtactgtgttttaacactacaagccatatattgtctgtacgtgcaacaaactatatcaccatgtatcccaagatgcttttttattgctatataaactagcttggtctgtctttgaactcacatcaattagcttaagtttccataagcaagtacaaatagctctaga

SEQ ID NO: 21 - DNA, 675 bp, Artificial Sequence
  Rice proalmin promoter
ctgcagcatcggcttaggtgtagcaacacgactttattattattattattattattattattattttacaaaaatataaaatagatcagtccctcaccacaagtagagcaagttggtgagttattgtaaagttctacaaagctaatttaaaagttattgcattaacttatttcatattacaaacaagagtgtcaatggaacaatgaaaaccatatgacatactataattttgtttttattattgaaattatataattcaaagagaataaatccacatagccgtaaagttctacatgtggtgcattaccaaaatatatatagcttacaaaacatgacaagcttagtttgaaaaattgcaatccttatcacattgacacataaagtgagtgatgagtcataatattatttttcttgctacccatcatgtatatatgatagccacaaagttactttgatgatgatatcaaagaacatttttaggtgcacctaacagaatatccaaataatatgactcacttagatcataatagagcatcaagtaaaactaacactctaaagcaaccgatgggaaagcatctataaatagacaagcacaatgaaaatcctcatcatccttcaccacaattcaaatattatagttgaagcatagtagtagaatccaacaacaatctagag

SEQ ID NO: 22 - DNA, 1098 bp, Artificial Sequence
  Rice cysteine peptidase promoter
ccaggcttcatcctaaccattacaggcaagatgttgtatgaagaagggcgaacatgcagattgttaaactgacacgtgatggacaagaatgaccgattggtgaccggtctgacaatggtcatgtcgtcagcagacagccatctcccacgtcgcgcctgcttccggtgaaagtggaggtaggtatgggccgtcccgtcagaaggtgattcggatggcagcgatacaaatctccgtccattaatgaagagaagtcaagttgaaagaaagggagggagagatggtgcatgtgggatccccttgggatataaaaggaggaccttgcccacttagaaaggagaggagaaagcaatcccagaagaatcgggggctgactggcactttgtagcttcttcatacgcgaatccaccaaaacacaggagtagggtattacgcttctcagcggcccgaacctgtatacatcgcccgtgtcttgtgtgtttccgctcttgcgaaccttccacagattgggagcttagaacctcacccagggcccccggccgaactggcaaaggggggcctgcgcggtctcccggtgaggagccccacgctccgtcagttctaaattacccgatgagaaagggaggggggggggggaaatctgccttgtttatttacgatccaacggatttggtcgacaccgatgaggtgtcttaccagttaccacgagctagattatagtactaattacttgaggattcggttcctaattttttacccgatcgacttcgccatggaaaattttttattcgggggagaatatccaccctgtttcgctcctaattaagataggaattgttacgattagcaacctaattcagatcagaattgttagttagcggcgttggatccctcacctcatcccatcccaattcccaaacccaaactcctcttccagtcgccgacccaaacacgcatccgccgcctataaatcccacccgcatcgagcctatcaagcccaaaaaaccacaaaccaaacgaagaaggaaaaaaaaaggaggaaaagaaaagaggaggaaagcgaagaggttggagagagacgctcgtctccacgtcgccgcc

SEQ ID NO: 23 - DNA, 432 bp, Artificial Sequence
  Barley D-Hordian promoter
cttcgagtgcccgccgatttgccagcaatggctaacagacacatattctgccaaaaccccagaacaataatcacttctcgtagatgaagagaacagaccaagatacaaacgtccacgcttcagcaaacagtaccccagaactaggattaagccgattacgcggctttagcagaccgtccaaaaaaactgttttgcaaagctccaattcctccttgcttatccaatttcttttgtgttggcaaactgcacttgtccaaccgattttgttcttcccgtgtttcttcttaggctaactaacacagccgtgcacatagccatggtccggaatcttcacctcgtccctataaaagcccagccaatctccacaatctcatcatcaccgagaacaccgagaaccacaaaactagagatcaattcattgacagtccaccg

SEQ ID NO: 24 - DNA, 60 bp, Artificial Sequence
  bx7 signal peptide sequence
atggctaagcgcctggtcctctttgcggcagtagtcgtcgccctcgtggctctcaccgcc

SEQ ID NO: 25 - DNA, 72 bp, Artificial Sequence
  Glub-2 signal peptide sequence
atggcaactaccattttctctcgtttttctatatacttttgtgctatgctattatgccagggttctatggcc

SEQ ID NO: 26 - DNA, 85 bp, Artificial Sequence
  Gt3 signal peptide sequence
atgtggacattaacaaactctatcttaacatctagtcgatcactactttacttcactataaaaggaccaacatatatcatccatt

SEQ ID NO: 27 - DNA, 72 bp, Artificial Sequence
  Glub-1 signal peptide sequence
atggcgagttccgttttctctcggttttctatatacttttgtgttcttctattatgccatggttctatggcc

SEQ ID NO: 28 - DNA, 69 bp, Artificial Sequence
  proalmin signal peptide sequence
atgaagatcattttcgtatttgctctccttgctattgttgcatgcaacgcttctgcacggtttgatgct

SEQ ID NO: 29 - DNA, 63 bp, Artificial Sequence
  Rice cysteine peptidase signal peptide sequence
atggccgcccgcgccgccgccgccgcgttcctgctgctgctcatcgtcgttggtcaccgcgcc

SEQ ID NO: 30 - DNA, 63 bp, Artificial Sequence
  D-Hodian signal peptide sequence
atggctaagcggctggtcctctttgtggcggtaatcgtcgccctcgtggctctcaccaccgcc

SEQ ID NO: 31 - DNA, 1314 bp, Artificial Sequence
  O2 transcription factor sequence
atggagcacgtcatctcaatggaggagatcctcgggcccttctgggagctgctaccaccgccagcgccagagccagagcgagagcagcctccggtaaccggcatcgtcgtcggcagtgtcatagacgttgctgctgctggtcatggtgacggggacatgatggatcagcagcacgccacagagtggacctttgagaggttactagaagaggaggctctgacgacaagcacaccgccgccggtggtggtggtgccgaactcttgttgctcaggcgccctaaatgctgaccggccgccggtgatggaagaggcggtaactatggcgcctgcggcggtgagtagtgccgtagtaggtgaccccatggagtacaatgccatactgaggaggaagctggaggaggacctcgaggccttcaaaatgtggagggcggcctccagtgttgtgacctcagatcaacgttctcaaggctcaaacaatcacactggaggtagcagcatcaggaataatccagtgcagaacaagctgatgaacggcgaagatccaatcaacaataaccacgctcaaactgcaggccttggcgtgaggcttgctactagctcttcctcgagagatccttcaccatcagacgaagacatggacggagaagtagagattctggggttcaagatgcctaccgaggaaagagtgaggaaaagaaaggaatccaatagagaatcagccagacgctcgagatacaggaaagccgctcacctgaaagaactggaagaccaggtagcacagctaaaagccgagaattcttgcctgctgaggcgcattgccgctctgaaccagaagtacaacgacgctaacgtcgacaacagggtgctgagagcggacatggagaccctaagagctaaggtgaagatgggagaggactctctgaagcgggtgatagagatgagctcatcagtgccgtcgtccatgcccatctcggcgccgacccccagctccgacgctccagtgccgccgccgcctatccgagacagcatcgtcggctacttctccgccacagccgcagacgacgatgcttcggtcggcaacggtttcttgcgactgcaagctcatcaagagcctgcatccatggtcgtcggtggaactctgagcgccacagagatgaaccgagtagcagcagccacgcattgcgcgggggccatggagcacatccagacggcgatgggatccatgccgccgacctccgcctccggatctacaccgccgccgcaggattatgagctgctgggtccaaatggggccatacacatggacatgtattag

SEQ ID NO: 32 - DNA, 987 bp, Artificial Sequence
  PBF transcription factor sequence
atggacatgatctccggcagcactgcagcaacatcaacaccccacaacaaccaacaggcggtgatgttgtcatcccccattataaaggaggaagctagggacccaaagcagacacgagccatgccccaaataggtggcagtggggagcgtaagccgaggccgcaactacctgaggcgctcaagtgcccacgctgcgactccaacaacaccaagttttgctactacaacaattatagcatgtcacaaccacgctacttttgcaaggcttgccgccgctattggacacatggtggtaccctccgcaatgtccccattggtggtgggtgtcgcaagaacaaacatgcctctagatttgtcttgggctctcacacctcatcgtcctcatctgctacctatgcaccattatcccctagcaccaacgctagctctagcaatatgagcatcaacaaacatatgatgatggtgcctaacatgacgatgcctaccccaacgacaatgggcttattccctaatgtgctcccaacacttatgccgacaggtggaggcgggggctttgacttcactatggacaaccaacatagatcattgtccttcacaccaatgtctctacctagccaggggccagtgcctatgctggctgcaggagggagtgaggcaacaccgtctttcctagagatgctgagaggagggatttttcatggtagtagtagctataacacaagtctcacgatgagtggtggcaacaatggaatggacaagccattttcgctgccatcatatggtgcaatgtgcacaaatgggttgagtggctcaaccactaatgatgccagacaactggtggggcctcagcaggataacaaggccatcatgaagagcagtaataacaacaatggtgtatcattgttgaacctctactggaacaagcacaacaacaacaacaacaacaacaacaacaacaacaacaacaacaacaacaagggacaataa

SEQ ID NO: 33 - DNA, 3902 bp, Artificial Sequence
  Reb transcription factor sequence
atggagcgggtgttctccgtggaggagatctccgacccattctgggtcccgcctccgccgccgcagtcggcggcggcggcccagcagcagggcggcggcggcgtggcttcgggaggtggtggtggtgtagcggggggcggcggcggcgggaacgcgatgaaccggtgcccgtcggagtggtacttccagaagtttctggaggaggcggtgctcgatagccccgtcccgaaccctagcccgagggccgaagcgggagggatcaggggcgcaggaggggtggtgccggtcgatgttaagcagccgcagctctcggcggcggcgacgacgagcgcggtggtggaccccgtggagtacaacgcgatgctgaagcagaagctggagaaggacctcgccgcggtcgccatgtggagggtacagccattctccccccctctagtactcgagagcttactgagatcggcaatgctagctactgtttgcatcgaatgtttataggtatttagatcgggcatttctatagaccaatggcgtccatggtcttgcaatgcgctctgttgagtgtcggtggttggttcgactcatagtatgtagggttgtgcgtatgtacaaacggaagcttcatagacctcggtattgagattgcgatatcgatgcaacctgcgaattggcgatgtaatcagtcatattcttactaaactgcgagacagtggtttgtttgcaattgcaatatttttgtatggggctgcttaaactgtcattgcctttttagattggcaatatgtgactttatgcaagtatttgattgggcggatccaggaacaaaaagttggggggattcaacataccgagtacactggcataaacacatcatctcagtattaaactatgctaaaatgctattaagagacctttagcacctcttatcttatcaaccatggtgaaaaaattgaaggggggactcaggggggtatccatgggtccgatgggtgcaggggggactgagtcccccctgcacccacgttgaatccgccctggcatgcgtataagctgtcacagccatttctaggtgcttgtgcttagttgggtgatgtcagcttaatttgtcttttctatgtcgtcatcgattttctaagaaacgaaaaatagcctatttatgtgctccagaatttgatgatccctggcccttcatttgctgaaattagcctatttgttggttgcccttcagttttttcccagcttatgttgttgcaatgtgtggctatgcctcgttttgtgccctataatttattatttgcaattcatttttgtacatgacttaaaatgacactagagcaacatgcactgattggttatcctataatcatttatgtagttctgttcattttatcatgctagctcatgtcattttcatcttcaggcctctggcacagttccacctgagcgtcctggagctggttcatccttgctgaatgcagatgtttcacacataggcgctcctaattccatcggaggtacttatcttatctggttacattttcagattgttatgaaactacccaaatatcctgcacaattgcatgggattaaattttagtttctttgaaatagaagtagagttgtattgctgtcacgtcatcaaatagttctgaagctatgaataaataagttccgcatttgttagtgattctttgaacattagaattgttatgcttaagtagatagggttatgtttgtttggagttcccttaaatcatttcattgctgactgccagctggcaggagcatttgttgttgccttgaccatgaatgaagaccttcctgttctgagtgctcacaagaaaacatattttgattaatgcaccttgaatccttaggatcttgcaaagatgggcacttagctttagaattgagtagtacttaaatagctgttgttatcatgatttgtcctgtagtgaaatgtcgacaaaacaggaatgctacttttgacttctgatatttcatgcctggctttacttatgctctgtttggaacatgggcacatatcaggcaatgctactccagttcaaaacatgctaagtggcccaagtgggggatcgggctcacagttggtacagaatgttgatgtccttgtaaagcagcccaccagctcttcatcaagggagcagtcagatgatgatgacatgaagggagaagctgagaccactggaactgcaagacctgctgatcaaagattacaacgaaggtgatcattcattgcttccttgtaatatagattctgtacataattaacctacctcgtcatgcatgcatgtgtcctattttcaccttagccctttcagttggatttccactttcatccggtagcctttcagtttcctattgcatcgcatatatgatcttttacctaccatattagttctctgtgtgccatactcagtgcttagtgtctcgagcaagagaggaatttgtatggctattacacgtagcactttgctctctacttgtttattgacataagcaatttgggatgaattaaatctgagttcacatcatattccttatgtcacaagtttctgaaaccgattgtatctagtatctggttgatgcacccccatcttggatttgcaaatcaaagttatactccctagagagctttacctttcataaagcaattaccccaataaaccacggatttgatagctattgactatgattaccagaattcatttggcagctattttctcaatttaagtttggtattagtctcagttggctgtaaaataatgtcacggtagggtacatgtatgtgcagcatacaaggtatgggtgagttatgatatggacagtgtgtacaccccacatttgctcactaaaatcaaaatattcaaacgtcacgtgatgatatggtggattgcattataccttgtattgtttattatgttacttgtgctagacaataatataggctgttcttttgggtgattttgtatgaagatgttgagcaagcacttctcgatataatgctagttttgttgacctgttccaggaagcaatccaatcgggagtcagccaggcgctcaagaagcagaaaggcagctcacttgaatgagctggaggcacaggtgtgatagttcacatagttattttcgataagacataaaatcctaaattactggctactgacttcagttatggatttacttgttacaggtatcgcaattaagagtcgagaactcctcgctgttaaggcgtcttgctgatgttaaccagaagtacaatgatgctgctgttgacaatagagtgctaaaagcagatgttgagaccttgagagcaaaggtatgctatatatgccttttgcaatatgcatcccatggattgctactttggcttgtttcaaactttcaacgtgacttgtgtaccctgttattagaagaataatcccgcctaccattatactctataaatcaccatttggccagtccaaacatgattattaaatcaggtcaatctgaacattgaaatgtatcaaaaattcgcaggtgaagatggcagaggactcggtgaagcgggtgacaggcatgaacgcgttgtttcccgccgcttctgatatgtcatccctcagcatgccattcaacagctccccatctgaagcaacgtcagacgctgctgttcccatccaagatgacccgaacaattacttcgctactaacaacgacatcggaggtaacaacaactacatgcccgacataccttcttcggctcaggaggacgaggacttcgtcaatggcgctctggctgccggcaagattggccggccagcctcgctgcagcgggtggcgagcctggagcatctccagaagaggatgtgcggtgggccggcttcgtctgggtcgacgtcctga

SEQ ID NO: 34 - DNA, 361 bp, Bombyx mori
atcagtcgcttagttcccacagcaacagctatatcgacagcaaaactcctttttaaaatccaggaattaaatctaaaaatttcaaaatgaacttcaacaagatcttcgtgttcgttgccctcatcctggctattagtttgggacaatctgaagccggttggctgaagaaattgggcaaaagaattgtaagtattgctaaaaacaaatattaaaatgttttaatatttctaaattaaatattaattatttttaaaggaacgcattggccagcacactcgagatgccaccattcagggtctgggaattgcgcaacaagcggccaatgtggcagccacggccagaggatgaaagttccatcaaa

SEQ ID NO: 35 - DNA, 1098 bp, Xenopus laevis
ttgaaatacaactatatttggaaaagatgttcaaaggattatttatctgttcactaattgctgtgatctgtgcaaatgcactgccacaaccagaggcctctgcggatgaagatatggatgaaagagaggtccggggaattggtaaatttttgcattcagcgggcaaatttggaaaagcttttgtgggagagataatgaagtcaaaacgagatgcagaagcagtaggaccagaggcctttgcagatgaagatttagatgaaagagaggtccggggaattggtaaatttttgcactcagcaaaaaaatttggaaaagcttttgtgggagagataatgaattcaaaacgagatgcagaagcagtaggaccagaggcctttgcagatgaagatttagatgaaagagaggtccggggaattggtaaatttttgcactcagcaaaaaaatttggaaaagcttttgtgggagaaataatgaattcaaaacgagatgcagaagcagtaggaccagaggcctttgcagatgaagatttagatgaaagagaggtccggggaattggtaaatttttgcactcagcaaaaaaatttggaaaagcttttgtgggagaaataatgaattcaaaacgagatgcagaagcagtaggaccagaggcctttgcagatgaagatttcgatgaaagagaggtccggggaattggtaaatttttgcactcagcaaaaaaatttggaaaagcttttgtgggagaaataatgaattcaaaacgagatgcagaagcagtaggaccagaggcctttgcagatgaagatttagatgaaagagaggtccggggaattggtaaatttttgcactcagcaaaaaaatttggaaaagcttttgtgggagaaataatgaattcaaaacgagatgcagaagcagtagatgacaggagatgggttgaatagtttcagcaacagaaaaacatcactgaagaacaatgattcccctgaaaatgtgtaaacggctgaaatgattctgaacatactagtgctgaataaaaagaagatcccttagataacctatacctacagtatatatacctacaaataaactgagcatcacaat

SEQ ID NO: 36 - DNA, 297 bp, Mamestra brassicae
atgctgtgcctcgctgacattcgtatcgtggcttcgtgttccgccgccattaagagtggatacggacagcaaccgtggctggcccacgttgcaggcccttatgccaactctctattcgatgatgtgcccgcggatagctatcacgcggccgtcgagtacttgcgcctgatacccgccagttgttacctgctagacggatacgccgccggtcgtgatgacggtagggctcattgcatagccccacgcaaccgccgactatactgtgcctcgtatcaggtctgcgtctgtcgatattga

SEQ ID NO: 37 - DNA, 524 bp, Tachypleus tridentatus
gcctaacatcgcctcagcaacttggccaatagtttcgaacttcatcgtcactatgaagaaacttgtaattgctttgtgcctgatgatggtattggctgtgatggtggaagaggccgaggctaaatggtgcttcagagtatgctacaggggaatttgttatcgcagatgtcgagggaagaggaatgaagtacgtcagtaccgtgaccgtgggtatgatgtaagagccataccagaagaaacgttctttacacgacaagacgaagatgaagatgacgatgaagagtgaggcgtttacagctgaaggaagtatccagctgatgaatattggcgaagacttggaacgaatgacttttacgatttttaaacctcgttaaaggtttaatatttttgtatattggtgttcattaaaacacattcttttatcactatttcttctttgtgcacaaagtaaacttcatatactttctctactatttggattgttgttaaagtttgatattataataaatatataacaagcattc

SEQ ID NO: 38 - protein, 19 aa, Parasilurus asotus
KGRGKQGGKVRAKAKTRSS

SEQ ID NO: 39 - protein, 129 aa, Bufo bufo gagarizans
MSGRGKQGGKVRAKAKTRSSRAGLQFPVGRVHRLLRKGNYAQRVGAGAPVYLAAVLEYLTAEILELAGNAARDNKKTRIIPRHLQLAVRNDEELNKLLGGVTIAQGGVLPNIQAVLLPKTESSKPAKSK

SEQ ID NO: 40 - DNA, 466 bp, Bufo bufo gagarizans
gtctgtacagagaagagaacgatgtctggacgcggcaaacaaggaggcaaagtgcgggctaaggccaagacccgctcatcccgggcaggcctccagttcccggtcggccgtgtgcacaggctcctccgcaagggcaactacgcccagagggtgggcgccggcgctcccgtctacttggccgctgtgctcgagtatctcaccgccgagatcctggagctggccggcaatgccgcccgcgacaacaagaagactcgcatcatcccccgtcacctgcagctggccgtgcgcaacgacgaggagctcaacaagctgctgggcggagtcaccatcgcccaggggggggtcctgcccaacatccaggccgtgctgctgcccaagaccgagagcagcaagccggccaagagcaagtgagccccgctctgccccgaaccaaaggctcttctaagaaaaaaaaaaaaaaaaaaaa

SEQ ID NO: 41 - DNA, 581 bp, Sus scrofa
tcacctgggcaccatggagacccagagggccagcctgtgcctggggcgctggtcactgtggcttctgctgctgggactcgtggtgccctcggccagcgcccaggccctcagctacagggaggccgtgcttcgtgctgtggatcgcctcaacgagcagtcctcggaagctaatctctaccgcctcctggagctggaccagccgcccaaggccgacgaggacccgggcaccccaaaacctgtgagcttcacggtgaaggagactgtgtgtcccaggccgacccggcagcccccggagctgtgtgacttcaaggagaacgggcgggtgaagcagtgtgtggggacagtcaccttgaaagagatcagaggcaactttgacataacctgtaatcagcttcagagtgtcaggattatagacctgctgtggagagtacgtcggccacagaaacccaaatttgtgactgtatgggtcagataattagtgcatgaaggaatttcattcttcaagacacagggaagagttctaaagttctgcttattctaccacaagcttcaggactggaaaaataaattcttgtgaaagc

SEQ ID NO: 42 - protein, 23 aa, Morone sp.
FFHHIFRGIVHVGKTIHDLVTGT

SEQ ID NO: 43 - DNA, 484 bp, Morone sp.
agagagatttacaccacctgtacatctcaaaccgcttcttaagctcactttgataacagctttttgactttcagtcacagtcggtggaaagaccgaagagatgaagtgcgccacgctctctcttgtgctgtcgatggtcgtcctcatggctgaacctggggatgccttctttcaccacattttccgtggaattgttcacgtcggcaagacgatccacaaacttgtgaccgggggaaaagcggagcaagatcagcaagatcagcaatatcagcaagatcagcaagatcagcaagcgcagcaatatcagcgctttaaccgcgagcgtgcggcttttgactagactttgtgaatctatggcggttcatctgaaagagcagctctgaaactttgttttaaattacattcttgttgctctttaactgatatttgaacatatatcagttatttggaataaatatgcatatctaaaaaaaaaaaaaaaaaa

SEQ ID NO: 44 - protein, 10 aa, Anoplius samariensis
GLLKRIKTLL

SEQ ID NO: 45 - DNA, 2879 bp, Homo sapiens
ttttttcatactgagtctcactctgttacccaggctggagtgcagtggcatgatctcagctaactgcaacttctgcttcccgggttcaatgggttcaagtgattctcatgcctcagcttgtagctgggaactactggtgtgagccatcatgcgtggctaattttcatatttttagtagagatggggtttcaccatgttggccaagcttgtctcgaactccttatctcaggtgatccgcccaccttggcctcccaaagtgctgggattataggcgtgcagaccgtgccctgcctcattcatcaattcttaatcgatgcctacagggtgccaggcaatgctagagctggagatttagcagtccatcatactgactcctgaggagtagaaggatgtagaataggcacctggctctcttcctctctggagggatttaacgctcttgagcacccctggctatgacaatctccggtcaggtctgggaggttgtcagagatgaagaaaccacttcctcatcttgcacacaaggaaggcctcactcactgcccagcaagtcctgtgaagcaatagccagggctaaagcaaaccccagcccacaccctggcaggcagccagggatgggtggatcaggaaggctcctggttgggcttttgcatcaggctcaggctgggcataaaggaggctcctgtgggctagagggaggcagacatggggaccatgaagacccaaagggatggccactccctggggcggtggtcactggtgctcctgctgctgggcctggtgatgcctctggccatcattgcccaggtcctcagctacaaggaagctgtgcttcgtgctatagatggcatcaaccagcggtcctcggatgctaacctctaccgcctcctggacctggaccccaggcccacgatggtgagctttgggggacattctgctctgctctggctgggcttggcacgtgttgttccttctgctcctgctgcactgcctgccaggagggcatctccccctttaaatgtggtcccgtgttttccagggaaccttctagagctcgtgtctcctcccagctcgagagcttctgccttataattcctgctgtggcagagatccctcaccccgaccccacgcaggttttgggacttctgcgagctccaggcactagaatggggtcattggctctgggcagtgacctcctctgctttaagtctcttctgtaccacgttaccccacatagggaagaactctatccagactttaggttccagtgggcatgtcttgtcccccaggaagccccctgacttcccttgcccccaccccagagtgggaggggctccttgttagagctcatctgaggtctgctcctactcactgttcacctaggagggtaggaatggctcagtcctcctcccctcaatgccccagtgccaagcccagcacccagtgcccgtcgcacatcaggtactgtggaaagcctgccctcttggtggggaggtcatggacacaaatcagaaaatacaagaatgggcctccccatttcctcctctgactaggatggggacccagacacgccaaagcctgtgagcttcacagtgaaggagacagtgtgccccaggacgacacagcagtcaccagaggattgtgacttcaagaaggacggggtgaggctgggggctgggggtgttggtgggtgcctcccaaggagctgaacagggggcacctggggaatatttcccactgggatgtggctgggaggtcatggcaaatggtttcaagtttgaccttgagcttctcctttccagctggtgaagcggtgtatggggacagtgaccctcaaccaggccaggggctcctttgacatcagttgtgataaggtgagtgggctgttctgggatgcaggggctgatgggggcatagagtgtggaccatccaatgggtcaattaactactcccccaacccaggacagagaaagcccctcctacccagggctcttccccaaacctgagttccatctccagggccggctctggaatcccttagagcggtagatctccaagtgtagcccttcctggggactcgttagatatgcaaattctcaggccctactcagacctactcagacagactctgggtagggcccagaaattcgtattttgataagctttccaggagattccggcttctgtaaagtttgagagccactgtctaagagtactcagctctcagccctgtgttcccatctcagtgttgctgggctgggctgtgtgaccctgcagagcccctcactatctccgggactctgttttctcatctttttattgggtgtagggattcaatcacatgcttcaaaggtcacagccagaggttgaactggggccccaaagctctgcgggggcccacgaagaggggcgtctaggtggggaggggtcttggattgaccctgggtacatccccgacaaggaacctgtttcttcctgtacacaaccccaggataacaagagatttgccctgctgggtgatttcttccggaaatctaaagagaagattggcaaagagtttaaaagaattgtccagagaatcaaggattttttgcggaatcttgtacccaggacagagtcctagtgtgtgccctaccctggctcaggcttctgggctctgagaaataaactatgagagcaatttcctcaggcttcagtctcacttgttttgcctcctctctctcaccacaactgagcccttagctcagggagtccacgtgtgagtgtgagtgtgtgtgagtgtgacacagaggtggcgagggcagtgttccatccaggaggacacagggtaaggcagtagggccaagagatccaagatggcattcccattctcagtggaa

SEQ ID NO: 46 - DNA, 6836 bp, Homo sapiens
gttggccttagatgtaacacagggagagctcatcccttttaatagaggaagacagaaaggctggtacattgggttgtaggaggatatataaggatatcagttaggtgttaagaacagaaagactgagttaacagtgatttaacaaaagaggagagtatttctcctttaagtaaattttcaggtaggcagcctagagctgatgcagtggctccatacccaattatccaggctccatctatcttgttgccatgccaacctcaacatgcagcttacacttgctggcctgaaagtgaactattccatctcctgctatcatgactgaatactagtcaaagggaaaaagggggaagtgggaggggaaagcacatacctttcttaaagagcacaacctagagatggtccctattctgttcatatctcgttggccttaatttaatcacatcatcactgcaagctacagtgggggctgggaaatttggtgtttgaggggatgaccaagcgcccaactgaaaatgttattcttctcttatgagaagtagagaatggatgttagggaatggctagaagactctactacaaaggatacggtggttcttttctgattgcttctaacttctcaatgaaaggtgagttcatcagctgaatgaaagaataaatgagattttggggacttgaggagcaaggagaaggagtataatagtcattttgaagagtgagttaagtagggaactgtagtaagattgacagacagtgtggagggattacttgaatcttgtgaatagaggaaagagtagaatcagattatcctgactcctgcctgaagctttacatattcagagaaaaatgttggaagaaactttgatataatgctatgtctgtgatcaggcacacattttactggacttttactgtcagggccgtcatttagtgccaagatgtctagagagttcttaataagtgtactcaattggctgagaaaatgtgtccatgcaaaaaaccaaacaccgcatgttctcactcatagatgggaattgaacaatgagaatacttggacacaggaaggggaacatcacactctggggactgttgtggggtggggggaggggggagggatagcattagaagatatacctaatgctaaatgatgagttaatgggtgcagcacaccagcatggcacatgtatacatatgtaactaacctgcacattgtgcacatgtaccctaaaacttaaagtataataataataaaaaaatgtgtccatggctctgggaggagcatgtttgttttcctcatttcccagtctgtaaataagcaaattgaaaggggttagtgataatgtccatctccagaagctgtcagatttcctttgtcaaactctatgatttgggctgaagtaggtgttggagaggcagctaccacgtgcacccagatggccactcgtttaatatgttaccatttcccattattttcgcaggatagatagccaaagtggagccctgagagatttcttcatttttcctgtcataaagaattggtaattcagtagtcataggagtttgtaataaataactcacattgatttctctgttctgaaataattttgcttcccctcttcccgaagctctgacacctgccccaacaagcaatgttggaaaattatttacatagtggcgcaaactcccttactgctttggatataaatccaggcaggaggaggtagctctaaggcaagagatctaggacttctagcccctgaactttcagccgaatacatcttttccaaaggagtgaattcaggcccttgtatcactggcagcaggacgtgaccatggagaagctgttgtgtttcttggtcttgaccagcctctctcatgcttttggccagacaggtaagggccaccccaggctatgggagagatttgatctgaggtatgggggtggggtctaagactgcatgaacagtctcaaaaaaaaaaaaaaaagactgtatgaacagaacagtggagcatccttcatggtgtgtgtgtgtgtgtgtgtgtgtgtgtgtgtgtgtgtggtgtgtaactggagaaggggtcagtctgtttctcaatcttaaattctatacgtaagtgaggggatagatctgtgtgatctgagaaacctctcacatttgcttgtttttctggctcacagacatgtcgaggaaggcttttgtgtttcccaaagagtcggatacttcctatgtatccctcaaagcaccgttaacgaagcctctcaaagccttcactgtgtgcctccacttctacacggaactgtcctcgacccgtgggtacagtattttctcgtatgccaccaagagacaagacaatgagattctcatattttggtctaaggatataggatacagttttacagtgggtgggtctgaaatattattcgaggttcctgaagtcacagtagctccagtacacatttgtacaagctgggagtccgcctcagggatcgtggagttctgggtagatgggaagcccagggtgaggaagagtctgaagaagggatacactgtgggggcagaagcaagcatcatcttggggcaggagcaggattccttcggtgggaactttgaaggaagccagtccctggtgggagacattggaaatgtgaacatgtgggactttgtgctgtcaccagatgagattaacaccatctatcttggcgggcccttcagtcctaatgtcctgaactggcgggcactgaagtatgaagtgcaaggcgaagtgttcaccaaaccccagctgtggccctgaggcccagctgtgggtcctgaaggtacctcccggttttttacaccgcatgggccccacgtctctgtctctggtacctcccgcttttttacactgcatggttcccacgtctctgtctctgggcctttgttcccctatatgcattgcaggcctgctccaccctcctcagcgcctgagaatggaggtaaagtgtctggtctgggagctcgttaactatgctgggaaacggtccaaaagaatcagaatttgaggtgttttgttttcatttttatttcaagttggacagatcttggagataatttcttacctcacatagatgagaaaactaacacccagaaaggagaaatgatgttataaaaaactcataaggcaagagctgagaaggaagcgctgatcttctatttaattccccacccatgacccccagaaagcaggagggcattgcccacattcacagggctcttcagtctcagaatcaggacactggccaggtgtctggtttgggtccagagtgctcatcatcatgtcatagaactgctgggcccaggtctcctgaaatgggaagcccagcaataccacgcagtccctccactttctcaaagcacactggaaaggccattagaattgccccagcagagcagatctgctttttttccagagcaaaatgaagcactaggtataaatatgttgttactgccaagaacttaaatgactggtttttgtttgcttgcagtgctttcttaattttatggctcttctgggaaactcctccccttttccacacgaaccttgtggggctgtgaattctttcttcatccccgcattcccaatatacccaggccacaagagtggacgtgaaccacagggtgtcctgtcagaggagcccatctcccatctccccagctccctatctggaggatagttggatagttacgtgttcctagcaggaccaactacagtcttcccaaggattgagttatggactttgggagtgagacatcttcttgctgctggatttccaagctgagaggacgtgaacctgggaccaccagtagccatcttgtttgccacatggagagagactgtgaggacagaagccaaactggaagtggaggagccaagggattgacaaacaacagagccttgaccacgtggagtctctgaatcagccttgtctggaaccagatctacacctggactgcccaggtctataagccaataaagcccctgtttacttgagtgagtccaagctgttttctgatagttgctttagaagttgtgactaacttctctaatgacctttgaaatcaagtccctgtaagtttacacttcccattacacaacatatccatggcactttaacctgtccaagagtcccctgaagggattccctctgacaagcacagtccctcttttgagatagctggccattcatgtagggccagttgtgggggttttagtactctcattctatcattattccaatttgaggagcaaaaactaaagatcattgagatccatggatctgctgccaggttcagtgactggaatgcacttgccccagcgggttcaagttctttgtagaaacagacccctcaaagatgacagcagctggcttcctccagaagtgtccttcaacactgtctttcagtactaagtgaccagtagaagttactccataaagaccatagccaggaatgaattatggggcttcctgcatatcaaatggttacctagggaaggcatatggtaaactagttaagcacagaggttctggaatcagactgcctaggtccaaatcctggctttacaacttactagctatgtgaccttaggtgatataacctctttacgcctcagttttcttacctacaaagcaggagaaataatagtaattagctcaaagggttgctataagaatcaaagaaaatcatgcaagcaaagcacttactacagtgcctggcacatagtaagctcttataacagttttctggtattattcttattaagccattttgtattatatccataaatgtagattcataaaatacataaaaatacaacttggtagaatttgtcttggttggcagcagttgaagcttctcatttgctaagaattaggtttagaatgttagaagggtgaacaacaagtctttgaagccattatttatgaatattgacttctctaattgacttttgataaccatttgtaagcatagaagctaaggatacattctcagacaaaaatgagagtgcaaatactctctgttgtccaattagggcagatccatccatcctcacattcagctaagcagaagagaggattgacactcttttctagttaaataatccagatacgtcttaattatagaaggccatcccaactccccagggatgtaggttgagctaatattttcttcagaattcagttgcttgcatcttactatacatagtctggtagacagcctctggccttaataatttgagccaggaaaatcttaacagctggtatttgcattcagagaacattaaaaaatcttaacaaagcattcgtaggatgtttagatttaagcaatttagcctactggtgggtacatcaatgtaaacttgttggaaaatgtatttccaggtaactggtgaattgtcataccatatagagctattagatgtaatccaattaaatgttagatgacatctgccaaagaagatgattctgatttgggcatgttggttctaagcaatgcttttttttttttgcagtaagtggagagtaagatcaaacatccaccgtggccacttctagctgatgctaataaaaccatgttgtcaggactggttttctgttagagtagggaccatggatccaatttttccagaagtagaatcaggcctcaaggaatgagttaaaaagacatagggacaaatggtctataaaacctataatagaaaggaggtgaaagcggggtggtggcccagtgcctgaagagatactgtagtgcatttacaggccaaataagagaaagtagaacaatagtatgaatcagagatgatggaggctgctacttgatagaacactttctttttggaactgaaaatagccatgttggtataagggttagggccaggcctgaccctaatgtaagcgccttagcatgggatgtgatatggagatgtgcagatcagaaacctaaaatctccctgtgtcagaaaaaaatgttagctcactggccaggcaacaagacttgcacactttccaaaaagaggtggtcatggagagagcattgttaagaatgggctgcatgtcaggccaggtgagtggatgagaagccacctctgtgatgagacttggtctatccaggccctggaggagagagtacaggctgcctcaaaagtgaggctgggacctgatggaaatggatttggagtcccagctgacaaagtaagtagaatgttaaatctgtgatattctcccccatgctttcactatcctcaagtttgatgtgccccaggcaagcaaagattgacaaaggaagcaaatgactctagatgattgagcaccaccaccacgtagatcaaatttccaaagtatagatttctgatcactagaatcccagggaaaagagaagcactgctttgatttctaggtagcttatcctaggacaactgcccactagtctcagatgggttgtcgtacttgcctggattccttctcttcagctccctgtctctatttcaaatatgcatcttttcatttcctctgcactagaacgtaggttaagcgggcttgttagccttttccttctgaaaatgcagactcctagctcaaatttcctggatcacctggcccagtgatcacttatagtctgctgattacaggcatcattttcctctggggtgtttgagtatagattcattgaccccagtcctcctagagtagattctctggggttagtgctcaggaatatgcaagatcacaagctcttttgtaccatgtgcttttagagctatcactgtagtgttttcctgacagctcagatttcttatctcag

SEQ ID NO: 47 - DNA, 603 bp, Cyprinus carpio
gcgagctctgtaatcatgaagcttattcttgctgtgctggtgctggcgctggttttggtggtcgagactcaggctcaatggcaccgctacccaggacaagccattggaggtgcaaaggacatgtggcgtgcttaccgggatatgaggaaggccaactggaagggcgcagacaagtatttccatgcacgtgggaactatgatgctgcaagaaggggccccggaggcagatgggcagccaaagtaatcagtaatggaagagaggctctgcagggactctctcgccgcggtaattcagatgctgcagcagaccaggccgccaatcgctggggacgtaacggtggtaaccccaaccgctacagaccgaggggccttcccaaaaagtactgaaaagaagagcatcactgcaacagaaaatgactgaaatcattttgctctagaactgcttgattcaattttgcataaaaccatttcacgcttgttttttttcagtcttgacaattatcttgcattaaatctgcacttatgacaaaaatgcaatcttttaagttttagcatcatttagcctatgtaacacactctggtttgaataaaggaagtaacttc

SEQ ID NO: 48 - DNA, 701 bp, Dermacentor variabilis
acagtttgagatcccgtccgcaaaaagaaaccgacgaagatggccgctactcagccccgtcagaactaccacgtcgaatgcgaagcccgcatcaacaagcagatcaacatggaactctacgcgagctacgtctacacatcaatggcctactactttgaccgcgatgatgtggcactgccgggattccacaagttcttcaagaaaagcagcgaggaggagcgtgaacatgctgagaagctgatgaagtatcagaatatgcgtggagggcgtgtggtgctgcagccaatccagaagccagcacaggacgaatggggtgcaggcttggacgccatgcaggcttcactggagctggagaagactgttaaccagtcactgcttgacctgcacaagctggcgactgatcacaatgacgctcagctgtgtgacttcctggaaagtgagtacctggcagagcaggtgaaggccatcaaggagctgtccgattatgtgaccaacttgaagcgtgttggccctggtcttggagagtacatgtttgacaaggagaccctgtcagactaggctctacatgcagacacaagatgtggtctgtctgttggtgaagggcttgcactcattgtgccactgtgtaccatttggccccttctaccatgcaagaataaaatagttcaaagcaaaaaaaaaaaaaaaaaaaaaaaaaaaaa

SEQ ID NO: 49 - DNA, 1234 bp, Mus sp.
ggagtcagcacagcccagcccttccagagagaggcaagagaggtccacgatgagagccctgggagctgttgtcactctcctgctctggggtcagctttttgctgtggagttgggcaatgatgccatggactttgaagatgacagctgcccaaagcccccagagattgcaaacggctatgtggagcacttggttcgctatcgctgccgacagttctacagactacgggccgaaggagatggggtgtacaccttaaacgacgagaagcaatgggtgaacacagtcgctggacacaaactccccgaatgtgaggcagtgtgtgggaagcccaagcaccctgtggaccaggtgcagcgcatcatcggtggctctatggatgccaaaggcagctttccttggcaggccaagatgatctcccgccacggactcaccaccggggccacgttgatcagtgaccagtggctgctgaccacggccaaaaacctcttcctgaaccacagcgagacggcgtcagccaaggacatcacccccaccctaacgctctacgtagggaaaaaccagctggtggagattgagaaggtcgttctccaccccaaccactccgtggtggatatcgggctaatcaaactcaagcagagggtgcttgtaaccgagagagtcatgcctatctgcctgccttccaaagactacatagcaccaggccgtgtgggctacgtgtctggctgggggcggaacgccaactttagatttaccgatcgtctcaagtatgtcatgctgcctgtggccgaccaggacaagtgtgtggtgcactatgagaatagtacagtgcccgagaagaaaaacttgacgagtcccgttggggtccagcctatcttgaacgagcacaccttctgtgctggcctcaccaagtaccaggaagacacctgctacggtgacgccggcagtgcctttgccattcatgacatggaggaggacacctggtacgcagctgggatcctgagctttgacaagacgtgcgctgtcgctgagtatggtgtgtacgtgagggcgaccgacctgaaggactgggttcaggaaaccatggccaagaactagttcagggctcactagaaggctgcacatggcagggcaggctgggagccatggaagagggggaagtggaagggttgggctatactctgatgggttctagccctgcactgctcagtcaacaataaaaaaatgtgctttggaccc

SEQ ID NO: 50 - DNA, 3321 bp, Homo sapiens
atgaagattttgatacttggtatttttctgtttttatgtagtaccccagcctgggcgaaagaaaagcattattacattggaattattgaaacgacttgggattatgcctctgaccatggggaaaagaaacttatttctgttgacacggaacattccaatatctatcttcaaaatggcccagatagaattgggagactatataagaaggccctttatcttcagtacacagatgaaacctttaggacaactatagaaaaaccggtctggcttgggtttttaggccctattatcaaagctgaaactggagataaagtttatgtacacttaaaaaaccttgcctctaggccctacacctttcattcacatggaataacttactataaggaacatgagggggccatctaccctgataacaccacagattttcaaagagcagatgacaaagtatatccaggagagcagtatacatacatgttgcttgccactgaagaacaaagtcctggggaaggagatggcaattgtgtgactaggatttaccattcccacattgatgctccaaaagatattgcctcaggactcatcggacctttaataatctgtaaaaaagattctctagataaagaaaaagaaaaacatattgaccgagaatttgtggtgatgttttctgtggtggatgaaaatttcagctggtacctagaagacaacattaaaacctactgctcagaaccagagaaagttgacaaagacaacgaagacttccaggagagtaacagaatgtattctgtgaatggatacacttttggaagtctcccaggactctccatgtgtgctgaagacagagtaaaatggtacctttttggtatgggtaatgaagttgatgtgcacgcagctttctttcacgggcaagcactgactaacaagaactaccgtattgacacaatcaacctctttcctgctaccctgtttgatgcttatatggtggcccagaaccctggagaatggatgctcagctgtcagaatctaaaccatctgaaagccggtttgcaagcctttttccaggtccaggagtgtaacaagtcttcatcaaaggataatatccgtgggaagcatgttagacactactacattgccgctgaggaaatcatctggaactatgctccctctggtatagacatcttcactaaagaaaacttaacagcacctggaagtgactcagcggtgttttttgaacaaggtaccacaagaattggaggctcttataaaaagctggtttatcgtgagtacacagatgcctccttcacaaatcgaaaggagagaggccctgaagaagagcatcttggcatcctgggtcctgtcatttgggcagaggtgggagacaccatcagagtaaccttccataacaaaggagcatatcccctcagtattgagccgattggggtgagattcaataagaacaacgagggcacatactattccccaaattacaacccccagagcagaagtgtgcctccttcagcctcccatgtggcacccacagaaacattcacctatgaatggactgtccccaaagaagtaggacccactaatgcagatcctgtgtgtctagctaagatgtattattctgctgtggatcccactaaagatatattcactgggcttattgggccaatgaaaatatgcaagaaaggaagtttacatgcaaatgggagacagaaagatgtagacaaggaattctatttgtttcctacagtatttgatgagaatgagagtttactcctggaagataatattagaatgtttacaactgcacctgatcaggtggataaggaagatgaagactttcaggaatctaataaaatgcactccatgaatggattcatgtatgggaatcagccgggtctcactatgtgcaaaggagattcggtcgtgtggtacttattcagcgccggaaatgaggccgatgtacatggaatatacttttcaggaaacacatatctgtggagaggagaacggagagacacagcaaacctcttccctcaaacaagtcttacgctccacatgtggcctgacacagaggggacttttaatgttgaatgccttacaactgatcattacacaggcggcatgaagcaaaaatatactgtgaaccaatgcaggcggcagtctgaggattccaccttctacctgggagagaggacatactatatcgcagcagtggaggtggaatgggattattccccacaaagggagtgggaaaaggagctgcatcatttacaagagcagaatgtttcaaatgcatttttagataagggagagttttacataggctcaaagtacaagaaagttgtgtatcggcagtatactgatagcacattccgtgttccagtggagagaaaagctgaagaagaacatctgggaattctaggtccacaacttcatgcagatgttggagacaaagtcaaaattatctttaaaaacatggccacaaggccctactcaatacatgcccatggggtacaaacagagagttctacagttactccaacattaccaggtgaaactctcacttacgtatggaaaatcccagaaagatctggagctggaacagaggattctgcttgtattccatgggcttattattcaactgtggatcaagttaaggacctctacagtggattaattggccccctgattgtttgtcgaagaccttacttgaaagtattcaatcccagaaggaagctggaatttgcccttctgtttctagtttttgatgagaatgaatcttggtacttagatgacaacatcaaaacatactctgatcaccccgagaaagtaaacaaagatgatgaggaattcatagaaagcaataaaatgcatgctattaatggaagaatgtttggaaacctacaaggcctcacaatgcacgtgggagatgaagtcaactggtatctgatgggaatgggcaatgaaatagacttacacactgtacattttcacggccatagcttccaatacaagcacaggggagtttatagttctgatgtctttgacattttccctggaacataccaaaccctagaaatgtttccaagaacacctggaatttggttactccactgccatgtgaccgaccacattcatgctggaatggaaaccacttacaccgttctacaaaatgaagacaccaaatctggctgaatgaaataaattggtgataagtggaaaaaagagaaaaaccaatgattcataacaatgtatgtgaaagtgtaaaatagaatgttactttggaatgactataaacattaaaagagactggagcat

SEQ ID NO: 51 - DNA, 8878 bp, Homo sapiens
gaattcatgccccttttgaaatagacttatgtcattgtcagaaaacataagcatttatggtatatcattaatgagtcacgattttagtggttgccttgtgagtaggtcaaatttactaagcttagatttgttttctcacatattctttcggagcttgtgtagtttccacattaatttaccagaaacaagatacacactctctttgaggagtgccctaacttcccatcattttgtccaattaaatgaattgaagaaatttaatgtttctaaactagaccaacaaagaataatagttgtatgacaagtaaataagctttgctgggaagatgttgcttaaatgataaaatggttcagccaacaagtgaaccaaaaattaaatattaactaaggaaaggtaaccatttctgaagtcattcctagcagaggactcagatatatataggattgaagatctctcagttaagtctacatgaaaaggatggtttcttggagcttccacaaacttaaaaccatgaaacatctattattgctactattgtgtgtttttctagttaagtcccaaggtgtcaacgacaatgaggaggtgaattttttaaagcattattatattattagtagtattattaatataagatgtaacataatcatattatgtgcttattttaatgaaattagcattgcttatagttatgaaatggaattgttaacctctgacttattgtatttaaagaatgtttcatagtatttcttatataaaaacaaagtaatttcttgttttctagtttatcacctttgttttcttaagatgaggatggcttagctaatgtaagatgtgtttttctcacttgctattctgagtactgtgattttcatttacttctagcaatacaggattacaattaagaggacaagatctgaaaatctcacaaactataaaataataaaagagcagaattttaagataaaagaaactggtggtaggtagattgttctttggtgaaggaaggtaatatatattgttactgagattactatttataaaaattataactaagcctaaaagcaaaatacatcaagtgtaatgatagaaaatgaaatattgcttttttcagatgaaaagttcaaattagagttagtgtgtattgttattattaatagttatgaaacacggttcagtctaatttatttatttgtagaacagtttgtcctcaactattatttttgctgacttattgctgttaatttgcagttactaaaaatacagaaatgcatttaggacaatggatatttaagaaatttaaattttatcatcaaacgtatcatggccaaatttcttacatatagcatagtatcattaaactagaaataagaatacacaataatatttaaatgaagtgattcatttcggatcattattgagtttcaagggaacttgagtgttgtacttatcagactctacatgtaagaacatatagttaatctggttgtgtgtgtaaaaacatatggttaatctggttaagtctggttaatcatattaggtaagaaaaatgtaaagaatgtgtaagacgaaatttttgtaaagtactctgcaaagcactttcacatttctgcttatcaactaaacctcacagagatagtttaatagtttaggctttaaaatggattttgattattcaacaagtggccttcataatttctttaagtgtttttctttaagtatatactttctttaaatattttttaaaatttccttttctctagtaaagccagaccatccatgctacctctctagtggcactctgaaataaaaagaaaatagttttctctgttataattgtatttgtaataagcagatgaatcacatttcttaaaatttgttttagagagggtaagctctgactaggaccatgacttcaatgtgaaatatgtatatatcctccgaatctttacatattaagaatgtatatagtcaactggttaaacaggaaaatctggaacagcctggctgggttttaatcttagcaccatcctactaaatgttaaataatattataatctaatgaataaatgacaatgcaattccaaatagagttcatctgatgacttctagactcacaaaattgcaagagagctcagttgttgctcagttgttccaaatcatgtcgtttgttaatttgtaattaagctccaaaggatgtatagctactgacaaaaaaaaaaatgagaatgtagttaatccaaatcaaaactttcctattgcaatgcgtattttctgcttcattatcctttaatataatattttaagttagcaagtaattttaattacaatgcacaagccttgagaattattttaaatataagaaaatcataatgtttgataaagaaatcatgtaagaaatttcaagataatggtttaacaaataattttgttgatagaagataagactaaaagtgaaattcgaagtggagaggacacttaaactgtagtacttgttatgtgtgattccagtaaaaatagtaatgagcacttattattgccaagtactgttctgagggtaccatatgcaataagttatttaatccttacaataatcttgtaaggcagattcaaactatcattacacttattttacagatgagaaaactggggcacagataaagcaacttgcccaaggtctcatagctgtaagtcaaccctacggtcaagacctacaagtagccgagctccagagtacattatgagggtcaaagattgtcttattacaaataaattccaagtagaatcaacctttaataagtctttaatgtctcttaaatatgtttatataggagtctaatcaccaattcacaaaaatgaaagtagggaaatgattaacaataatcataggaatctaacaatccaagtggcttgagaatattcattcttcttgacagtatagattctttacaatttcgtaagttccaatgtatgttttaggaatatgaggtcattactattcataatctgatacagctttatcctaaggcctctctttaaaaactacactgcatcatagcttttttgtgcagttggtctttctactgttactgaacagtaagcaacctacagattcactatcaccaaccagccagttgatggatcttaagcaaattatcaagcttgtgataacctaaattataaaatgagggtgttggaatagttacattccaaatcttctataacactctgtattatatttctgcctcattccttgtagggtttcttcagtgcccgtggtcatcgaccccttgacaagaagagagaagaggctcccagcctgaggcctgccccaccgcccatcagtggaggtggctatcgggctcgtccagccaaagcagctgccactcaaaagaaagtagaaagaaaagcccctgatgctggaggctgtcttcacgctgacccagacctggtgggtgcactgatgtttcttgcagtggtggctctctcatgcagagaaagcctgtagtcatggcagtctgctaatgtttcactgacccacattaccatcactgttattttgtttgtttattttggaaataaaattcaaaacataaacatattgggcctttggtttaggctttctttcttgttttctttggtctgggcccaaaatttcaaattaggatatgtgggtgccacctttccatttgtattttgccactgcctttgtttagttggtaaaattttcatagcccaattatattttttctggggtaagtaatattttaaatctctatgagagtatgatgatgactttcgaatttctggtcttacagaaaaccaaataataaatttttatgttggctaatcgtatcgctgaattttcctatgtgctattttaacaaatgtccatgacccaaatccttcatctaatgcctgctattttctttgtttttagggggtgttgtgtcctacaggatgtcagttgcaagaggctttgctacaacaggaaaggccaatcagaaatagtgttgatgagttaaataacaatgtggaagctgtttcccagacctcctcttcttcctttcagtacatgtatttgctgaaagacctgtggcaaaagaggcagaagcaagtaaaaggtagatatccttgtgctttccattcgattttcagctataaaattggaaccgttagactgccacgagaatgcatggttgtgagaagattaacatttctgggttagtgaatagcattcatacgcttttgggcaccttcccctgcaacttgccagataagcactattcagctcttattcccagtctgacatcagcaagtgtgattttctatgaaaaattctactatgactccttattttaagtatacaagaaacttgtgactcagaagataatatttacagagtggaaaaaaacccctagcatttatagttttaacatttgaggttttgaatgagagagttatccataatatattcaattgtgttgtggataatgacacctaacctgtgaatcttgaggtcagaatgttgagtgctgttgacttggtggtcaggaaacagctagtgcgtgagcctggcacaggcatctcagtgagtagcatacccacagttggaaatttttcaaagaaatcaaaggaatcatgacatcttataaatttcaaggttctgctatacttatgtgaaatggataaataaatcaagcatatccactctgtaagattgaacttctcagatggaagaccccaatactgctttctcctcttttccctcaccaaagaaataaacaacctatttcatttattactggacacaatctttagcgtatacctatggtaaattactagtatggtggttaggatttatgttaatttgtatatgtcatgcgccaaatcatttccactaaatatgactatatatcataactgcttggtgatagctcagtgtttaatagtttattctcagaaaatcaaaattgtatagttaaatacattagttttatgaggcaaaaatgctaactatttctacataatttcatttttccagataatgaaaatgtagtcaatgagtactcctcagaactggaaaagcaccaattatatatagatgagactgtgaatagcaatatcccaactaaccttcgtgtgcttcgttcaatcctggaaaacctgagaagcaaaatacaaaagttagaatctgatgtctcagctcaaatggaatattgtcgcaccccatgcactgtcagttgcaatattcctgtggtgtctggcaaaggtaactgattcataaacatatttttagagagttccagaagaactcacacaccaaaaataagagaacaacaacaacaacaaaaatgctaagtggattttcccaacagatcataatgacattacagtacatcataaaaatatccttagccagttgtgttttggactggcctggtgcatttgctggttttgatgagcaggatggggcacaggtagtcccaggggtggctgatgtgtgcatctgcgtactggcttgaacagatggcagaaccacagatagatgtagaagtttctccattttgtgtgttctgggagctcatggatattccaggacacaaaaggtggagaagagctttgttcatcctcttagcagataaacgtcctcaaaactgggttggacttactaaagtaaaatgaaaatctaatatttgttatattattttcaaaggtctataataacacactccttagtaacttatgtaatgttattttaaagaattggtgactaaatacaaagtaattatgtcataaacccctgaacataatgttgtcttacatttgcagaatgtgaggaaattatcaggaaaggaggtgaaacatctgaaatgtatctcattcaacctgacagttctgtcaaaccgtatagagtatactgtgacatgaatacagaaaatggaggtaagctttcgacagttgttgacctgttgatctgtaattatttggataccgtaaaatgccaggaaacaaggccaggtgtggtggctcatacctgtaattccagcaccttgggaggccaaagtgggctgatagcttgagcctaggagtttgaaactagcctgggcaacataatgagaccctaactctacaaaaaaaaaaaaaataccaaaaaaaaaaaaaaaatcagctgtgttggtagtatgtgcctgtagtcccagctatccaggaggctgagatgggagatcacctgagcccacaacctggagtcttgatcatgctactgaactgtagcctgggcaacagaggatagtgagatcctgtctcaaaaaaaaaaattaattaaaaagccaggaaacaagacttagctctaacatctaacatagctgacaaaggagtaatttgatgtggaattcaacctgatatttaaaagttataaaatatctataattcacaatttggggtaagataaagcacttgcagtttccaaagattttacaagtttacctctcatatttatttccttattgtgtctattttagagcaccaaatatatactaaatggaatggacaggggattcagatattattttcaaagtgacattatttgctgttggttaatatatgctctttttgtttctgtcaaccaaaggatggacagtgattcagaaccgtcaagacggtagtgttgactttggcaggaaatgggatccatataaacagggatttggaaatgttgcaaccaacacagatgggaagaattactgtggcctaccaggtaacgaacaggcatgcaaaataaaatcattctatttgaaatgggattttttttaattaaaaaacattcattgttggaagcctgttttaggcagttaagaggagtttcctgacaaaaatgtggaagctaaagataagggaagaaaggcagtttttagtttcccaaaattttatttttggtgagagattttattttgtttttcttttaggtgaatattggcttggaaatgataaaattagccagcttaccaggatgggacccacagaacttttgatagaaatggaggactggaaaggagacaaagtaaaggctcactatggaggattcactgtacagaatgaagccaacaaataccagatctcagtgaacaaatacagaggaacagccggtaatgccctcatggatggagcatctcagctgatgggagaaaacaggaccatgaccattcacaacggcatgttcttcagcacgtatgacagagacaatgacggctggtatgtgtggcactctttgctcctgctttaaaaatcacactaatatcattactcagaatcattaacaatatttttaatagctaccacttcctgggcacttactgtcagccactgtcctaagctctttatgcatcactcgaaagcatttcaactataaggtagacattcttattctcattttacagatgagatttagagagattacgtgatttgtccaatgtcacacaactacccagagataaaactagaatttgagcacagttactttctgaataatgagcatttagataaatacctatatctctatattctaaagtgtgtgtgaaaactttcattttcatttccagggttctctgatactaagggttgtaaaagctattattccagtataaagtaacaaacacagtccctagatggattgccacaaaggcccagttatctctctttcttgctatagggcacaggaggtctttggtgtattagtgtgactctatgtatagcacccaaaggaaagactactgtgcacacgagtgtagcagtcttttatgggtaatctgcaaaacgtaacttgaccaccgtagttctgtttctaataacgccaaacacattttctttcaggttaacatcagatcccagaaaacagtgttctaaagaagacggtggtggatggtggtataatagatgtcatgcagccaatccaaacggcagatactactggggtggacagtacacctgggacatggcaaagcatggcacagatgatggtgtagtatggatgaattggaaggggtcatggtactcaatgaggaagatgagtatgaagatcaggcccttcttcccacagcaatagtccccaatacgtagatttttgctcttctgtatgtgacaacatttttgtacattatgttattggaattttctttcatacattatattcctctaaaactctcaagcagacgtgagtgtgactttttgaaaaaagtataggataaattacattaaaatagcacatgattttcttttgttttcttcatttctcttgctcacccaagaagtaacaaaagtatagttttgacagagttggtgttcataatttcagttctagttgattgcgagaattttcaaataaggaagaggggtcttttatccttgtcgtaggaaaaccatgacggaaaggaaaaactgatgtttaaaagtccacttttaaaactatatttatttatgtaggatctgtcaaagaaaacttccaaaaagatttattaattaaaccagactctgttgcaataagttaatgttttcttgttttgtaatccacacattcaatgagttaggctttgcacttgtaaggaaggagaagcgttcacaacctcaaatagctaataaaccggtcttgaatatttgaagatttaaaatctgactctaggacgggcacggtggctcacgactataatcccaacactttgggaggctgaggcgggcggtcacaaggtcaggagttcaagaccagcctgaccaatatggtgaaaccccatctctactaaaaatacaaaaattagccaggcgtggtggcaggtgcctgtaggtcccagctagcctgtgaggtggagattgcattgagccaagatc

SEQ ID NO: 52 - DNA, 2182 bp, Homo sapiens
gtctaggagccagccccacccttagaaaagatgttttccatgaggatcgtctgcctagttctaagtgtggtgggcacagcatggactgcagatagtggtgaaggtgactttctagctgaaggaggaggcgtgcgtggcccaagggttgtggaaagacatcaatctgcctgcaaagattcagactggcccttctgctctgatgaagactggaactacaaatgcccttctggctgcaggatgaaagggttgattgatgaagtcaatcaagattttacaaacagaataaataagctcaaaaattcactatttgaatatcagaagaacaataaggattctcattcgttgaccactaatataatggaaattttgagaggcgatttttcctcagccaataaccgtgataatacctacaaccgagtgtcagaggatctgagaagcagaattgaagtcctgaagcgcaaagtcatagaaaaagtacagcatatccagcttctgcagaaaaatgttagagctcagttggttgatatgaaacgactggaggtggacattgatattaagatccgatcttgtcgagggtcatggagtagggctttagctcgtgaagtagatctgaaggactatgaagatcagcagaagcaacttgaacaggtcattgccaaagacttacttccctctagagataggcaacacttaccactgataaaaatgaaaccagttccagacttggttcccggaaattttaagagccagcttcagaaggtacccccagagtggaaggcattaacagacatgccgcagatgagaatggagttagagagacctggtggaaatgagattactcgaggaggctccacctcttatggaaccggatcagagacggaaagccccaggaaccctagcagtgctggaagctggaactctgggagctctggacctggaagtactggaaaccgaaaccctgggagctctgggactggagggactgcaacctggaaacctgggagctctggacctggaagtgctggaagctggaactctgggagctctggaactggaagtactggaaaccaaaaccctggaagtcctagacctggtagtaccggaacctggaatcctggcagctctgaacgcggaagtgctgggcactggacctctgagagctctgtatctggtagtactggacaatggcactctgaatctggaagttttaggccagatagcccaggctctgggaacgcgaggcctaacaacccagactggggcacatttgaagaggtgtcaggaaatgtaagtccagggacaaggagagagtaccacacagaaaaactggtcacttctaaaggagataaagagctcaggactggtaaagagaaggtcacctctggtagcacaaccaccacgcgtcgttcatgctctaaaaccgttactaagactgttattggtcctgatggtcacaaagaagttaccaaagaagtggtgacctccgaagatggttctgactgtcccgaggcaatggatttaggcacattgtctggcataggtactctggatgggttccgtcataggcaccctgatgaagctgccttcttcgacactgcctcaactggaaaaacattcccaggtttcttctcacctatgttaggagagtttgtcagtgagactgagtctaggggctcagaatctggcatcttcacaaatacaaaggaatccagttctcatcaccctgggatagctgaattcccttcccgtggtaaatcttcaagttacagcaaacaatttactagtagcacgagttacaacagaggagactccacatttgaaagcaagagctataaaatggcagatgaggccggaagtgaagccgatcatgaaggaacacatagcaccaagagagggcatgctaaatctcgccctgtcagaggtatccacacttctcctttggggaagccttccctgtccccctagactaagttaaatatttctgcacagtgttcccatggccccttgcatttccttcttaactctctgttacacgtcattgaaactacacttttttggtctgtttttgtgctagactgtaagttccttgggggcagggcctttgtctgtctcatctctgtattcccaaatgcctaacagtacagagccatgactcaataaatacatgttaaatggatgaatg

SEQ ID NO: 53 - DNA, 737 bp, Homo sapiens
cctcctggtctcagtatggcgctgtcctgggttcttacagtcctgagcctcctacctctgctggaagcccagatcccattgtgtgccaacctagtaccggtgcccatcaccaacgccaccctggaccagatcactggcaagtggttttatatcgcatcggcctttcgaaacgaggagtacaataagtcggttcaggagatccaagcaaccttcttttacttcacccccaacaagacagaggacacgatctttctcagagagtaccagacccgacaggaccagtgcatctataacaccacctacctgaatgtccagcgggaaaatgggaccatctccagatacgtgggaggccaagagcatttcgctcacttgctgatcctcagggacaccaagacctacatgcttgcttttgacgtgaacgatgagaagaactgggggctgtctgtctatgctgacaagccagagacgaccaaggagcaactgggagagttctacgaagctctcgactgcttgcgcattcccaagtcagatgtcgtgtacaccgattggaaaaaggataagtgtgagccactggagaagcagcacgagaaggagaggaaacaggaggagggggaatcctagcaggacacagccttggatcaggacagagacttgggggccatcctgcccctccaacccgacatgtgtacctcagctttttccctcacttgcatcaataaagcttctgtgtttggaac

SEQ ID NO: 54 - DNA, 1409 bp, Bos taurus
gccctggtgaggatcatgtcgctgtttacatcacttccttttcttctcctgactgcggtgacagcatcttgtgcagacacagaaacagagaactgtgagaacatccggaagacctgccccgtgattgcctgtggtcctccgggcatcaatggcatcccaggcaaagatgggcgtgatggtgccaagggagaaaagggagaaccaggtcaaggactcagaggctcgcagggcccccctggaaagatggggcctcaaggaacgccagggatccctgggataccaggaccaataggccaaaaaggagaccctggagaaaatatgggtgactatattcgcctggctacttcagaaagagcaactctacaatctgaattgaaccagatcaaaaactggctaatcttctctctgggcaaaagagttgggaagaaggcattttttaccaatggtaaaaagatgccttttaatgaagtgaagactctgtgtgcacagttccagggccgtgtggccacccctatgaatgctgaagaaaacagggccctcaaggatttagtcactgaagaggccttcctgggcatcacagatcaggagactgaaggcaaatttgtggatctgacaggaaagggggtgacctaccaaaactggaatgatggcgagcctaacaacgcttctcctggggagcactgtgtgacacttctgtcggacggcacatggaatgacatcgcttgttccgcctcctttttgaccgtctgtgaattctctctctgagggagaatgagcctaaagtcctcctgttcctttactcatctcatgggcccacaacctggtttggaggataaatctatgtcaatttcacacacccagtactgagttgctcttttgtggggaaacagagacaataagaatggattgagaatgatgagatgtggaactgaaaagcgtgaagagacttatagtggtgtaagagtttctggttcagacccagtcactaataataatcatttcaggaacaacaaaataatggtagtaatagtagcaacagcagtaatagtgggagtactaataacatattttaaaatgtttactatgagtcagacattacatgtaagattatacattaagtatctaatttaactaggctgttcatttttgtttgagactataaagaaagctgagcactgaagaattgatggttttgaactgtggtgttggagaagactcttaagagtcccttggactgcaaggagatccaaccagtccatcttaaaggagatcagtcctaggtgttcattggaaggactgaagttgaagctgaaactccaatactttggccacctgatgcaaagagctgactcatttgaaaagaccctgaagctgggaaagattgagggcaggagaaaaagccggaattc

SEQ ID NO: 55 - DNA, 1463 bp, Homo sapiens
tgcactgggaatctaggatgggggccttggccagagccctgccgtccatactgctggcattgctgcttacgtccaccccagaggctctgggtgccaaccccggcttggtcgccaggatcaccgacaagggactgcagtatgcggcccaggaggggctattagctctgcagagtgagctgctcaggatcacgctgcctgacttcaccggggacttgaggatcccccacgtcggccgtgggcgctatgagttccacagcctgaacatccacagctgtgagctgcttcactctgcgctgaggcctgtccctggccagggcctgagtctcagcatctccgactcctccatccgggtccagggcaggtggaaggtgcgcaagtcattcttcaaactacagggctcctttgatgtcagtgtcaagggcatcagcatttcggtcaacctcctgttgggcagcgagtcctccgggaggcccacagttactgcctccagctgcagcagtgacatcgctgacgtggaggtggacatgtcgggagacttggggtggctgttgaacctcttccacaaccagattgagtccaagttccagaaagtactggagagcaggatttgcgaaatgatccagaaatcggtgtcctccgatctacagccttatctccaaactctgccagttacaacagagattgacagtttcgccgacattgattatagcttagtggaagcccctcgggcaacagcccagatgctggaggtgatgtttaagggtgaaatctttcatcgtaaccaccgttctccagttaccctccttgctgcagtcatgagccttcctgaggaacacaacaaaatggtctactttgccatctcggattatgtcttcaacacggccagcctggtttatcatgaggaaggatatctgaacttctccatcacagatgacatgataccgcctgactctaatatccgactgaccaccaagtccttccgacccttcgtcccacggttagccaggctctaccccaacatgaacctggaactccagggatcagtgccctctgctccgctcctgaacttcagccctgggaatctgtctgtggacccctatatggagatagatgcctttgtgctcctgcccagctccagcaaggagcctgtcttccggctcagtgtggccactaatgtgtccgccaccttgaccttcaataccagcaagatcactgggttcctgaagccaggaaaggtaaaagtggaactgaaagaatccaaagttggactattcaatgcagagctgttggaagcgctcctcaactattacatccttaacaccctctaccccaagttcaatgataagttggccgaaggcttcccccttcctctgctgaagcgtgttcagctctacgaccttgggctgcagatccataaggacttcctgttcttgggtgccaatgtccaatacatgagagtttga

SEQ ID NO: 56 - DNA, 4577 bp, Homo sapiens
gctacaatccatctggtctcctccagctccttctttctgcaacatggggaagaacaaactccttcatccaagtctggttcttctcctcttggtcctcctgcccacagacgcctcagtctctggaaaaccgcagtatatggttctggtcccctccctgctccacactgagaccactgagaagggctgtgtccttctgagctacctgaatgagacagtgactgtaagtgcttccttggagtctgtcaggggaaacaggagcctcttcactgacctggaggcggagaatgacgtactccactgtgtcgccttcgctgtcccaaagtcttcatccaatgaggaggtaatgttcctcactgtccaagtgaaaggaccaacccaagaatttaagaagcggaccacagtgatggttaagaacgaggacagtctggtctttgtccagacagacaaatcaatctacaaaccagggcagacagtgaaatttcgtgttgtctccatggatgaaaactttcaccccctgaatgagttgattccactagtatacattcaggatcccaaaggaaatcgcatcgcacaatggcagagtttccagttagagggtggcctcaagcaattttcttttcccctctcatcagagcccttccagggctcctacaaggtggtggtacagaagaaatcaggtggaaggacagagcaccctttcaccgtggaggaatttgttcttcccaagtttgaagtacaagtaacagtgccaaagataatcaccatcttggaagaagagatgaatgtatcagtgtgtggcctatacacatatgggaagcctgtccctggacatgtgactgtgagcatttgcagaaagtatagtgacgcttccgactgccacggtgaagattcacaggctttctgtgagaaattcagtggacagctaaacagccatggctgcttctatcagcaagtaaaaaccaaggtcttccagctgaagaggaaggagtatgaaatgaaacttcacactgaggcccagatccaagaagaaggaacagtggtggaattgactggaaggcagtccagtgaaatcacaagaaccataaccaaactctcatttgtgaaagtggactcacactttcgacagggaattcccttctttgggcaggtgcgcctagtagatgggaaaggcgtccctataccaaataaagtcatattcatcagaggaaatgaagcaaactattactccaatgctaccacggatgagcatggccttgtacagttctctatcaacaccaccaacgttatgggtacctctcttactgttagggtcaattacaaggatcgtagtccctgttacggctaccagtgggtgtcagaagaacacgaagaggcacatcacactgcttatcttgtgttctccccaagcaagagctttgtccaccttgagcccatgtctcatgaactaccctgtggccatactcagacagtccaggcacattatattctgaatggaggcaccctgctggggctgaagaagctctccttttattatctgataatggcaaagggaggcattgtccgaactgggactcatggactgcttgtgaagcaggaagacatgaagggccatttttccatctcaatccctgtgaagtcagacattgctcctgtcgctcggttgctcatctatgctgttttacctaccggggacgtgattggggattctgcaaaatatgatgttgaaaattgtctggccaacaaggtggatttgagcttcagcccatcacaaagtctcccagcctcacacgcccacctgcgagtcacagcggctcctcagtccgtctgcgccctccgtgctgtggaccaaagcgtgctgctcatgaagcctgatgctgagctctcggcgtcctcggtttacaacctgctaccagaaaaggacctcactggcttccctgggcctttgaatgaccaggacgatgaagactgcatcaatcgtcataatgtctatattaatggaatcacatatactccagtatcaagtacaaatgaaaaggatatgtacagcttcctagaggacatgggcttaaaggcattcaccaactcaaagattcgtaaacccaaaatgtgtccacagcttcaacagtatgaaatgcatggacctgaaggtctacgtgtaggtttttatgagtcagatgtaatgggaagaggccatgcacgcctggtgcatgttgaagagcctcacacggagaccgtacgaaagtacttccctgagacatggatctgggatttggtggtggtaaactcagcaggggtggctgaggtaggagtaacagtccctgacaccatcaccgagtggaaggcaggggccttctgcctgtctgaagatgctggacttggtatctcttccactgcctctctccgagccttccagcccttctttgtggagcttacaatgccttactctgtgattcgtggagaggccttcacactcaaggccacggtcctaaactaccttcccaaatgcatccgggtcagtgtgcagctggaagcctctcccgccttccttgctgtcccagtggagaaggaacaagcgcctcactgcatctgtgcaaacgggcggcaaactgtgtcctgggcagtaaccccaaagtcattaggaaatgtgaatttcactgtgagcgcagaggcactagagtctcaagagctgtgtgggactgaggtgccttcagttcctgaacacggaaggaaagacacagtcatcaagcctctgttggttgaacctgaaggactagagaaggaaacaacattcaactccctactttgtccatcaggtggtgaggtttctgaagaattatccctgaaactgccaccaaatgtggtagaagaatctgcccgagcttctgtctcagttttgggagacatattaggctctgccatgcaaaacacacaaaatcttctccagatgccctatggctgtggagagcagaatatggtcctctttgctcctaacatctatgtactggattatctaaatgaaacacagcagcttactccagaggtcaagtccaaggccattggctatctcaacactggttaccagagacagttgaactacaaacactatgatggctcctacagcacctttggggagcgatatggcaggaaccagggcaacacctggctcacagcctttgttctgaagacttttgcccaagctcgagcctacatcttcatcgatgaagcacacattacccaagccctcatatggctctcccagaggcagaaggacaatggctgtttcaggagctctgggtcactgctcaacaatgccataaagggaggagtagaagatgaagtgaccctctccgcctatatcaccatcgcccttctggagattcctctcacagtcactcaccctgttgtccgcaatgccctgttttgcctggagtcagcctggaagacagcacaagaaggggaccatggcagccatgtatataccaaagcactgctggcctatgcttttgccctggcaggtaaccaggacaagaggaaggaagtactcaagtcacttaatgaggaagctgtgaagaaagacaactctgtccattgggagcgccctcagaaacccaaggcaccagtggggcatttttacgaaccccaggctccctctgctgaggtggagatgacatcctatgtgctcctcgcttatctcacggcccagccagccccaacctcggaggacctgacctctgcaaccaacatcgtgaagtggatcacgaagcagcagaatgcccagggcggtttctcctccacccaggacacagtggtggctctccatgctctgtccaaatatggagccgccacatttaccaggactgggaaggctgcacaggtgactatccagtcttcagggacattttccagcaaattccaagtggacaacaacaatcgcctgttactgcagcaggtctcattgccagagctgcctggggaatacagcatgaaagtgacaggagaaggatgtgtctacctccagacctccttgaaatacaatattctcccagaaaaggaagagttcccctttgctttaggagtgcagactctgcctcaaacttgtgatgaacccaaagcccacaccagcttccaaatctccctaagtgtcagttacacagggagccgctctgcctccaacatggcgatcgttgatgtgaagatggtctctggcttcattcccctgaagccaacagtgaaaatgcttgaaagatctaaccatgtgagccggacagaagtcagcagcaaccatgtcttgatttaccttgataaggtgtcaaatcagacactgagcttgttcttcacggttctgcaagatgtcccagtaagagatctcaaaccagccatagtgaaagtctatgattactacgagacggatgagtttgcaatcgctgagtacaatgctccttgcagcaaagatcttggaaatgcttgaagaccacaaggctgaaaagtgctttgctggagtcctgttctctgagctccacagaagacacgtgtttttgtatctttaaagacttgatgaataaacactttttctggtc

SEQ ID NO: 57 - DNA, 4090 bp, Mus musculus
  misc_feature (1)...(4090): n = A,T,C or G
tgagcagcactaacctgactcagtaggttgtatcagtatatctattcatatacacgcagaacagtaataattaaagaaagagaggccaagagaggccgagaacttgagaaggaggagggtggggggtgagattggagggggtagacagaggaggcaaatggtataaatgcacaaatatggaatctacagagatggtgccacgatgctgacgtaaggctcaggatttgcaggaaggctcgggatttgtaggaagggaatcttgggttgaagtctacagagaacgatatctcttctgatcattggatgcaatcaacacacaccagggagcatccatagtgggcggaatgcatggcagccatagtttttggctgacatctgaagcctgtggaggatttaggggtaggaagaatgaattcctttaacaagtcaaaggacaccacagctccacgctgattgcagcgatgagtaagaggccctgtctctttcctccagtccgcttcagtgatctctattagccattgatgcaattcattcattactttaagggtcattttaagcccttaatcttaaaaccagtcccaagttgtttcacgactaagagactgagctccaacaaggttggctgaaggcaaggccttctgtgtgtaactttcatttgtttagggattgctttccaggttccagtcatggaatgggcaccgggcaaacagcggtcaaatgatttggcagaaatcaacatcagttggttgagccatgcgtcatcttcatctcgagaaggaatttgtattgagcaataggttagagtttcaaaatcccagaaagtccaggaacattaaaaaaaaaaaaaaaaatagaggtgtatggcagagtttcagccgagagtccacgtgtgatgtctcagcttcaggttagggtaacccttttgtgactggttcttctctactagtgagagcaatagtcttgggatttcacaatgctcagggctcaggtgatcacttgcaatgtccctctgctgataacttccaagacagcttctgtcattttcagctctcaggtggttactctgatggcctcatggtcctgcctgaaacagaaagtctgccacctacttctgtagcagcaagactcctgttctgtggctaagcttcctgcctgtgcaagagccacagggaggggccaaatgcatgccactggggccacgctcctggtaaagacataaatagtgatcctcgggactggtcatcagagctccccttgccttcaccatgaagtcctgcggccttttacctttcacggtgctccttgctctggggatcctggcaccctggactgtggaaggaggcaaaaatgatggtgagttggagttgctttggtccaacattgcctggagtatcagagtgggggctcctgatggtttgggctgtttttcagtttactctgacctcagggcgacatctgtgtctcgctggggtctgagtcttgatgaatttcaaggcatgtagagtgctcctcttatgcagccatcctgtcagctcaggtctcacacagctctgtccctgccctttacctttctgtttgtttctgtctctggctttagttctcagcatctcacatattattcccttcctatttatttctcttggtctccattattcctgctcccaccttctgtctttgtgagatcttgcttagccctgaggtagaaaaccttgactgggagcccggtaccttttatcctcagtctgatttttcctggtcacatgtcttggttgaccaagtctgacttttcctccctaggtcagcccggtatttctctttgaagttgtgggccactggaatgagggtctatattctgagatgtggaccttcgtctaggaatgatgatagtccgtaccctcctaacatcttgagcttctctttagctatcaaaatcggagcctgccctgctaaaaagcctgcccagtgccttaagcttgagaagccacaatgccgtactgactgggagtgcccgggaaagcagaggtgctgccaagatgcttgcggttccaagtgcgtgaatcctgttcccattcgcaaaccagtgagccagcagagaaaacagagaggggacaatcaacgtcaagagccacccagagtgaatgaagagtccctcccaggcatccttgtttctaagagctgttgggtccaacatgtcagttagtcaaggcctcttgctgccattggcaggaagagccatttgcctgcagttgccactctgtgaggatgatggctttacaaccattcggccctttcggggctggagagctggtcccctgcattggctggaggctagatggtagcgaggaagcaggtcctctttcaggaggcgtgtttgggaggaggtgacaaaggtgatgggtggatggggacgaacttcctcgctcaggaaggagatgttgggttaaagacatggagatgtgttgcctgagccctaagacatcggccctgtgaatcctttctcaacagggagatgtgttgcctgagccctaagacatcggccctgtgaatcctttctcaacaggtgtggaggaagcctgggaggtgcgtcaaaactcaggcaagatgtatgatgcttaaccctcccaatgtctgccagagggacgggcagtgtgacggcaaatacaagtgctgtgagggtatatgtgggaaagtctgcctgcccccgatgtgagtgaggctaaggagtgggctggggtaggcagagctcatttctctccagcccttttctgcttcaaggttctggagctcgaagcacatgcgccaggagattctattctaatcaggagcccctgtctgtttgccgtttaagggaactgtcccctgtttcttagggcaaagcttagcattgcctgaggctttgatcctgtggcagcctgtcagggtaagggcctcgggtgaatggctctcagagtctctgcctgcacaatagaaataccgaagttgaagttttgcgaggcacagtatacgttatttgcttcccatgttatttacttcatggtgtctctctggtcagagcacaaaggataggtataatgtgaggaatgtctagctcagtgctctgcgttttgagttttacaacgacaacgagatttgaacctgttctcctgaaaccccagatcctctcaagtccagccccactttaccctttgaccgttctcagcatgctcccttacaagggctggataggaatgatctagctggttcctatgttgaaggtctttccttactttctcttgtaggcctgatccctgacattggcgccggctctggactcgtgctcggtgtgctctggaaactacttccctgctcccaggcgtccctgctccgggttccatggctcccggctccctgtatcccaggcttggatcctgtggaccagggttactgttttaccactaacatctccttttggctcagcattcaccgatctttagggaaatgctgttggagagcaaataaataaacgcattcatttctctatgcacaccgtgagtctgattctctgaggggatgagatgggtgtggtaggaaccaataaaggaaggatgggaacgaggcctccctcttacattccgggaggagaaggatgagaattccaggcttgggcatgcttgaacctnccaaatatcatgtttttatctgcaaagtggcaacagggaccgctttcttacaacgtgtagtgcaccagaggttgcagaatggtgcaaagtgtgtgtgtgctatacagctgtgctttaccaaagtgccttcacacaccacggccacttattgctacccggcgttatgaaaatgcggtgcatgtgtgtgcacgcacacacatgtgcagtgtgcttacttgtatgtgtttttgaaggacagagtangacaccaggtgtcttcctctgtcactttctggttattaccttgagtcangatctctgtgctgaaccaaaagccgaccaatcagggctgggttcgctggtctgcccatccccttccccggttactggggttacangaaaatgcacacaccngctttntatgtgggttcccgggattgactgattctgcc

SEQ ID NO: 58 - DNA, 565 bp, Oryctolagus cuniculus
atggagacccataagcacggaccttccctggcctggtggtcactgttgctgctgctgctgggcctgctgatgcccccagccatcgcccaggacctcacctaccgggaggctgtgctccgcgctgtggatgccttcaaccagcagtcctcagaggccaacctctaccgcctcctgagcatggacccccagcagctggaggatgcgaagccatacaccccgcagcctgtgagctttacggtgaaggagacggagtgcccccggacaacatggaagctaccagagcagtgtgacttcaaggaagatgggctggtgaagcggtgtgtggggactgtgacacggtaccaggcctgggactcctttgacatccgctgcaacagggcccaagagtccccagaacctactgggctgcgcaagcgcttacgaaaatttagaaacaagattaaagaaaagcttaaaaaaattggtcagaaaatccagggtttcgtgccgaaacttgcacccaggacagattactagggtctgccctgccctggactctgaaaaataaactgtgtgaaagcaacaa

SEQ ID NO: 59 - DNA, 686 bp, Allium cepa
aacgaaaattacgaaattacatcaatatctcgagccatggttcgcgttgtatctttacttgcagcatcgaccttcatactgttgattatgataatcagcagtccgtatgcaaatagtcagaacatatgcccaagggttaatcgaattgtgacaccctgtgtggcctacggactcggaagggcaccaatcgccccatgctgcagagccctgaacgatctacggtttgtgaatactagaaacctacgacgtgctgcatgccgctgcctcgtaggggtagtgaaccggaaccccggtctgagacgaaaccctagatttcagaacattcctcgtgattgtcgcaacacctttgttcgtcccttctggtggcgtccaagaattcaatgcggcaggattaaccttacggataagcttatatacttggacgctgaggaatgaagactaggctctactgttatgcactatagtttatagtatatatactaaataaaacagtatgtgctgtataatttgcaatatggacttatttatagcaagtcctaatggtgtctgctacttgggtccagcattgagcactatataggcactatatagggtactatgggctgattatgatgtcaacggcggtactttatcttacataaataaataatgggtttatcttgcttgaaaaaaaaaaaaaaaaaaaa

SEQ ID NO: 60 - DNA, 550 bp, Bos taurus
agactggggaccatgcagacccagagggccagcctctcactggggcggtggtcgctgtggctactgctgctgggactagtggtgccctcggccagcgcccaagccctcagctacagggaggccgtgcttcgtgctgtggatcagctcaatgagctgtcctcagaagctaatctctaccgcctcctggagctagacccacctcccaaggataatgaagatctgggcactcgaaagcctgtgagcttcacggtgaaggagactgtgtgccccaggacgattcagcagcccgcggagcagtgtgacttcaaggagaaagggcgggtgaaacagtgtgtggggacagtcaccctggacccatccaatgaccagtttgacctaaactgtaatgagctccagagtgtcatcctaccctggaaatggccatggtggccttggcgcagaggttgatggagaagagctgtcagatcctgagcctcgggaagagtcttaagtgtctgatttgttcagattcgggcttctggacagtgaaaataaattcttgtgaaaacgg